(19) United States
(12) Patent Application Publication
(10) Pub. No.: US 2026/0010429 A1
(43) Pub. Date: Jan. 8, 2026

(54) SYSTEM AND METHODS FOR MULTIDIMENSIONAL ADAPTIVE SENSING AND IMPLEMENTATIONS THEREOF

(71) Applicant: Omniconn IP Holding, Inc., Millerton, NY (US)

(72) Inventors: Richard David PEARSON, Abu Dhabi (AE); Abdul Hathi JABARULLA, Abu Dhabi (AE)

(21) Appl. No.: 19/327,904

(22) Filed: Sep. 12, 2025

Related U.S. Application Data
(63) Continuation of application No. PCT/US2025/030409, filed on May 21, 2025.
(60) Provisional application No. 63/650,328, filed on May 21, 2024.

(51) Int. Cl. G06F 11/07

(52) U.S. Cl. CPC G06F 11/0793; G06F 11/0709

(57) ABSTRACT

The present disclosure relates to a multidimensional adaptive sensing system and method for event detection with improved accuracy. The system dynamically adjusts, using baseline and compound models, a triggering conditional threshold of each event based on real-time variations in environmental parameters and sensor health. The adaptive system allows for fine-tuning of sensitivity to environmental changes, seasonal variations, and sensor decay, thereby reducing false positives and negatives. Installation flexibility is achieved by selecting and deploying a subset of models tailored to available data at the sensor's location, ensuring optimal operation regardless of specific environmental conditions or sensor configurations. The adaptive sensing system is used in environmental control systems for dynamic routine management, sensor health management, a triage system for complex event analysis, and multifaceted compliance assurance solution. Further, the adaptive sensing system is used for automated configuration, model deployment, and maintenance by leveraging edge computing units and a central control unit.

### CROSS-REFERENCE TO RELATED APPLICATIONS

This application is a continuation of International Application No. PCT/US2025/030409, filed on May 21, 2025, which claims the benefit of and priority to U.S. Provisional Patent Application No. 63/650,328 filed on May 21, 2024, the entire contents of both of which are hereby incorporated by reference.

### FIELD OF DISCLOSURE

The present disclosure is generally related to sensing systems.

### Introduction

Sensing systems, such as smoke or carbon monoxide detectors, play a crucial role in ensuring safety in various environments. However, conventional sensing systems operate on a uni-dimensional basis, based on the detection of specific physical changes, such as smoke density or gas concentration, and respond when such changes exceed predetermined electrical characteristic thresholds, such as resistance, voltage, or current changes.

While conventional sensing systems have proven effective in many scenarios, they are prone to false positives and negatives. Environmental factors such as humidity and temperature fluctuations can cause these sensing systems to trigger false alarms or fail to detect real threats. Additionally, sensor decay over time can also lead to inaccurate readings, further compromising the reliability of these systems.

These limitations not only lead to operational inefficiencies, such as unnecessary response actions execution or maintenance checks triggered by false alarms, but also pose significant safety concerns. A system that fails to detect a real threat due to a false negative could result in serious consequences, including property damage and loss of life.

Further, in conventional systems, a persistent issue continues to exist due to the reliance on manual or semi-automatic methods for monitoring sensor health and modifying operational parameters accordingly. This dependence on human intervention for sensor health assessment and adjustment can result in inefficiencies. Moreover, the degradation of sensor health over time can contribute to diminished efficiency, increased periods of system downtime, and necessitate frequent physical maintenance inspections.

Therefore, there is a need for an improved sensing system that can overcome above-mentioned challenges.

The present disclosure addresses these needs by introducing a multidimensional sensing system for improved detection accuracy by dynamically adjusting detection thresholds based on a comprehensive analysis of environmental and operational parameters. This approach represents a significant advancement over existing sensing technologies, providing a more robust, reliable, and intelligent solution for event detection.

### BRIEF DESCRIPTION OF FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is an exemplary block diagram illustrating a multidimensional adaptive sensing system of a first embodiment in accordance with the present disclosure.

FIG. 2 is an exemplary block diagram illustrating a sensor module of a multidimensional adaptive sensing system of a first embodiment in accordance with the present disclosure.

FIG. 3 is an exemplary block diagram illustrating a data aggregation module of a multidimensional adaptive sensing system of a first embodiment in accordance with the present disclosure.

FIG. 4 is an exemplary block diagram illustrating a communication network of a multidimensional adaptive sensing system of a first embodiment in accordance with the present disclosure.

FIGS. 5A-5C are exemplary diagrams illustrating a state machine flowchart of the logical unit of the multidimensional adaptive sensing system of a first embodiment in accordance with the present disclosure.

FIGS. 6A-6B are exemplary flow charts illustrating a method of training a machine learning (ML) model of a multidimensional adaptive sensing system in accordance with the present disclosure.

FIGS. 7A-7B are exemplary flow charts illustrating a method of training a machine learning model or an artificial intelligence (AI) model of a multidimensional adaptive sensing system in accordance with the present disclosure.

FIG. 8 is an exemplary flow chart illustrating a method of validating a machine learning model or an artificial intelligence (AI) model of a multidimensional adaptive sensing system in accordance with the present disclosure.

FIGS. 9A-9B are exemplary flow chart illustrating a method of adaptive learning and decision making using a machine learning model or an artificial intelligence (AI) model of a multidimensional adaptive sensing system in accordance with the present disclosure.

FIGS. 10A-10C are exemplary flow charts illustrating a method of adaptive learning and decision making in a fire alarm system using a machine learning model or an artificial intelligence (AI) model in accordance with the present disclosure.

FIG. 11 is an exemplary block diagram illustrating a multidimensional adaptive sensing system of an embodiment in accordance with the present disclosure.

FIGS. 12A-12B are exemplary flow charts illustrating a method of autonomous health monitoring and operational adjustment of a multidimensional adaptive sensing system in accordance with the present disclosure.

FIG. 13 is an exemplary architecture overview of an edge-driven multidimensional adaptive sensing system of an embodiment in accordance with the present disclosure.

FIG. 14A-14D are exemplary flow charts illustrating a method of automated configuration process for an edge-driven multidimensional adaptive sensing system of an embodiment in accordance with the present disclosure.

FIGS. 15A-15B are exemplary flow charts illustrating a method of automated sensor health monitoring and maintenance in the edge-driven multidimensional adaptive sensing system of an embodiment in accordance with the present disclosure.

FIGS. 16A-16B are exemplary flow charts illustrating a process of registering models and correlation tagging in the edge-driven multidimensional adaptive sensing system of an embodiment according to the present disclosure.

FIGS. 17A-17B are exemplary flow charts illustrating a method of adapting response to environmental changes according to the present disclosure.

FIGS. 18A-18B are exemplary system architectures, highlighting the integration of illustrating a multidimensional adaptive sensing system with building management system.

FIG. 19 illustrates a system architecture of an adaptive environmental control system for dynamic routine management using one or more machine learning models according to the present disclosure.

FIG. 20 illustrates a system architecture of a triage system for event analysis according to the present disclosure.

FIG. 21 depicts a high-level view of an overall system architecture of MASS, in another example embodiment.

FIG. 22 depicts a system for facilitating decay-induced training of models, according to certain embodiments.

FIG. 23 depicts the structure of a baseline machine learning module and a compound machine learning module within a MASS architecture.

FIG. 24 depicts an example of how a decay data model is developed.

FIG. 25 depicts an example of a baseline model structure, according to certain embodiments.

FIG. 26 depicts an example of a sensor profile and baseline database architecture.

FIG. 27 depicts an example of a compound model structure.

FIG. 28 depicts an example of a topology profile and combined database architecture.

FIG. 29 depicts how the system automatically detects new sensors, retrieves sensor metadata, and assigns baseline and compound models based on environmental context and sensor specifications.

FIG. 30 depicts a flow diagram associated with health monitoring and continuous evaluation.

FIG. 31 depicts a flow diagram for performing self-correction through real-time operational adjustment.

FIG. 32 depicts a flow diagram associated with a process for dynamically reconfiguring sensor models.

### DETAILED DESCRIPTION

The embodiments described herein will be better appreciated and understood when considered in conjunction with the following description and the accompanying drawings. It should be understood, however, that the following descriptions, while indicating certain example embodiments and implementation (including the specific details thereof), are given by way of illustration and not of limitation. Many changes and modifications may be made within the scope of the embodiments herein without departing from the spirit and scope thereof, and the embodiments herein include all such modifications.

As used herein, the term ‘exemplary’ or ‘illustrative’ means ‘serving as an example, instance, or illustration.’ Any implementation described herein as exemplary or illustrative is not necessarily to be construed as advantageous and/or preferred over other embodiments. Unless the context requires otherwise, throughout the description and the claims, the word ‘comprise’ and variations thereof, such as ‘comprises’ and ‘comprising’ are to be construed in an open, inclusive sense, i.e., as ‘including, but not limited to.’

The present disclosure describes a multidimensional adaptive sensing system (MASS), which in certain embodiments, is designed to significantly enhance the accuracy of event detection, such as fire alarms, by integrating data from multiple environmental and operational parameters. In certain embodiments, the system utilizes a combination of baseline and compound models, and dynamically adjusts a triggering conditional threshold (TCT) for each event based on real-time variations in relevant parameters, including but not limited to, temperature, humidity, and airflow. These baseline and compound models may be developed iteratively, incorporating both rule-based algorithms and machine learning techniques. In certain embodiments, the adaptive nature of the system allows for the fine-tuning of sensitivity to environmental changes, seasonal variations, and sensor decay, thereby reducing false positives and negatives. Installation flexibility may be achieved by selecting and deploying a subset of models tailored to the available data at the sensor's location, ensuring optimal operation regardless of specific environmental conditions or sensor configurations.

Further, certain aspects of the present disclosure extend the capabilities of the system through the integration of autonomous health monitoring and operational adjustment mechanisms. In certain embodiments, the system employs advanced algorithms and machine learning models to continuously assess the condition and performance of each sensor within the network. By analysing data in real-time, the system may identify signs of sensor degradation or environmental impact, automatically adjusting operational parameters to maintain optimal accuracy and reliability. In some aspects, operational parameters may include detection parameters, which are parameters that affect the sensor abnormality detection functionality of sensors and corresponding sensing devices. Some examples of detection parameters include detection thresholds and sensitivity settings. In some aspects, the following disclosure may refer to adjusting the detection threshold and/or adjusting the sensitivity setting of a sensor or group of sensors. However, any suitable detection parameter may be adjusted according to the disclosed techniques to mitigate and/or prevent sensor abnormalities.

This proactive approach may minimize downtime and extends sensor lifespan, ensuring the system adapts dynamically to both internal and external changes. In certain embodiments, the MASS enables significant advancements in the field of sensing systems, offering enhanced detection accuracy and system resilience across various applications, including environmental monitoring, industrial safety, and smart infrastructure.

According to some implementations, a multifaceted compliance assurance system and solution is disclosed. The multifaceted compliance assurance system utilizes dynamic sensing and predictive regulatory analysis to innovate compliance in building management systems, such as fire safety, by leveraging the multi-dimensional adaptive sensing system of the present disclosure. In certain embodiments, the approach transforms regulatory adherence into a dynamic, automated process by encoding compliance requirements into target constraints and rules within multi-dimensional adaptive sensing system. This approach may further enable real-time monitoring and automated health checks of sensors, facilitating immediate responses to violations and predictive maintenance to pre-empt compliance failures. By integrating adaptive models that adjust to environmental changes and sensor degradation, in certain embodiment, the solution not only ensures ongoing compliance with local and global regulations but also reduces manual inspection burdens. In certain embodiments, predictive analytics further enhance the system's capability to foresee and mitigate potential non-compliance, making it as a cutting-edge solution for efficient, reliable compliance management in critical building systems.

Further, in certain embodiments, the present disclosure discloses an intelligent triage system for complex event analysis using adaptive multidimensional sensing that significantly enhances the detection and analysis of complex environmental events. By integrating the multi-dimensional adaptive sensing system with advanced triaging models, certain embodiments identify and respond to non-linear and sophisticated phenomena beyond traditional sensor capabilities. The triage system may operate by defining non-linear conditional triggers (NCTs) and associated triage actions, using a network of advanced sensors to monitor environmental conditions in real-time. In certain embodiments, specialized triaging models, trained on historical data, dynamically adapt to evolving situations, enabling precise identification of anomalies and automatic execution of appropriate responses or human interventions. Such an adaptive, intelligent system may improve operational efficiency and accuracy of event detection and management, by enabling a versatile solution to a wide range of applications by continuously learning and adjusting to new conditions.

Additionally, in certain embodiments, the present disclosure presents an improved approach to sensor network management, leveraging edge computing units (ECUs) and a central control unit (CCU) for automated configuration, model deployment, and maintenance. In certain embodiments, this system streamlines the setup process by automatically identifying sensor characteristics and determining the optimal combination of baseline and compound models for each sensor array. In certain embodiments, utilizing metadata and machine learning algorithms, the system dynamically adjusts to environmental changes, seasonal variations, and network expansions, ensuring optimal performance without manual intervention. The CCU's intelligent decision-making capabilities may allow for real-time adjustments and model updates, significantly enhancing detection accuracy and system reliability across diverse applications. This edge-driven architecture may improve conventional adaptive sensing technology, by enabling scalable, efficient, and self-configuring sensor networks for a wide range of monitoring and detection tasks.

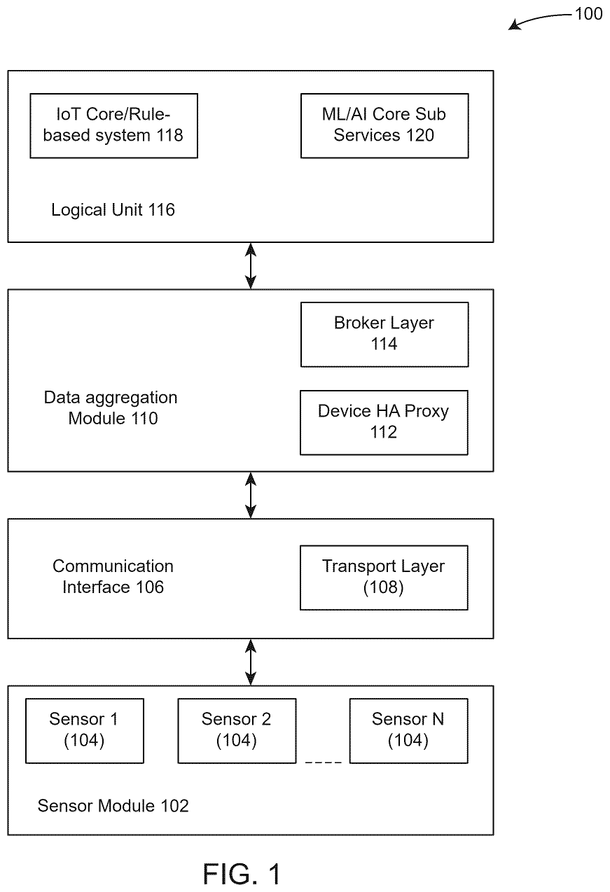

Referring to FIG. 1, a multidimensional adaptive sensing system (MASS) 100 is illustrated, in accordance with a first embodiment of the present disclosure. The system 100 includes one or more sensor modules 102, one or more communication interface 106, a data aggregation module 110, and a logical unit 116. Each of the one or more sensor modules 102 comprises one or more sensors 104, e.g., sensor 1, sensor 2, . . . sensor N. The one or more sensors modules 104 forms a sensor network deployed in a distributed manner on a site, for example a building or the like. In some embodiments, the one or more sensors modules 104 comprise internal sensors and external sources, such as weather services or other IoT devices, of the system 100.

In some embodiments, the one or more sensors 104 may include sensors configured to measure, for example but not limited to, temperature, smoke, CO₂, humidity, airflow, variable air volume (VAV), human presence, sunlight exposure, sun angle or the like, which be considered within the scope of the disclosure.

The communication interface 106 is configured to enable the communication between the one or more sensor modules 102 and rest of the system 100. Further, the communication interface 106 is also configured to allow the system 100 to communicate with the external world, such as, but not limited to, cloud services, emergency services, user devices, or the like. This communication interface 106 comprises transport layer 108 that is configured to enable remote system monitoring, control, and adjustment, enhancing operational flexibility, and firmware updates for the sensors. The communication interface 106 comprises any one of the technologies including, but not limited to MQTT, WS Post, Rabbit MQ, LoRa, Zigbee, zWave, BACnet, Modbus, SIP, Kafka, Rest API, Azure, AWS, Slack, Twilio, or a combination thereof. By leveraging these technologies, the communication interface 106 may enable efficient message queuing, secure data transmission, robust message queuing and routing, long-range and short-range wireless communication, serial communication, distributed streaming and data processing, real-time messaging and collaboration, voice, SMS, and chat communications, or the like.

The data aggregation module 110 is configured to gather the data from the one or more sensor modules 102, preprocess the data to standardize and normalize data, and then stream the data to the logical unit 116. The data aggregation module 110 enables the aggregation of the data from the internal sensors and/or external sources, such as weather services, environmental data, or other IoT devices, and directs it to the logical unit 116 of the system 100. In certain embodiments, the data aggregation module 110 comprises a load balancing and proxy unit, such as a High Availability Proxy illustrated as HA proxy 112, to receive and transmit sensors data packets, such to balance load in terms of internal sensor and external environment data. In certain embodiments, the data aggregation module 110 also comprises broker layer 114 to facilitate communication and data exchange between various sensors and rest of a networked system. The broker layer 114 operates as an intermediary entity to efficiently manage requests, allocate resources, and orchestrate interactions among connected elements of system 100. Its implementation may enhance system scalability, reliability, and interoperability, thereby optimizing overall performance and user experience.

The logical unit 116 processes the incoming data, executes analysis, and facilitates the decision-making processes of the system 100. In certain embodiments, the logical unit 116 comprises an IoT core and/or rule-based system 118. The IoT core and/or rule-based system 118 communicates with the rest of the system 100 to collect, process, and transmit data. Further, the IoT core and/or rule-based system 118 may utilize machine learning (ML) and/or artificial intelligence (AI) analysis core sub services 120 in data processing. According to some implementations, the ML/AI sub services 120 comprise at least two adaptive models, such as a baseline model and a compound model, that enable the system 100 to possess dynamic response capabilities. The baseline model(s) and the compound model(s) may be developed iteratively, incorporating both rule-based algorithms and machine learning techniques. In certain embodiments, the baseline model(s) are tailored to the detection parameters of individual sensors 104, utilizing a combination of the rule-based algorithms and machine learning to accurately predict event detection e.g., smoke or gas presence. On the other hand, in certain embodiments, the compound model(s) integrate data from multiple sensors 104 and other external sources to capture complex environmental interactions. The input from internal sensors and/or external data sources enriches the baseline and compound models, making them more resilient and adaptable. The integration of diverse data streams may allow the models to dynamically evolve, reflecting changes in sensor health and external environmental conditions. This holistic approach may ensure that the system 100 remains robust against sensor wear and environmental fluctuations, maintaining high accuracy and reliability in its operations. This may ensure precise event detection while minimizing false alarms, a critical function in maintaining system reliability.

In some embodiments, the logical unit 116 is configured to initiate maintenance actions or recalibrations of the sensors 104, based on the evaluation of sensor states and conditions to ensure reliability of the system 100. In some embodiments, the logical unit 116 is configured to make dynamic adjustments to the sensor settings and parameters of the system 100 e.g., triggering conditional threshold (TCT) to maintain optimal sensing accuracy and reliability of the system 100 across various environmental conditions and sensor lifecycle stages. Similarly, for instance, if the accuracy of sensor 104 declines, its data might be weighted less in compound models to prevent degradation of the system's overall performance.

In some embodiments, the baseline models are selected and configured corresponding to the type of the sensors 104, considering the sensor's operational range, sensitivity, and data output format. This may ensure that the models accurately interpret sensor data, thus effectively reducing the likelihood of false positives or negatives.

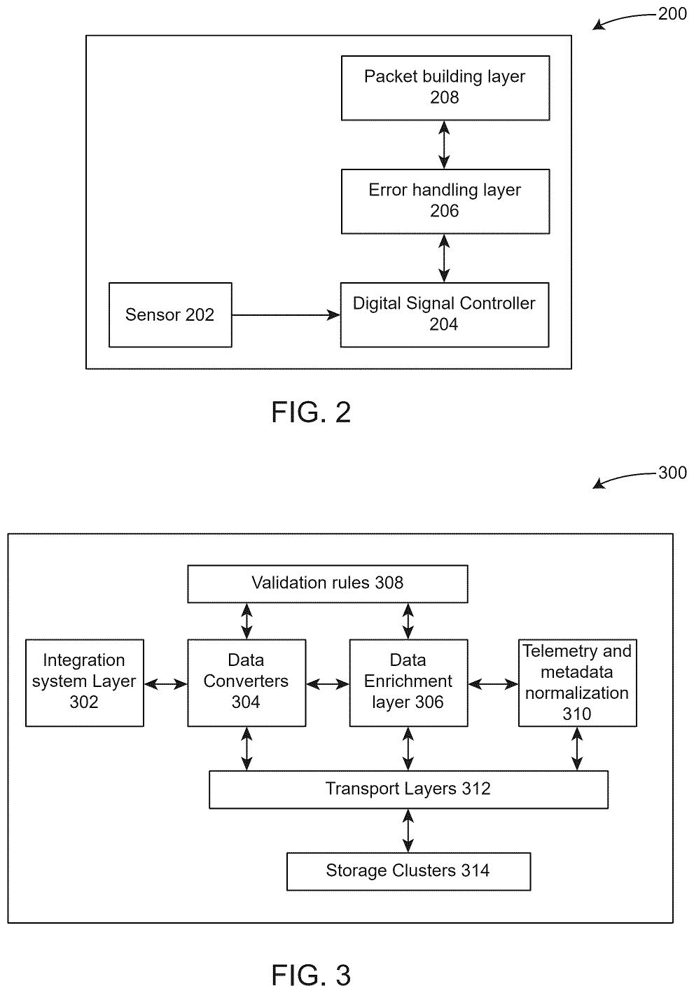

Referring to FIG. 2, the sensor module 200 of the multidimensional adaptive sensing system of a first embodiment is illustrated, in accordance with the present disclosure. The sensor module 200 is configured to receive the raw data from the sensors 202, further process and encapsulate it into required format, so that encapsulated data may be transmitted to rest of the system 100. The sensor module 200 comprises one or more sensors 202, digital signal controller 204, error handling layer 206, and packet building layer 208. The digital signal controller 204 receives signals from the sensor 202, for further processing. The digital signal controller 204, includes, for example but not limited to, a microcontroller unit integrated with specialized digital signal processing capabilities. The digital signal controller 204 is configured to facilitate real-time execution of signal processing algorithms, to process digital signals. In some embodiments, the digital signal controller 204 can be integrated with the analog to digital convertor, to process analog signals to convert the analog signals into digital format. With continued reference to FIG. 2, as non-limiting examples, the sensor 202 may be the same as the sensor 104, as described previously herein.

In some embodiments, the one or more sensors 202 can include internal and/or external sensors to measure, for example but not limited to, temperature, smoke, CO₂, humidity, airflow, variable air volume (VAV), human presence, sunlight exposure, sun angle or the like, which may be considered within the scope of the disclosure.

The error handling layer 206, receives digital signals form the digital signal controller 204, to check and manage the errors in the digital signals. The error handling layer 206 comprises a system for detecting, managing, and resolving errors within the digital signals received. The error handling layer 206 includes, for example but not limited to, a combination of algorithms, protocols, and monitoring mechanisms, to provide real-time identification of errors, triggers appropriate response actions, and initiates error resolution procedures to ensure stability and reliability.

The packet building layer 208 is configured to construct packets of data received according to specified protocols and requirements. The packet building layer 208 manages the encapsulation of data into packets, ensuring proper formatting and organization for efficient transmission and reception within the environment of system 100.

Referring to FIG. 3, the data aggregation module 300 of the multidimensional adaptive sensing system of a first embodiment is illustrated, in accordance with the present disclosure. The data aggregation module 300 is configured to aggregate data from sensor modules 102 or 200 that comprise internal sensors, and/or from the external sources, such as weather services or other IoT devices. The process of data aggregation comprises preprocessing steps to standardize and normalize data, before communicating the data to the logical unit 116. The data aggregation module 300 comprises an integration system layer 302, data converters 304, data enrichment layer 306, telemetry and metadata normalization layer 310, validation rules 308, transport layers 312, and storage clusters 314. The integration system layer 302 facilitates interoperability among disparate data formats by providing a unified framework for data exchange and communication. By using standardized interfaces and protocols, the integration system layer 302 enables efficient integration of diverse data.

The data converter 304 comprises a plurality of converters. The data converter 304 is configured to convert one format to other and vice versa with high accuracy and efficiency. Additionally, the data converter 304 may incorporate advanced signal processing algorithms to enhance performance and versatility in various applications.

The data enrichment layer 306 is configured to receive data from the data converters 304, comprising one or more data attributes. The data enrichment layer 306 further augments the received data by associating additional attributes obtained from external data sources, thereby enhancing the richness and depth of the data. Additionally, the enriched data is subject to validation using the validation rules 308 to ensure consistency and reliability. The validation rules 308 are a set of criteria or rules to be implemented, to ensure data integrity and accuracy. The validation rules 308 validate input data against predetermined conditions, preventing erroneous or unauthorized information from being processed or stored. Through validation of the data, compliance with required standards and protocols is maintained, enhancing overall operational efficiency and reliability.

The telemetry and metadata normalization layer 310 standardizes the format and structure of the received telemetry data and associated metadata from the sensor modules 102 or 200, to facilitate uniform processing and analysis. Additionally, normalization may involve aligning timestamps, units, and other parameters across the collected data to ensure consistency and compatibility within the data aggregation module 300 of system 100.

The transport layer 312 facilitates the transmission of data among the data converters 304, data enrichment layer 306, telemetry and metadata normalization layer 310, and one or more storage clusters 314. The transport layer 312 includes one or more protocols, for example, but not limited to, transmission control protocol (TCP) and user datagram protocol (UDP) to manage communication sessions, segment data packets, and handle flow control, enhancing the efficiency and integrity of data transmission within the system 100. The one or more storage clusters 314 comprises a plurality of storage nodes configured to store and retrieve data. By way of example, but not limitation, the storage clusters 314 may utilize distributed storage techniques to efficiently manage data across the nodes, ensuring high availability and reliability of stored data.

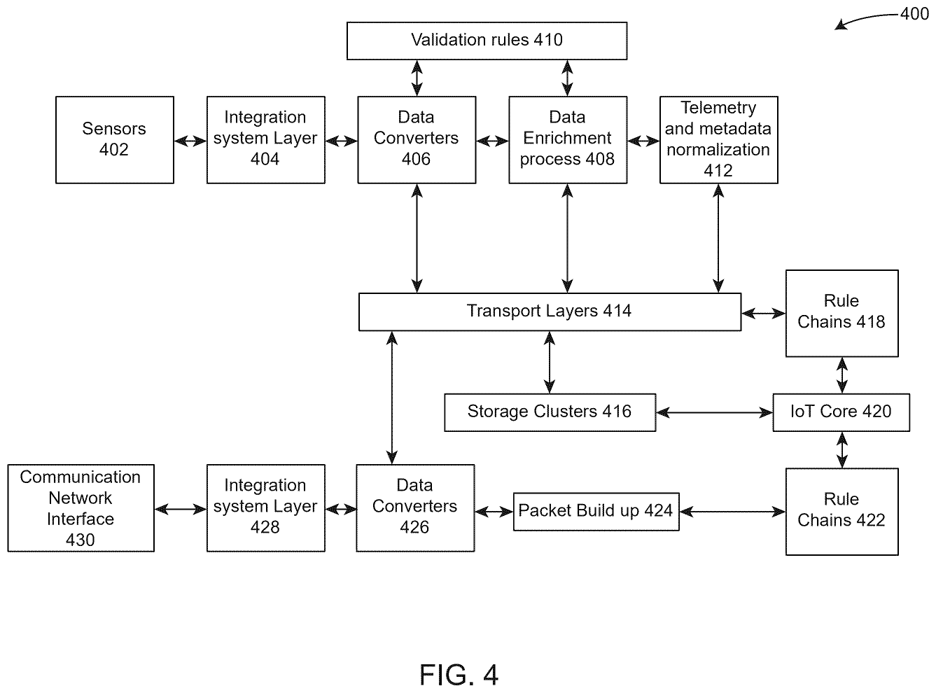

In the first embodiment of the present disclosure, a communication network 400 of the multidimensional adaptive sensing system 100, is illustrated, as shown in FIG. 4. The communication network interface 430 enables the system 100 interaction with external networks and devices, for examples, but not-limited to emergency services, cloud-based services, and user devices. The communication network interface 430 provides the bidirectional exchange of information, including status updates from the system 100 and external data inputs, facilitating comprehensive environmental analysis and remote system monitoring. With continued reference to FIG. 4, communication network interface 430 is substantially the same as the communication interface 106, as described previously herein.

With continued reference to FIG. 4, sensors 402, integration system layer 404, data converters 406, data enrichment layer 408, telemetry and metadata normalization layer 412, validation rules 410, transport layers 414, and storage clusters 416 are substantially the same as the sensors 104, integration system layer 302, data converters 304, data enrichment layer 306, telemetry and metadata normalization layer 310, validation rules 308, transport layers 312, and storage clusters 314, respectively, as described previously herein. Thus, it is to be understood herein that the description about the same has not been repeated herein for the sake of conciseness.

The communication network interface 430 comprises, for example, any one of the technologies including, but not limited to MQTT, WS Post, Rabbit MQ, LoRa, Zigbee, zWave, BACnet, Modbus, SIP, Kafka, Rest API, Azure, AWS, Slack, Twilio, or a combination thereof. By leveraging these technologies, the communication network interface 430 enables the system 100 to interact with external networks and devices. The data received through external network and devices, is pre-processed through an integration system layer 428, data converters 426, and packet build-up 424, before transmitting it to the storage clusters 416 and/or the IoT core 420. With reference to FIG. 4, the integration system layer 428, data converters 426 may correspond the integration system layer 302 and data converters 304, respectively, as described previously herein. Thus, it is to be understood herein that the description about the same has not been repeated herein for the sake of conciseness. A combination of rule chains 418 and 422 and IoT core 420, is substantially similar to the logical unit 116 of the system 100, as described previously herein.

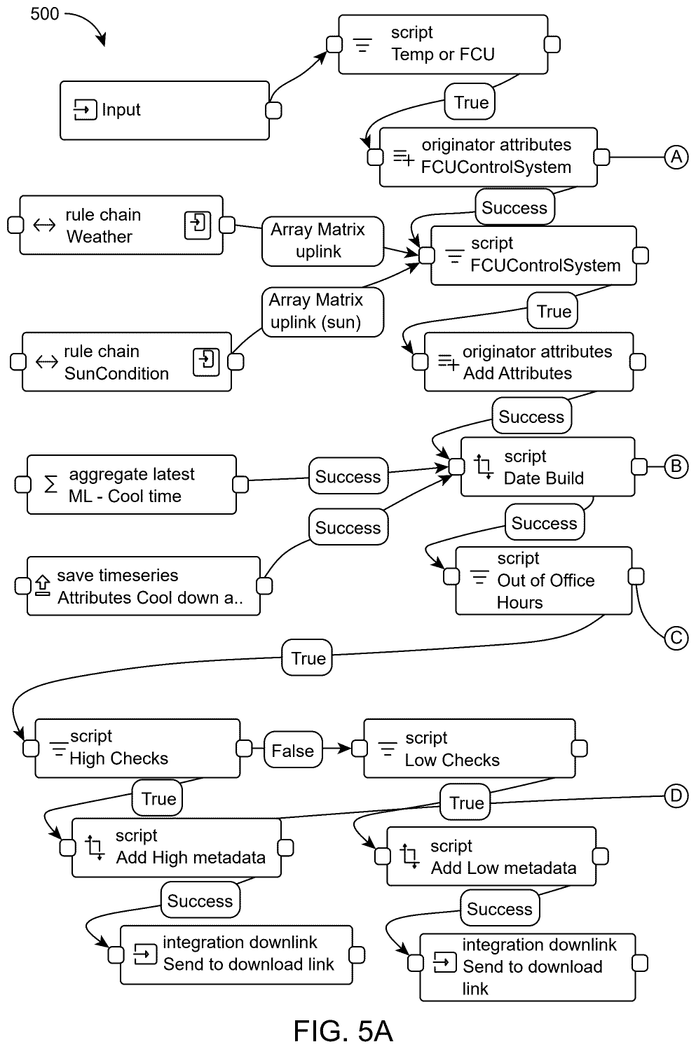

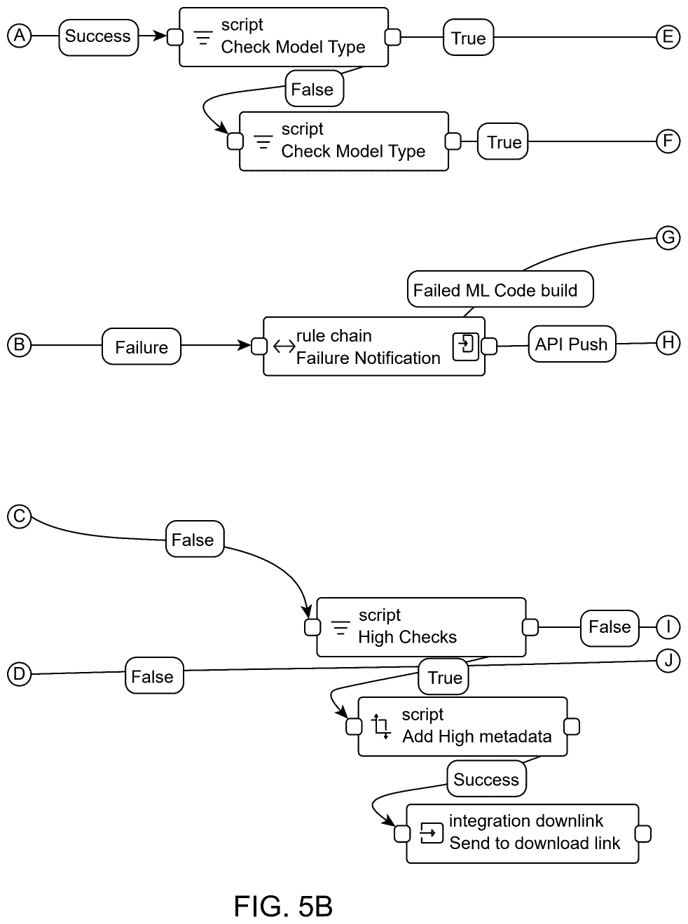

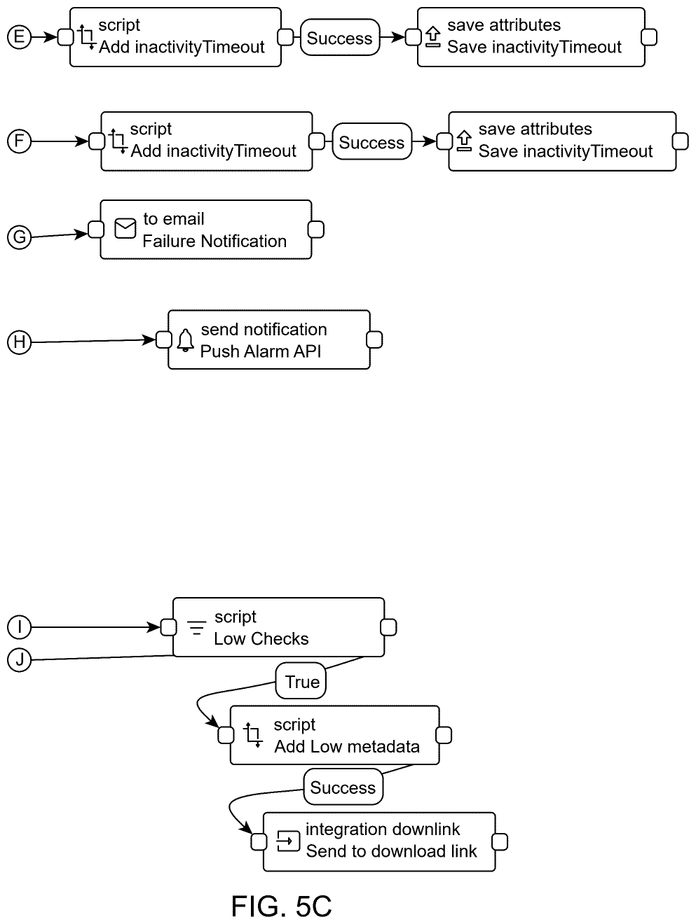

FIGS. 5A-5C illustrate an exemplary diagram illustrating a programming flowchart of the logical unit of the multidimensional adaptive sensing system of a first embodiment in accordance with the present disclosure.

Referring to FIGS. 5A-5C, a state machine flowchart 500 of the logical unit 116 of the multidimensional adaptive sensing system 100 is illustrated, according to certain embodiments of the present disclosure. FIGS. 5A-5C depicts the internal workings of the logical unit 116, where baseline and compound adaptive models are stored and executed. It displays the input stream coming from the data aggregation module 110, feeding into different models. The decision process based on these models' analysis is also shown, including how the logical unit 116 dynamically adjusts TCTs in response to the analysis. Various connections between data inputs, models, and decision outputs are highlighted in FIGS. 5A-5C. For instance, various inputs in terms of sensor's data, external environment data, rules-set is provided to the baseline and compound adaptive models of the logical unit 116, which further makes dynamic changes within the make dynamic adjustments to the settings of sensor 104 and parameters of the system 100 e.g., triggering conditional threshold (TCT) and further detects the event, and accordingly generates the notification. Further, through communication interface 106, the logical unit 116 allows the bi-directional data exchange with the external world, for example, but not limited to, user device.

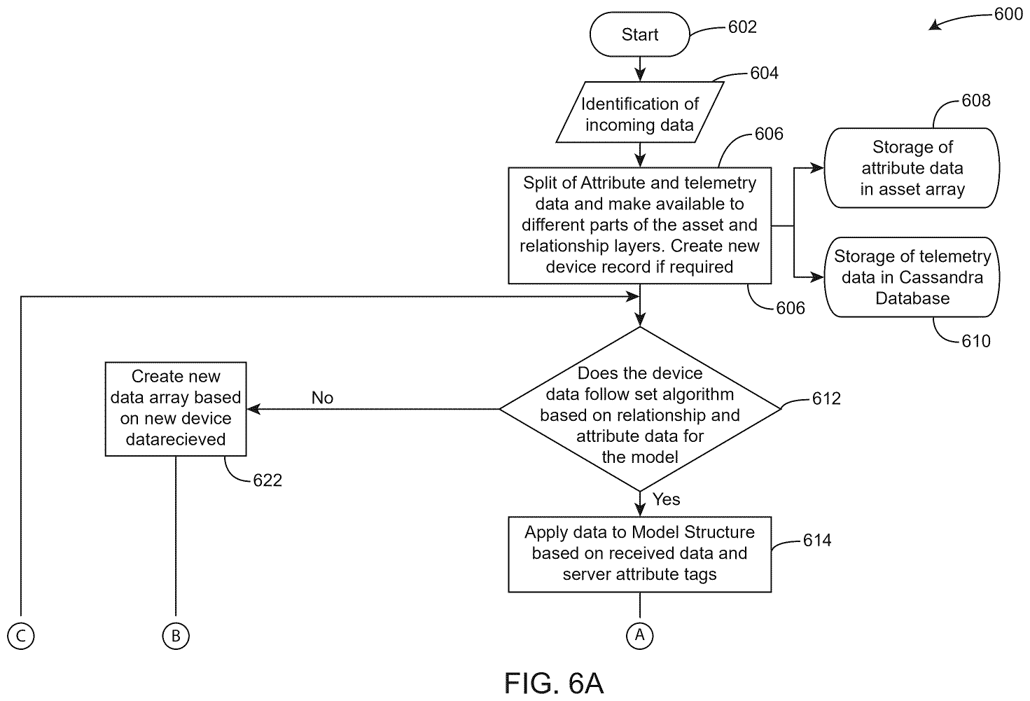

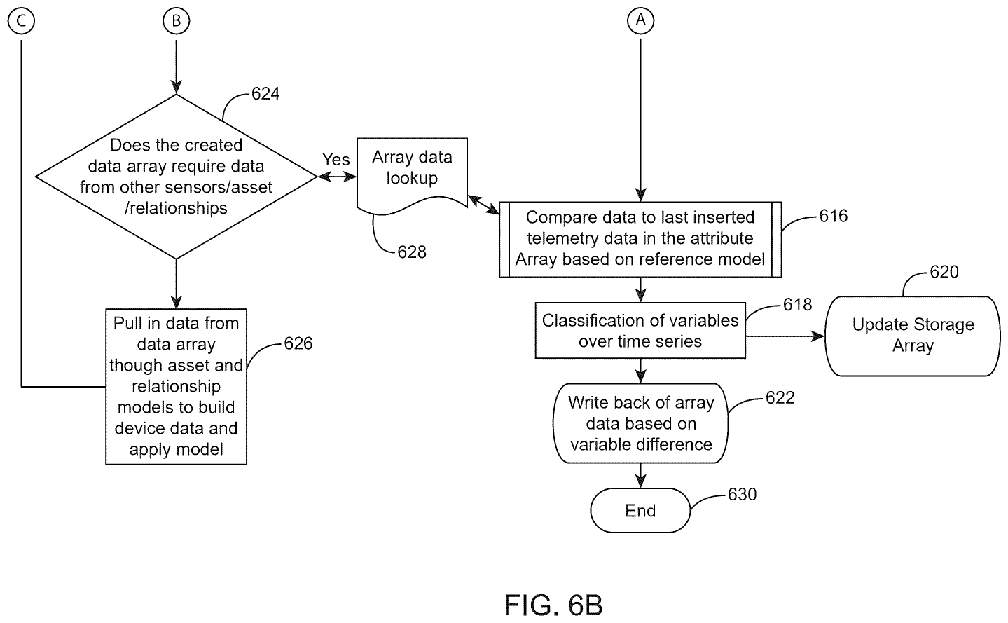

FIGS. 6A-6B are an exemplary flow charts illustrating a method of training machine learning model according to the present disclosure. At step 602, a process of training the machine learning model is started. At step 604, identification of incoming data is performed. The incoming data may be sensor data that is obtained from a plurality of sensors deployed for monitoring. In some aspects, the incoming data includes attributes of the sensors and telemetry data received from the sensors. At step 606, attributes and telemetry data are separated or split and provided to different parts of the asset and relationship layers of a multidimensional adaptive sensing system. Attributes refer to, for example, but not limited to, variables, fields, or predictors that describe the characteristics or state of an entity such as environmental condition. For example, attributes may include, but not limited to, temperature, gas density, and CO₂ concentration etc. The telemetry data represents a stream of information generated by various sensors or devices deployed in the multidimensional adaptive sensing system.

If required, a new device record is created at step 606. If the incoming data comprises new data corresponding to a new device (e.g., sensor A), then the new device record comprising information characterizing the new device is created or generated. At step 608, the attributes data is stored in an asset array. The asset array organizes and categorizes the attributes data for further processing. At step 610, the telemetry data is stored in a database, for example, a NoSQL database, such as an Apache Cassandra™ database.

At step 612, it is checked whether the device data follows a set algorithm based on relationship and attribute data for the model. In some aspects, the model is configured as a recurrent neural network (RNN) model. If yes, the method proceeds to step 614. If no, the method proceeds to step 622. At step 614, the device data is applied to a model structure based on received data and server attribute tags. At step 616, data is compared with last inserted telemetry data in an attribute array based on a reference model. At step 618, classification of variables over time series is performed. At step 620, storage array is updated with classified variables. At step 622, writing back of array data based on variable difference is performed to generate the initial model.

If the device data does not follow set algorithm, a new data array is created based on new device data received at step 622. At step 624, it is checked whether the created data array requires data from other sensor or asset or relationship models. If no, the method proceeds to step 626. If yes, the method proceeds to step 628. At step 626, generating device data by pulling data array through asset and relationship models and then proceeds to step 612. If the created data array requires data from other sensor or asset or relationship models, data lookup operation on the array models is performed at step 628 to identify other data required for created data array and proceeds to step 626. At step 630, the process ends.

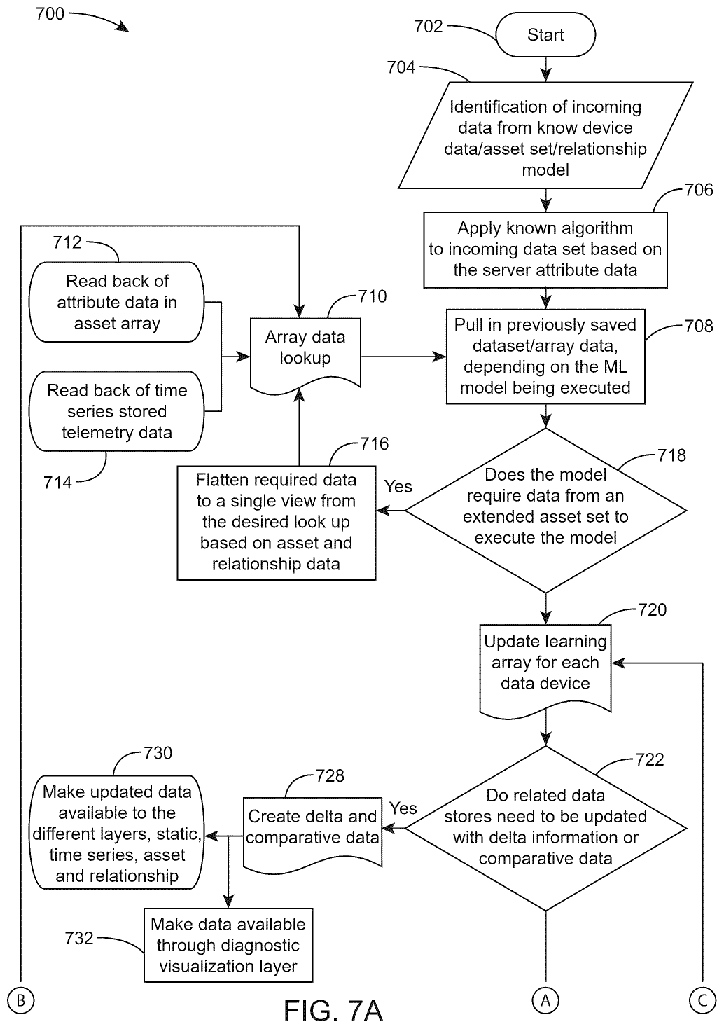

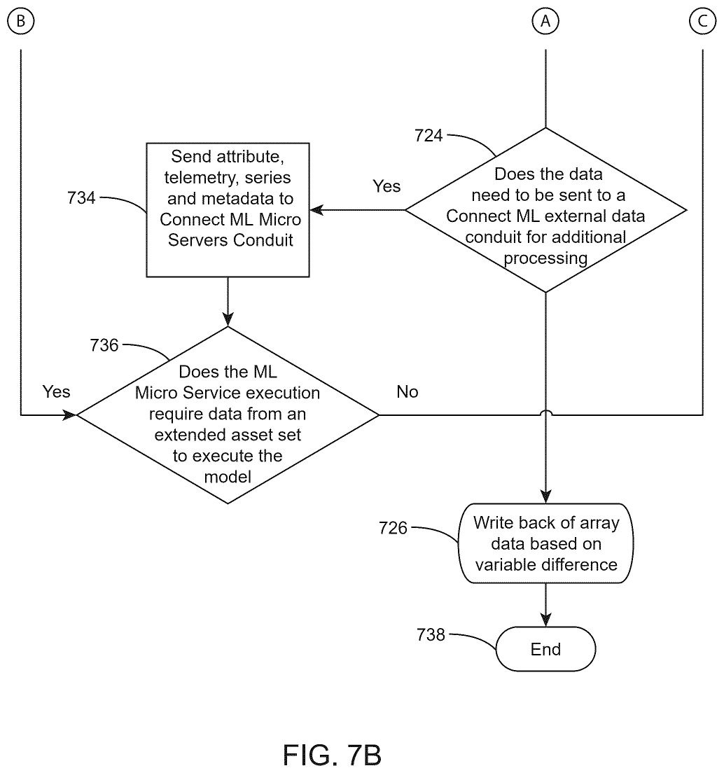

FIGS. 7A-7B are exemplary flow charts illustrating a method of training a machine learning model of a multidimensional adaptive sensing system according to the present disclosure. At step 702, the process of training the machine learning model is started. In some aspects, the machine learning model that is referenced for FIGS. 7A-7B is the same machine learning model that referenced in FIGS. 6A-6B. The machine learning model may be a baseline model or a compound model. At step 704, identification of incoming data from a known device data or an asset set or a relationship model is performed. At step 706, the set algorithm is applied to the incoming data based on a server attribute data. In some aspects, an edge computing unit receives or accesses attribute data, wherein the system evaluates if the current model being used is suitable based on the attribute data. If the model is determined to be suitable, no change is needed. However, if the model is not suitable, the system will connect to the server to request a suitable model.

At step 708, saved data set or array data set is obtained depending on or based on the ML model being executed. At step 710, array data lookup operation is performed to obtain the saved data set or array data set. In some aspects, the server is configured to obtain a suitable, or most suitable model, to match the current array of identified devices. Using matching rules, the server is configured to transmit the suitable model or models, which are then loaded and activated as part of the system.

At step 712, the attribute data which is already stored, is read back and sent to step 708 for further processing. At step 714, timeseries of stored telemetry data which is already stored, is read back and sent to step 708 for further processing. At step 718, it is checked whether the model requires data from an extended asset set to execute the model. In some aspects, the extended asset set includes one or more peripherals and/or sensors.

In certain aspects, the machine learning models are trained on a set of input data including attributes and telemetry data generated by one or more sensors and propagated throughout the network. The gateway is configured to direct a copy of this data to the loaded machine learning model for evaluation. Another copy of the data is sent to the server for various purposes, including historical logging, compliance, and investigation is an abnormality is detected.

If data is required from an extended asset set, the method proceeds to step 716. At step 716, required data is flattened into a single view from the desired data lookup based on the asset and relationship data and the flattened data is further processed at step 708. If data is not required from the extended asset set, the method proceeds to step 720. At step 720, learning array for each device is updated based on the obtained data set/array data. In some aspects, the system is configured to store and access a database of pre-trained machine learning models. Each pre-trained machine learning model is suitable for a sensor, or array of sensors. As one example, a sensing device configured as a fire alarm may comprise a temperature sensor and a smoke detector sensor. Thus, a machine learning model is trained for that particular combination of sensors. If a new sensing device, such as a moisture sensor, is connected to the network, the system is configured to identify a new machine learning model that is suitable for the combination of a temperature sensor, smoke detector sensor, and moisture sensor.

At step 722, it is checked whether the related data stores are to be updated with delta or comparative data. For example, once a sensor is connected to the network, the gateway detects the new sensor and queries the server for a new model, if the current model is not suitable. If related data stores are not required to be updated, the method proceeds to step 724. If related data stores are to be updated, the method proceeds to step 728. At step 724, it is checked whether the learning data is to be sent to ML external data conduit. In some aspects, the learning data includes the telemetry data generated by the sensor after decay conditions are induced within the sensors, thus providing a lifecycle model of the sensor's behavior under deteriorating conditions. If learning data is not required to be sent, the method proceeds to step 726. At step 726, the array data is overwritten based on variable difference. At step 728, delta or comparative is created if the related data stores are required to be updated.

At step 730, the updated data is provided to different layers such as static layers, time series layers, asset and relationship layers. In step 732, the updated data is provided to different layers via a diagnostic visualization layer. If the learning data is required to be sent, the attribute data, telemetry, series, and metadata are sent to machine learning micro server conduits at step 734. At step 736, it is checked whether the machine learning micro service execution requires data from an extended asset set to execute the model. If yes, the method proceeds to step 710. If no, the method proceeds to step 720. At step 738, the training method ends.

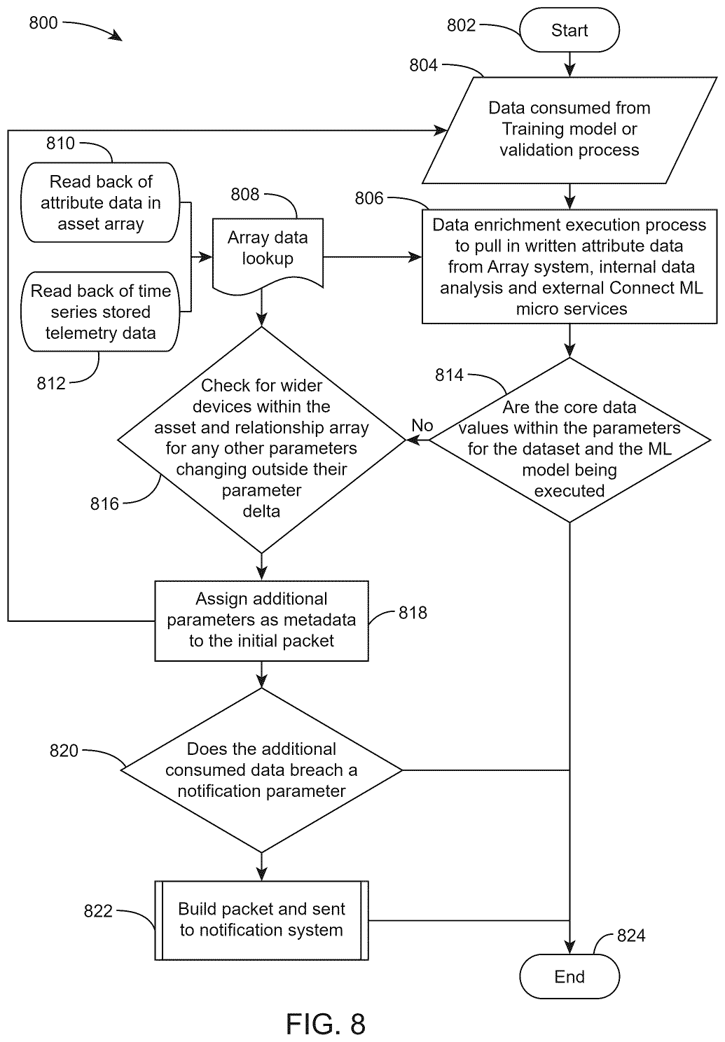

FIG. 8 is an exemplary flow chart illustrating a method of validating a machine learning model of a multidimensional adaptive sensing system according to the present disclosure. At step 802, the method of validation begins. At step 804, data from training model, for example, the model referenced in FIGS. 7A-7B, or validation process is obtained. At step 806, data enrichment process is performed by obtaining attribute data from an array system, internal analysis and external machine learning micro services. At step 808, the array data lookup is performed for data enrichment. At step 810, attribute data is obtained from the asset array and sent to step 806. At step 812, stored timeseries telemetry data is obtained and sent to step 806.

At step 814, it is checked whether the core data values within parameters for the dataset and the machine learning model are being executed. If yes, the method proceeds to step 824. If no, the method proceeds to step 816. At step 816, it is checked whether wider devices within the asset and other relationship array for any other parameters changing outside their parameter delta. In other words, the system monitors the devices connected to the network and determines whether any operational parameters of the different devices do not meet acceptable thresholds. If yes, the method proceeds to step 818. At step 818, additional parameters are assigned as metadata to the initial packet. The metadata is sent to step 804. At step 820, it is checked whether additional consumed data breach a notification parameter. If yes, at step 822, a packet is built and sent to a notification system. At step 824, the validation method ends.

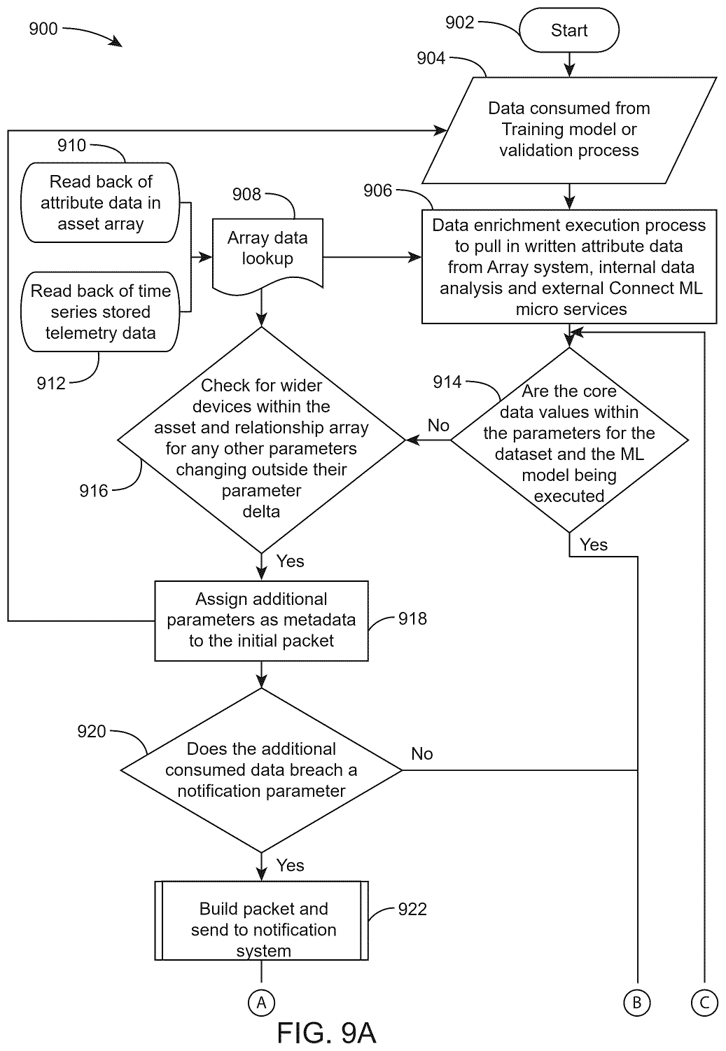

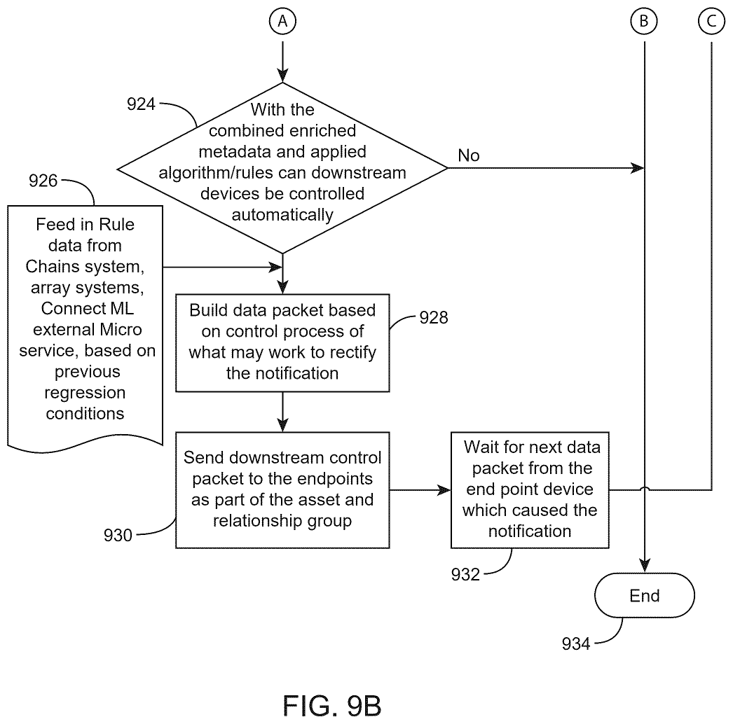

FIGS. 9A-9B are an exemplary flow charts illustrating a method of adaptive learning and decision making using a machine learning model or an artificial intelligence (AI) model of a multidimensional adaptive sensing system according to the present disclosure. At step 902, the method of adaptive learning and decision making is started. At step 904, data is obtained from a training model or a validation process. At step 906, data enrichment process is executed by obtaining written attribute data from an array system, internal data analysis and external machine learning micro services. At step 908, array data lookup process is performed to enrich the data. At step 910, the attribute data in the asset array is obtained and sent to step 906. At step 912, the time series telemetry data is obtained and sent to step 906.

At step 914, it is checked whether core data values within the parameters for the dataset and the machine learning model being executed. If yes, the method proceeds to step 934. If no, the method proceeds to step 916. At step 916, it is checked whether wider devices within the asset and relationship array for any other parameters changing outside their parameter delta. If yes, at step 918, additional parameters are assigned as metadata to an initial packet. The assigned data is sent to step 904. At step 920, it is checked whether the additional consumed data breach a notification parameter. If no, the method proceeds to step 934. If yes, the method proceeds to step 922. At step 922, a packet is built and sent to the notification system. At step 924, it is checked whether with the combined enriched metadata and applied algorithm/rules can downstream devices be controlled automatically. If no, the method moves to step 934. If yes, the method proceeds to step 928.

At step 928, data packet is built based on control process of what may work to rectify the notification. While building data packet, rule data from chains system, array systems, machine learning external micro service is fed based on previous regression conditions at step 926. At step 930, downstream control packet is sent to end points as part of the asset and relationship group. At step 932, to the system waits to receive the next data packet from the end point device which caused the notification, then the received next data packet is sent to step 914. At step 934, the method ends.

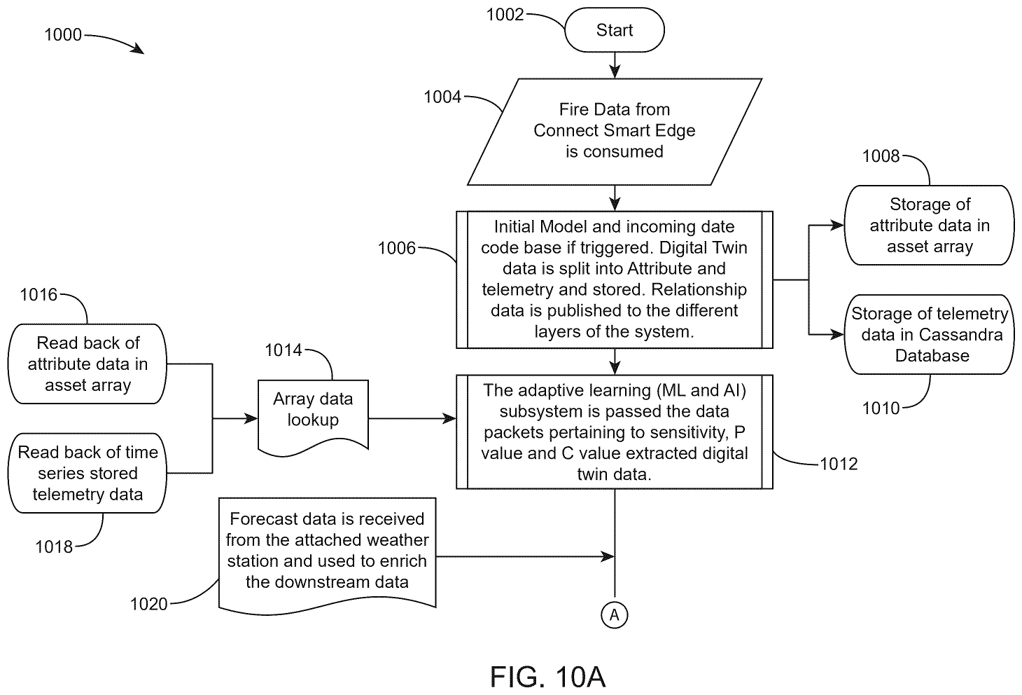

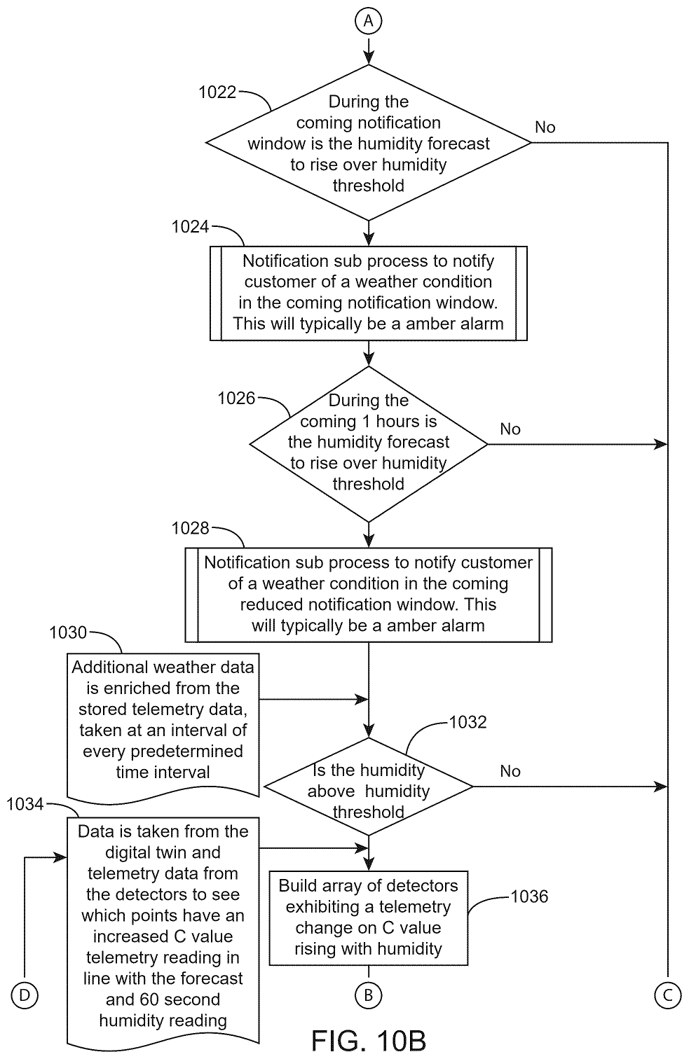

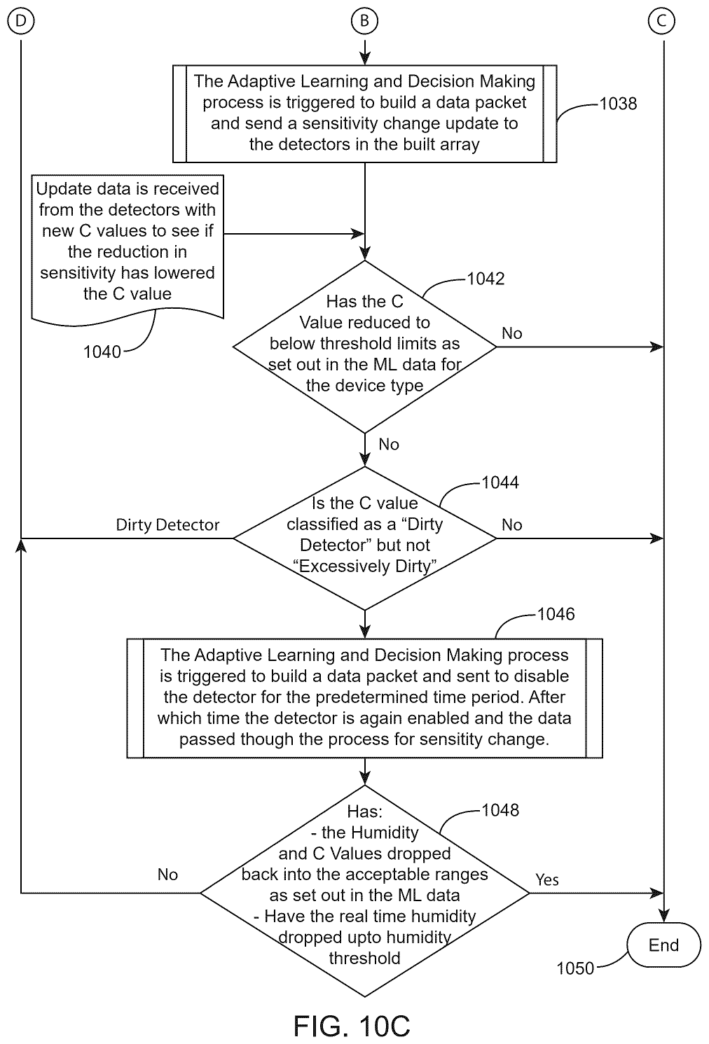

FIGS. 10A-10C are exemplary flow charts illustrating a method of adaptive learning and decision making in a fire alarm system using a machine learning model or an artificial intelligence (AI) model according to the present disclosure. At step 1002, the method of managing the fire alarm system is started. At step 1004, fire data is obtained from a smart edge connect. At step 1006, the initial model and incoming data code base if triggered, the initial model is updated with incoming data. Further, digital twin data is split into attribute data and telemetry data and is stored. Furthermore, relationship data is provided or published to different layers of the system. At step 1008, the attribute data is stored in the asset array. At step 1010, the telemetry data is stored in a NoSQL database such as an Apache Cassandra™ database. At step 1012, the adaptive learning subsystem is passed the data packets pertaining to sensitivity, p value and c value mediated digital twin data. At step 1014, array data lookup process is performed. At step 1016, the attribute data is obtained in the asset array and sent to step 1012. At step 1018, the time series telemetry data is obtained and sent to step 1012. At step 1020, forecast data is received from the attached weather station and used to enrich the downstream data. At step 1022, it is checked whether during coming notification window (in a non-limiting example, 3 hours) if the humidity is forecasted to rise over the humidity threshold (in a non-limiting example 80%). If yes, the method proceeds to step 1024. If no, the method proceeds to step 1050. At step 1024, notification subprocess is activated to notify a user regarding weather condition in the upcoming notification window (e.g., 3 hours). The notification may be an amber alarm. At step 1026, it is checked whether during coming reduced notification window (in a non-limiting example, 1 hour) if the humidity is forecasted to rise over the humidity threshold (e.g., 80%). If yes, the method proceeds to step 1028. If no, the method proceeds to step 1050. At step 1028, notification subprocess is activated to notify a user regarding weather condition in the upcoming reduced notification window (e.g., 1-hour). At step 1030, additional weather data is enriched from the stored telemetry data taken at an interval of every predetermined time interval (in a non-limiting example, 60 seconds). At step 1032, it is checked whether humidity is above 80% based on the enriched data. If yes, the method proceeds to step 1036. If no, the method proceeds to step 1050. At step 1034, the data is taken from the digital twin and telemetry data from the detectors to view which points have an increased c value telemetry reading in line with the forecast and 60 second humidity reading. At step 1036, an array of detectors exhibiting a telemetry change on c value rising with humidity, are built.

At step 1038, the adaptive learning and decision-making process is triggered to build a data packet and the sensitivity update is sent to the detectors in the built array. At step 1040, update data is received from the detectors with new c values to determine if the reduction in sensitivity has lowered the c value. At step 1042, it is checked whether the c value reduced to below threshold limits as set out in the machine learning model data for the device types. If yes, the method proceeds to step 1044. If no, the method proceeds to step 1050. At step 1044, it is checked whether the c value is classified as a “dirty detector” but not “excessively dirty detector”. If classified as “excessively dirty detector”, the method proceeds to step 1050. If classified as “dirty detector”, the method proceeds to step 1034 and 1042.

At step 1046, the adaptive learning and decision-making process is triggered to build a data packet and send to disable the detector for the predetermined time period (in a non-limiting example, 10 mins). After which time, the detector is again enabled, and the data passed through the process for sensitivity change. At step 1048, it is checked whether the humidity and c values dropped back into the acceptable ranges as set out in the machine learning model data have the real-time humidity dropped below a humidity threshold (e.g., 80%). If yes, the method proceeds to step 1050. If no, the method proceeds to step 1034. At step 1050, the method ends.

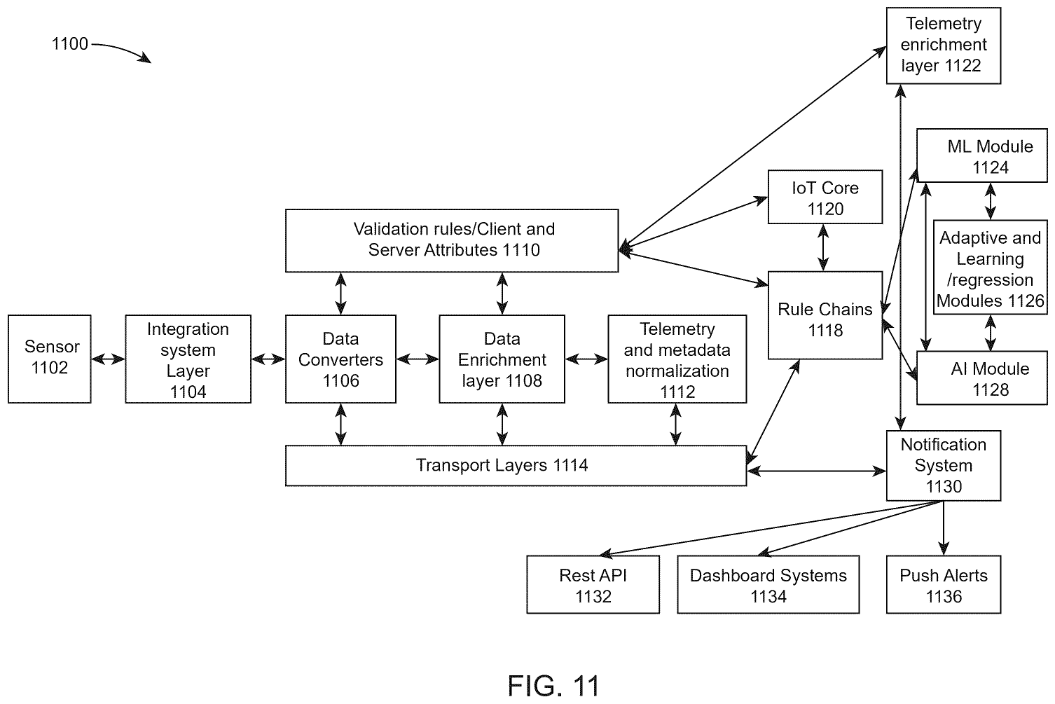

In second embodiment of the present disclosure, a multidimensional adaptive sensing system 1100 is configured to monitor sensor's health and performance, deployed within the system. Referring to FIG. 11, a multidimensional adaptive sensing system 1100 to monitor sensor's health and performance is illustrated, according to the second embodiment of the present disclosure. The system 1100 illustrates the feedback mechanism to identify potential sensor decay or malfunction, by analysing data deviations in sensor's data. The system 1100 is configured to generate the recommendations for maintenance actions or sensor replacement and communicate it to the system administrators. The system 1100 employs advanced algorithms and machine learning models to continuously assess the condition and performance of each sensor deployed within the network. By analysing sensor's data in real-time, the system 1100 identifies the sensor degradation or environmental impact and then automatically adjusts operational parameters to maintain optimal accuracy and reliability of the system 1100. Upon detecting potential sensor's health degradation, the system 1100 proactively adjusts its operational parameters, such as detection thresholds and sensitivity settings, to compensate for any identified anomalies or degradation. Integrating autonomous health monitoring and self-adjusting capabilities enables the system 1100 to proactively minimize downtime and extend sensor lifespan, ensuring the system 1100 adapts dynamically to both internal and external changes. The system 1100 promises significant advancements in the field of sensing systems, offering enhanced detection accuracy and resilience across various applications, including environmental monitoring, industrial safety, and smart infrastructure.

Referring to FIG. 11, a multidimensional adaptive sensing system 1100 comprises sensor modules, logical unit, data aggregation module, communication interface, health monitoring engine, and operational adjustment mechanism. The system 1100, as depicted in FIG. 11 comprises one or more sensors 1102, an integration system layer 1104, data converters 1106, a data enrichment layer 1108, validation rules 1110, a telemetry and metadata normalization layer 1112, a transport layer 1114, rule chains 1118, IoT core 1120, telemetry enrichment layer 1122, ML module 1124, adaptative and learning/regression modules 1126, an AI module 1128, a notification system 1130, rest API 1132, a dashboard system, 1134, and push alerts module 1136.

With continued reference to FIG. 11, the one or more sensors 1102, the integration system layer 1104, the data converters 1106, the data enrichment layer 1108, the validation rules 1110, the telemetry and metadata normalization layer 1112, the transport layer 1114, the rule chains 1118, the IoT core 1120, are substantially the same as the one or more sensors 402, the integration system layer 404, the data enrichment layer 408, the validation rules 410, telemetry and metadata normalization layer 412, the transport layer 414, the rule chains 418, the IoT core 420, respectively, as described previously herein. Thus, it is to be understood herein that the description about the same has not been repeated herein for the sake of conciseness.

As depicted in FIG. 11, the machine learning (ML) module 1124 comprises a plurality of interconnected processing nodes configured to execute machine learning algorithms to analyze received input data and generate output data. The adaptive and learning/regression modules 1126 are configured to perform the dynamic adjustment and predictive modelling within the system. The adaptive and learning/regression modules 1126 employ iterative processes to analyze data, adapt system parameters, and refine predictive models through regression techniques. The AI module 1128 comprises computational system configured to process and analyze data using advanced artificial intelligence techniques. The AI module 1128 employs machine learning algorithms and neural network architectures to efficiently handle complex tasks such as pattern recognition, natural language processing, and decision-making.

The notification system 1130 comprises a processor configured to receive event data and determine notification parameters based on predetermined criteria. The notification system 1130 further includes a communication module for transmitting notifications to one or more designated recipients via various communication channels. The REST API 1132 facilitates communication between system 1100 and external systems over a network, by providing authentication and authorization mechanisms to ensure secure interactions between endpoints.

The dashboard system 1134 comprises a graphical user interface (GUI) configured to display real-time data and analytics from the system 1100 in a single integrated platform. The dashboard system 1134 includes customizable widgets for monitoring key performance indicators (KPIs), with interactive features for further analysis. The push alerts module 1136 is configured for delivering notifications to users, administrator and the like. The push alerts module 1136 generates and transmits push alerts to designated devices via a communication network.

The system 1100 comprises health monitoring engine and operational adjustment mechanism additionally, with respect to the system 100, described previously. The ML module 1124, adaptive and learning/regression module 1126, AI module 1128 comprises the health monitoring engine and operational adjustment mechanism. The health monitoring engine uses machine learning and data analytics to continuously evaluate each sensor's health and performance. The health monitoring engine identifies potential issues, enabling proactive maintenance and optimization. Further, based on the health monitoring engine's insights, the operational adjustment mechanism autonomously modifies operational parameters of the system 1100 to enhance the system's accuracy and reliability. These adjustments ensure the system's 1100 adaptability to both internal and external changes.

For instance, as sensors 1102 undergo wear or as their operating environment changes, the health check and monitoring models provide actionable insights that trigger the dynamic recalibration of baseline and compound models. This ensures that the models reflect the most accurate representation of sensor capabilities and environmental conditions. Further, along with the immediate adjustments, the health monitoring data enables predictive maintenance. By anticipating sensor 1102 failures or significant environmental shifts, the system 1100 can proactively adjust the models to maintain uninterrupted, accurate operation. This predictive capability ensures the longevity and reliability of the sensing system 1100.

The system 1100 is configured to distinguish between true anomalies and false alarms by correlating data across sensors 1102 and against historical models. Anomalies could range from unexpected environmental conditions to hardware malfunctions. In some implementations, the system 1100 assesses the anomaly's nature, including whether it's a transient environmental factor or indicates a deeper issue with the sensor. Further, upon detection of an anomaly or a health issue, the system 1100 autonomously initiates adjustments. In some implementations, this includes recalibrating the sensor, modifying detection thresholds, or, in the case of identified sensor degradation, reducing its influence on the compound model's decisions. Adjustments are made in real-time, ensuring minimal disruption to system accuracy.

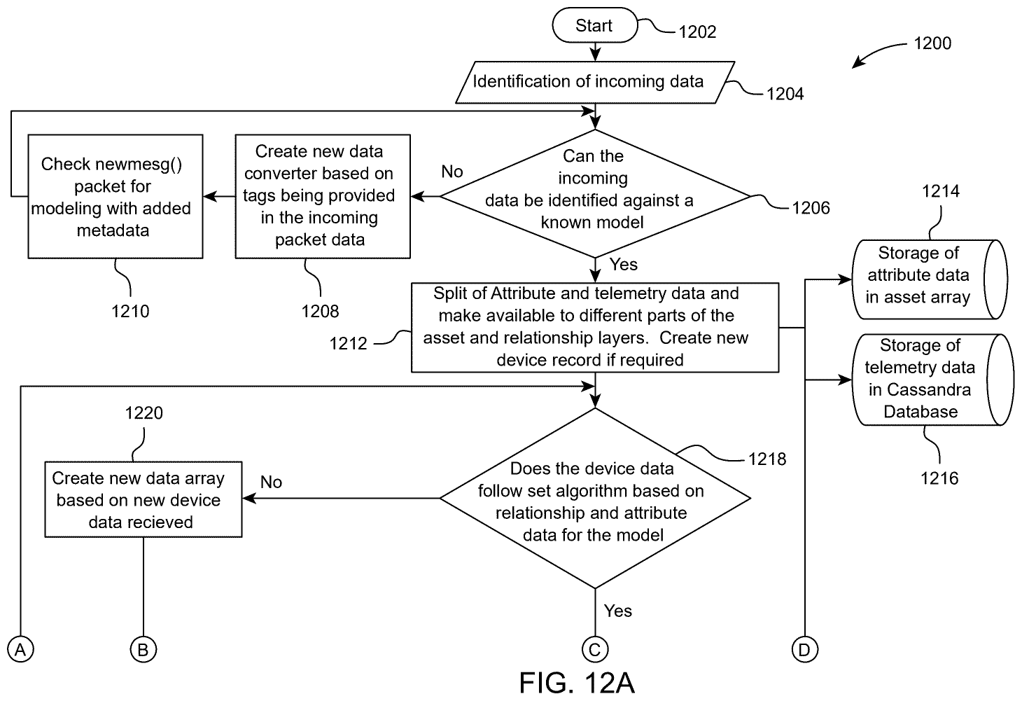

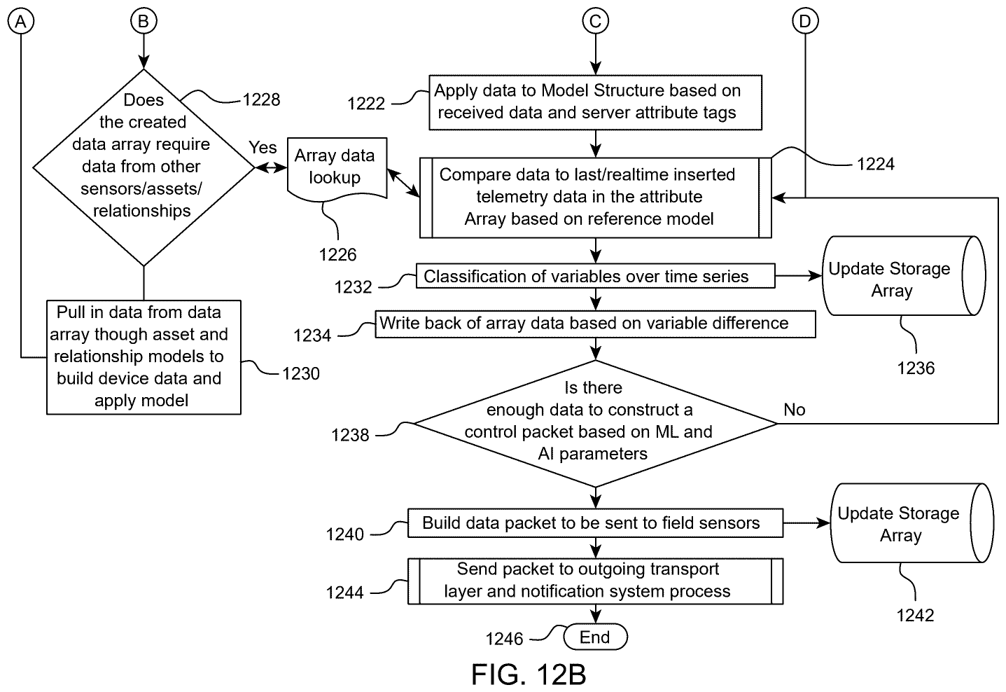

FIGS. 12A-12B illustrate exemplary flow charts illustrating a method of autonomous health monitoring and operational adjustment for the multidimensional adaptive sensing system according to the present disclosure. At step 1202, a process of autonomous health monitoring and operational adjustment for the multidimensional adaptive sensing system 1100 is started. At step 1204, identification of incoming data is performed. The incoming data may be sensor data that is obtained from a plurality of sensors 1102 deployed for monitoring. At step, 1206, identification of the incoming data is performed against a known model to the system 1100. If the incoming data is not identified against the known model, a new data converter is created based on tags provided in the incoming data packet, at step 1208. At step 1210, new message packet for modelling with metadata is checked for modelling, and then the method proceeds to step 1206. If the incoming data is identified against the known model, at step 1206, splitting of attributes and telemetry data is performed and provided to the asset and relationship layers, at step 1212.

Also, in some aspects, a new device record is created, if required. Attributes refer to, for example, but are not limited to, variables, fields, or predictors that describe the characteristics or state of an entity such as environmental condition. For example, attributes include, but are not limited to, temperature, gas density, and CO₂ concentration etc. The telemetry data represents a stream of information generated by various sensors or devices deployed in the adaptive sensing system 1100. At steps 1214, 1216, storage of attribute data in asset array and storage of telemetry data in a database, for example, but not limited Cassandra, are performed, respectively. At step 1218, a check is performed to confirm if the device data following set algorithms based on relationship and attribute data for the model. If yes, apply data to model structure based on received data and server attribute tags, at step 1222. But if no, new data array based on new device data received is created at step 1220.

At step 1228, a check is performed to identify that the created data array requires data from other sensors/assets/relationship. If yes, array data lookup at 1226 is referred at step 1226. If no, data is pulled from data array though asset and relationship models to build device data and apply model, at step 1230. At step 1224, comparison is performed to compare data to last or real-time inserted telemetry data in the attribute array based on reference model. At step, 1232, classification of variables over time series is performed, and then the method updates storage array, at step 1236, accordingly. At step 1234, data write is performed to write back of array data based on variable difference. At step 1238, a check is performed to check for enough data to construct a control packet based on ML and AI parameters, if yes, constructed data packet is sent to sensors 1102 of the system 1100 at step 1240, otherwise the method proceeds back to step 1224. At step 1244, packets to outgoing transport layer and notification system process are shared, to let the external environment, users, administrator and the like to know about the current adjustments made based to the adaptive sensing system 1100, based on the sensor's data.

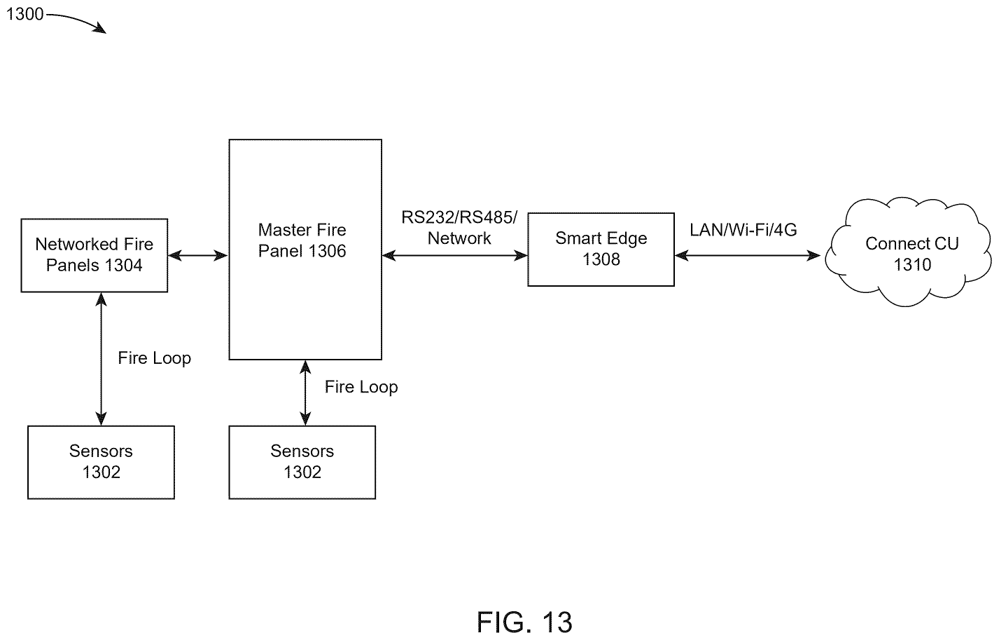

Referring to FIG. 13, an exemplary architecture overview of an edge-driven multidimensional adaptive sensing system 1300 of third embodiment is illustrated, in accordance the present disclosure. The edge-driven multidimensional adaptive sensing system 1300 leveraging edge computing units (ECUs) and a central control unit (CCU) for automated configuration, model deployment, and maintenance. The system 1300 is configured to streamline the setup process by automatically identifying sensor characteristics and determining the optimal combination of baseline and compound models for each sensor array. Utilizing metadata and machine learning algorithms, the system dynamically adjusts to environmental changes, seasonal variations, and network expansions, ensuring optimal performance without manual intervention. The CCU's intelligent decision-making capabilities allow for real-time adjustments and model updates, significantly enhancing detection accuracy and system's reliability across diverse applications. This edge-driven architecture provides a significant advancement in adaptive sensing technology, offering scalable, efficient, and self-configuring sensor networks for a wide range of monitoring and detection tasks.

The edge-driven multidimensional adaptive sensing system 1300 comprises one or more sensors 1302, one or more ECUs 1304, at least one master ECU 1306, smart edge device 1308, and CCU 1310, as depicted in the FIG. 13. In some embodiments, the one or more sensors 1302 can include sensors to measure, but are not limited to, temperature, smoke, CO₂, humidity, airflow, variable air volume (VAV), human presence, sunlight exposure, or the like be considered within the scope of the disclosure. For example, for an edge-driven multidimensional adaptive fire alarm system, the one or more sensors can be a temperature sensor, a smoke sensor, a CO₂ sensor, and the like.

The one or more sensors 1302 are communicatively coupled to the one or more ECUs 1304 and at least one master ECU 1306. The ECUs 1304 and 1306 comprise a compact and autonomous computing device situated proximate to the sensors 1302, thereby minimizing latency in data processing and transmission. The ECUs are equipped with processing, storage, and networking capabilities, facilitating real-time analysis and decision-making at the network's edge. For example, for an edge-driven multidimensional adaptive fire alarm system, the one or more ECUs 1304 can be networked fire panels. Further, at least one master ECU 1306 can be interconnected with the one or more ECUs and/or with the sensors 1302 can be a master fire panel.

Further, a smart edge device 1308 connect the master ECU e.g., master fire panel, with the CCU 1310. The CCU 1310 can be a centralized server, by way of example, but not limitation, a SIBCA connect system.

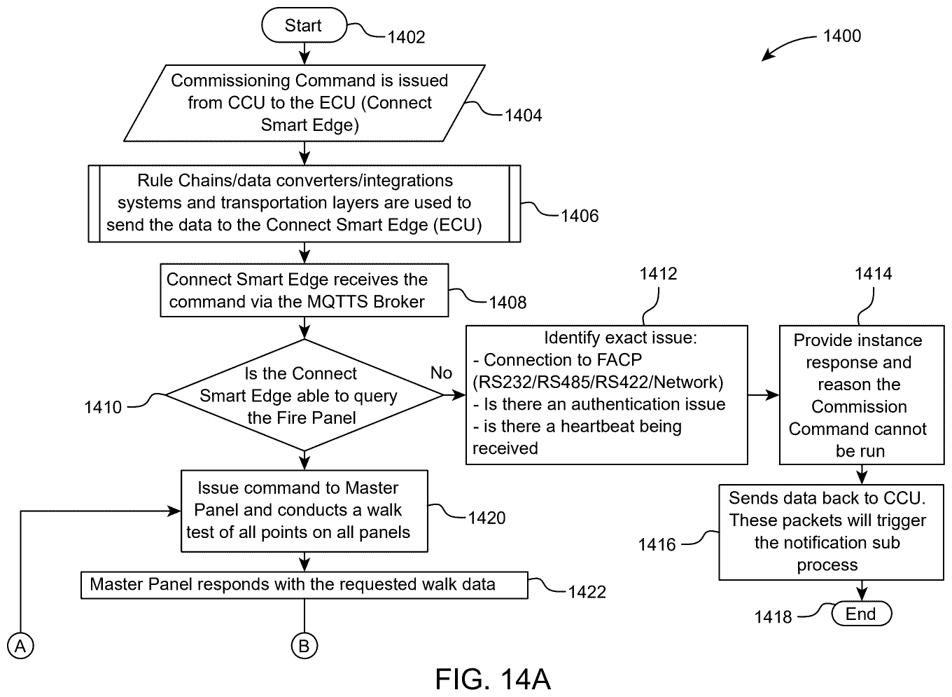

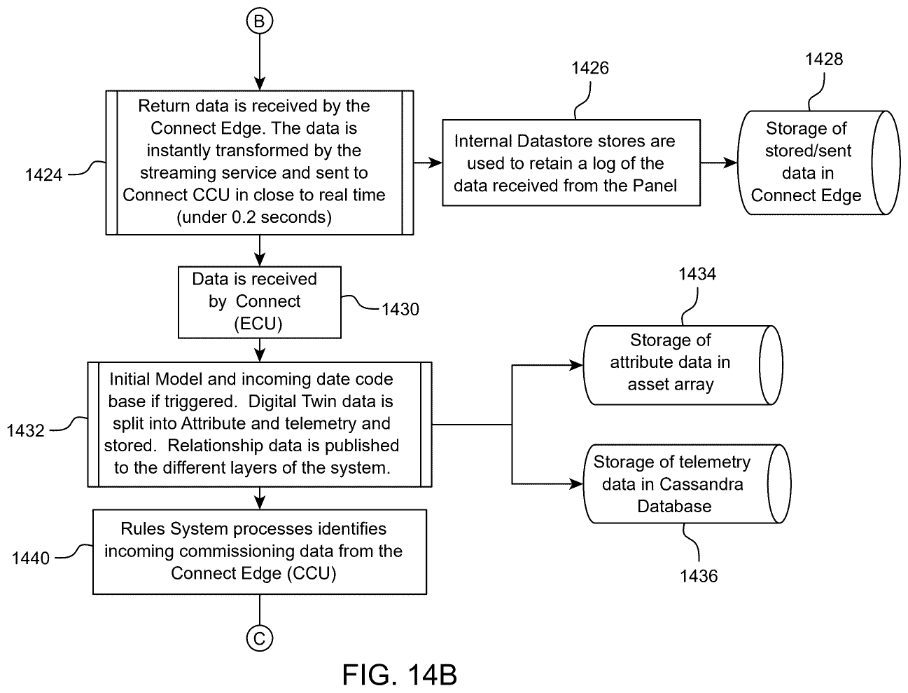

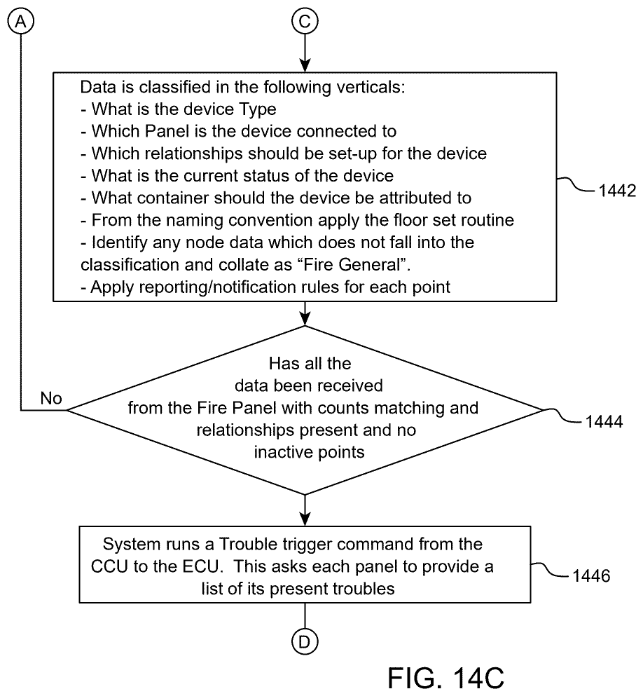

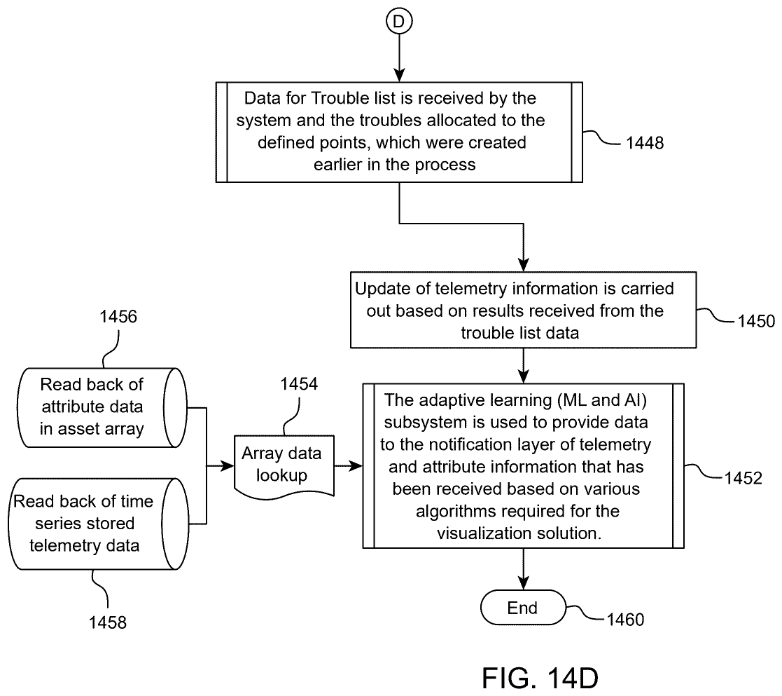

FIGS. 14A-14D are exemplary flow charts illustrating a method of automated configuration process for an edge-driven multidimensional adaptive sensing system 1300 according to the present disclosure. The method starts at step 1402. At step 1404, a commissioning command is issued from CCU 1310 (e.g., SIBCA Connect) to the ECU 1304 (Connect Smart Edge). At step 1406, a pre-defined rule chains/data converters/integrations systems and transportation layers are employed to send the data to the connect smart edge (ECU) 1304. At step 1408, connect smart edge receives the command via the MQTTS Broker. At step 1410, a check is made to confirm that: “Is the Connect Smart Edge able to query the Fire Panel”, if no, then the method identifies exact issue for why the Connect Smart Edge is not able to query the Fire Panel at step 1412. The issues include, but not limited to, an issue with the connection to FACP (RS232/RS485/RS422/Network), an authentication issue, and/or a heartbeat being received.

Further, at step 1414, the process provides instance response and reason for commission command not being run, then at step 1416, the method sends data back to CCU (e.g., SIBCA Connect) and data packets will trigger the notification sub process, the process ends at step 1418. If the method finds ‘yes’ at step 1420, a command is issued to Master Panel 1306 and conducts a walk test of all points on all panels 1304. At step 1422, Master Panel 1306 responds with the requested walk data. At step 1424, return data is received by the Smart Edge/Connect Edge 1308. The data is instantly transformed by the streaming service and sent to Connect CCU 1310 in close to real time.

At step 1426, internal datastore stores are used to retain a log of the data received from the panel and storage of stored/sent data in Connect Edge is performed at step 1428. At step 1430, data is received by Connect (ECU) 1304, and then initial model and incoming date code base if triggered. In some aspects, the log of the data includes digital twin data, including attribute data, telemetry data, and relationship data. Further, digital twin data is split into attribute and telemetry and stored. Also, relationship data is published to the different layers of the system, at step 1432. At steps 1434 and 1436, storage of attribute data in asset array and storage of telemetry data in a database is performed respectively.

At step 1440, rules system processes identifies incoming commissioning data from the Connect Edge (CCU) and classify data into one or more verticals that includes, but not limited to device Type, which Panel is the device connected to, which relationships should be set-up for the device, what is the current status of the device, what container should the device be attributed to, from the naming convention apply the floor set routine, identify any node data which does not fall into the classification and collate as “Fire General”, apply reporting/notification rules for each point and the like, at step 1442.

At step 1444, a check is made to confirm that all the data has been received from the Fire Panel with counts matching and relationships present and no inactive points, if no, the process proceeds to step 1420, otherwise, at step 1446, system runs a trouble trigger command from the CCU 1310 to the ECU 1304. This asks each panel 1304 to provide a list of its present troubles. Further, at step 1448, data for trouble list is received by the system 1300 and the troubles allocated to the defined points, which were created earlier in the process. At step 1450, update of telemetry information is carried out based on results received from the trouble list data. At step 1452, the adaptive learning (ML and AI) subsystem is used to provide data to the notification layer of telemetry and attribute information that has been received based on various algorithms required for the visualization solution. Also, at step 1452, attribute data and telemetry data are read back through array data lookup at steps 1456 and 1458, respectively. The method ends at step 1460.

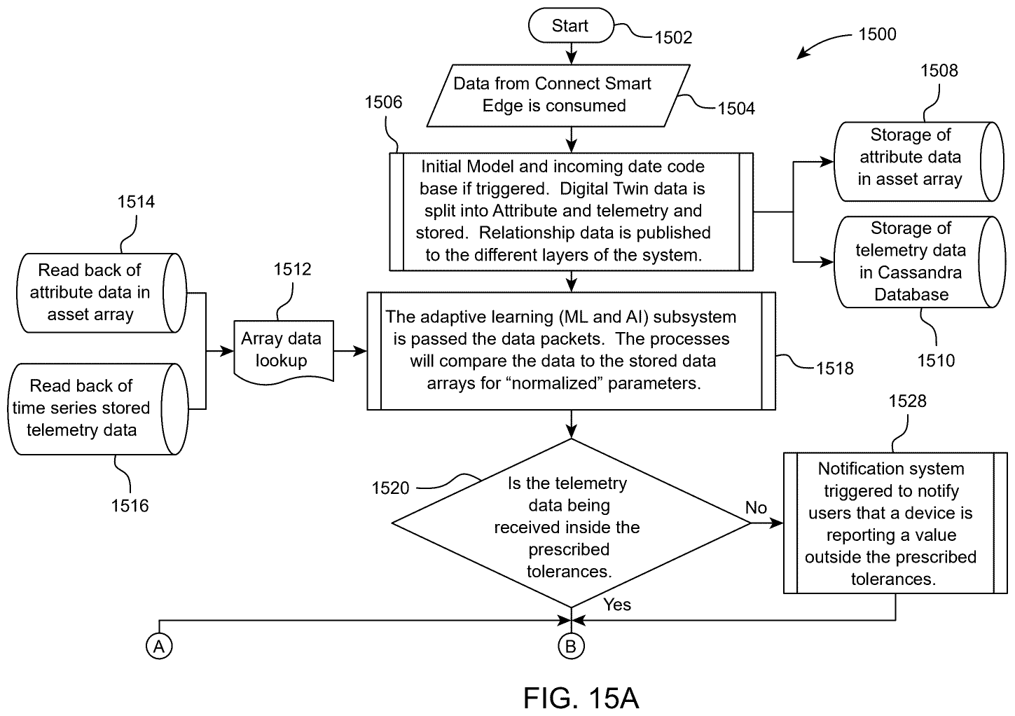

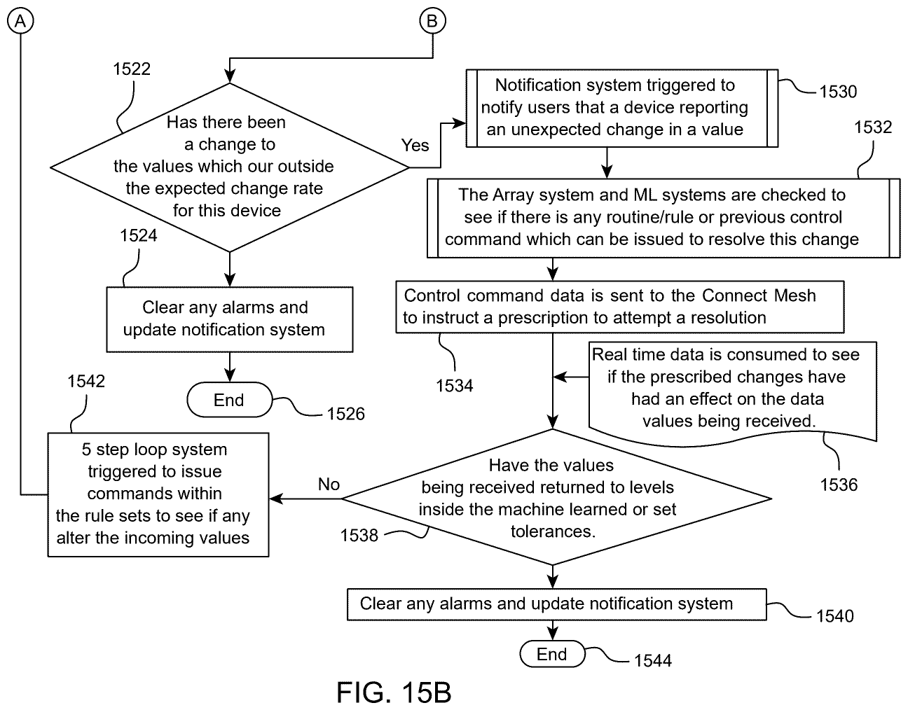

FIGS. 15A-15B are exemplary flow charts illustrating a method of automated sensor health monitoring and maintenance in the edge-driven multidimensional adaptive sensing system of an embodiment in accordance with the present disclosure. At step 1502, the method of automatic deployment and management of sensors is started. At step 1504, input data is obtained from a data source. The data source may be a connected smart edge. At step 1506, the initial model and incoming data code base if triggered, the initial model is updated with incoming data. Further, digital twin data is split into attribute data and telemetry data and is stored, Furthermore, relationship data is provided or published to different layers of the system.

At step 1508, the attribute data is stored in the data array. At step 1510, the telemetry data is stored in a database, for example a NoSQL database such as an Apache Cassandra™ database. At step 1512, data array lookup operation is performed. At step 1514, attribute data from the asset array is obtained and sent to step 1518. At step 1516, time series telemetry data is obtained and sent to step 1518. At step 1518, the adaptive learning (ML and AI) subsystem is passed the data packets. Then, the method compares data to the stored data arrays for normalized parameters. At step 1520, it is checked whether the telemetry data being received inside the prescribed tolerances. If yes, the method proceeds to step 1522. If no, the method proceeds to step 1528. At step 1522, it is checked whether there has been a change to the values which are outside the expected change rate for a device. If yes, the method proceeds to step 1530. If no, the method proceeds to step 1524. At step 1524, it is cleared any alarms and update notification in the system. At step 1526, the process is ended.

At step 1528, notification system is triggered to notify users that a device is reporting a value outside the prescribed tolerances and then proceeds to step 1522. At step 1530, the notification system is triggered to notify users that a device is reporting an unexpected change in a value. At step 1532, the array systems and machine learning systems are checked to determine if there is any routine/rule or previous control command which can be issued to resolve this change. At step 1534, control command data is sent to a central control unit to instruct a prescription to attempt a resolution.

At step 1536, real time data is consumed to determine if the prescribed changes have had an effect on the data values being received. At step 1538, it is checked whether the values being received returned to levels inside the machine learned or set tolerances. If no, the method proceeds to step 1542. If yes, the method proceeds to step 1540. At step 1540, it is cleared any alarms and update notification system and proceeds to step 1544. At step 1542, five step loop system triggered to issue commands within the rule sets to determine if any alter the incoming values and proceeds to step 1522. At step 1544, the method ends.

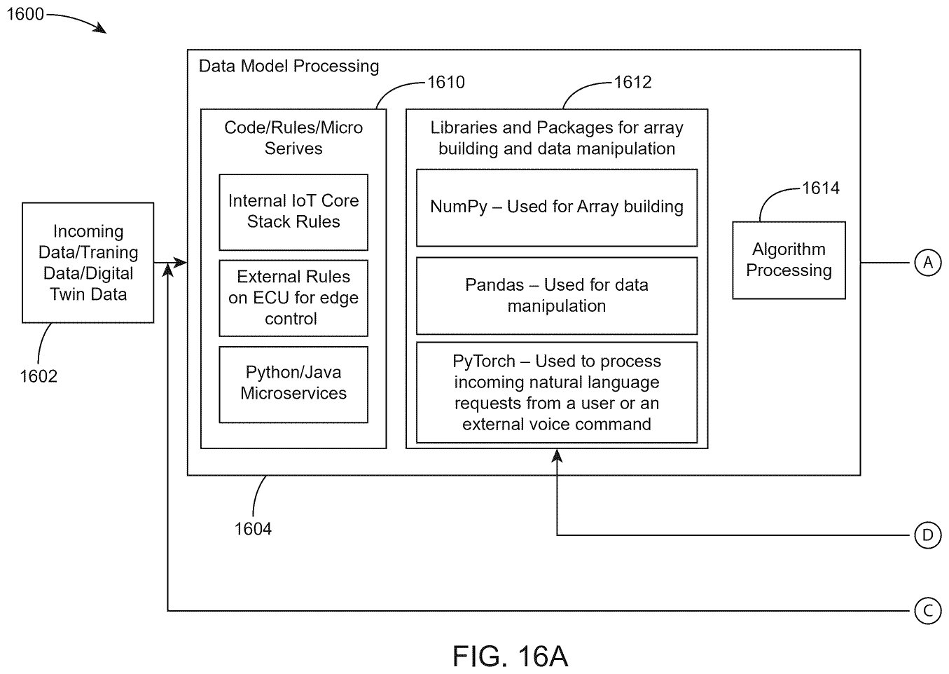

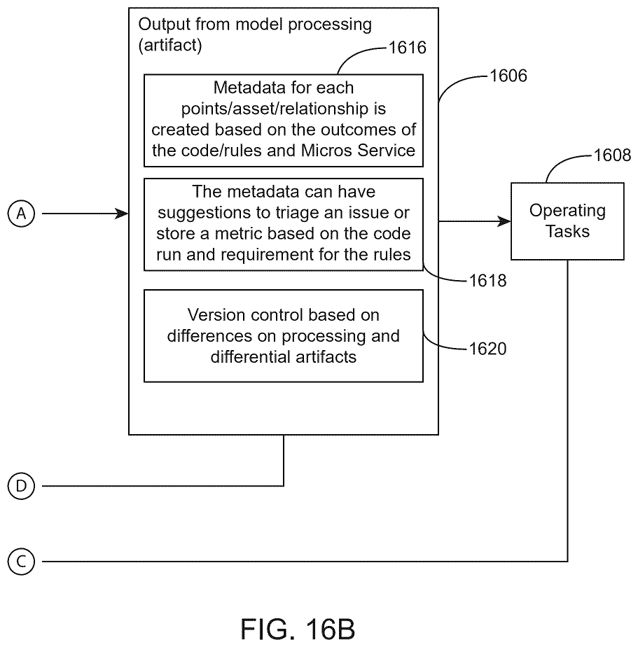

FIGS. 16A-16B are exemplary flow charts illustrating a process of registering models correlation tagging in the edge-driven multidimensional adaptive sensing system of an embodiment according to the present disclosure. The method illustrates how models are tagged with metadata for correlation with specific sensor types, environmental conditions, and other relevant factors. Further, method illustrates how these tags are used to select and deploy the most suitable models for each scenario. At step 1602, at least one of incoming data, training data or digital twin data is received. At step 1604, the data model is processed based on the incoming data, training data or digital twin data. The data model processing utilizes code or rules or micro services 1610, libraries and packages 1612, algorithm processing 1614 for processing the incoming data, training data or digital twin data through the one or more machine learning models and generating output from the one or more machine learning models. The code or rules or micro services 1610 may include, but not limited to, internal IoT core stack rules, external rules on ECU for edge control and python or java microservices. The libraries and packages 1612 may include, but not limited to, array building, data manipulation, and natural language processing. In one example, NumPy used for array building. In another example, Pandas is used for data manipulation. In yet another example, PyTorch™ is used to process incoming natural language requests from a user or an external voice command. At step 1606, the output from the one or more machine learning models are processed. The output processing includes i) creating metadata for each point or asset or relationship based on the outcomes from the code or rules or micro services 1610, ii) providing suggestions based on the metadata to triage an issue or store a metric based on the code run and requirement for the rules, (iii) performing version control of the one or more machine learning models based on differences on processing and differential artifacts. At step 1608, operating tasks or specific tasks such as decision making using the adaptive machine learning models.

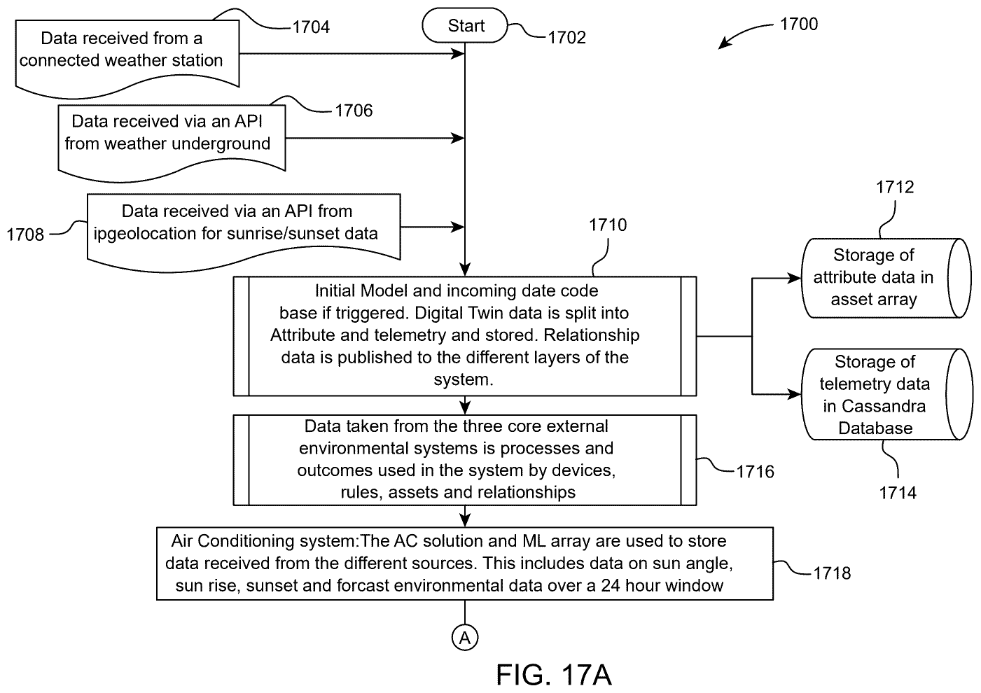

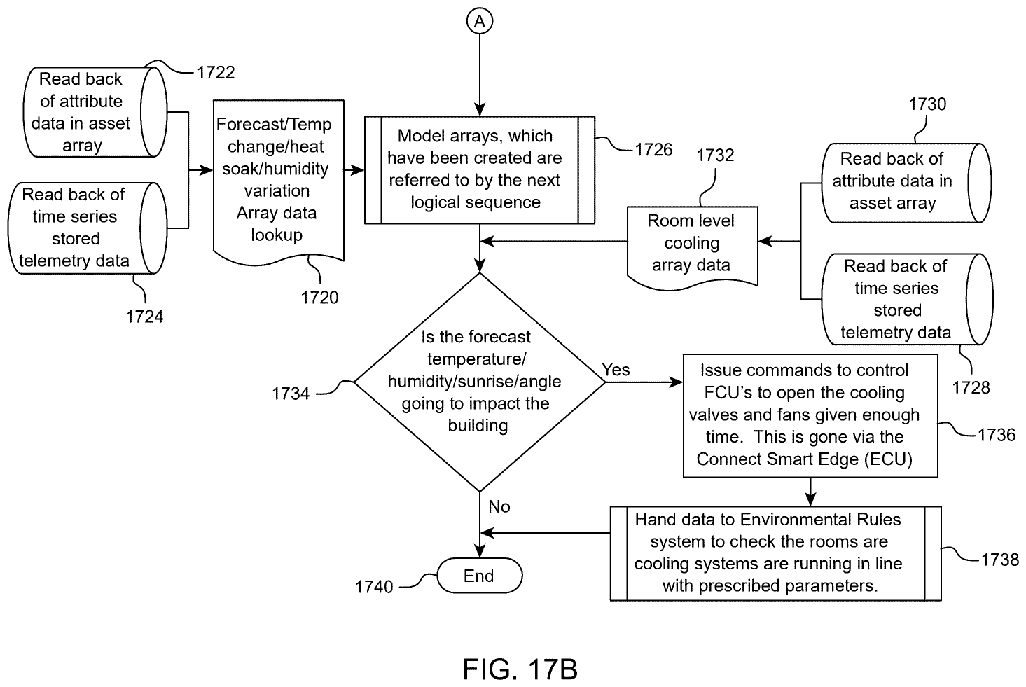

FIG. 17 is an exemplary flow chart illustrating a method of adapting response to environmental changes according to the present disclosure. The method responds to environmental changes, such as seasonal variations, by automatically adjusting sensor configurations or deploying relevant models. The method illustrates the data flow from environmental monitoring sources through the system, leading to model adjustments or deployments. At step 1702, the method of adapting the response to environmental changes is started. At step 1704, data from a connected weather station is received. At step 1706, data from a weather underground is received via application programming interface (API). At step 1708, data from ipgeolocation for sunrise and sunset is received via the API. At step 1710, the initial model and incoming data code base if triggered, the initial model is updated with incoming data. Further, digital twin data is split into attribute data and telemetry data and is stored, Furthermore, relationship data is provided or published to different layers of the system. At step 1712, the attribute data is stored in the asset array. At step 1714, the telemetry data is stored in a NoSQL database. At step 1716, the data taken from the three-core external environmental systems is processed and the processed outcomes are used in the system by devices, rules, assets, and relationships. At step 1718, in the air conditioning (AC) system for example, the AC solution and ML array are used to store data received from different sources. The data includes, but not limited to, sun angle, sun rise, sunset, and forecast environmental data over a 24-hour window. At step 1720, the array data lookup is performed to obtain forecast data, temperature change, heat soak, humidity variation. At step 1722, attribute data is obtained from the asset array and sent to step 1726. At step 1724, time series telemetry data is obtained and sent to step 1726. At step 1726, model arrays, which have been created are referred by a next logical sequence. At step 1728, attribute data is obtained from the asset array. At step 1730, the time series telemetry data is obtained. At step 1732, the room level cooling array data is prepared based on data from steps 1728 and 1730. At step 1734, it is checked whether the forecast temperature, humidity, sunrise, or sun angle are going to impact the building. If no, the method proceeds to step 1740. If yes, the method proceeds to step 1736. At step 1736, commands are issued to control FCU's to open the cooling valves and fans given enough time. These commands are performed via central control unit. At step 1738, the data is provided to environmental rules to check the cooling systems are running in line with prescribed parameters. At step 1740, the method is ended.

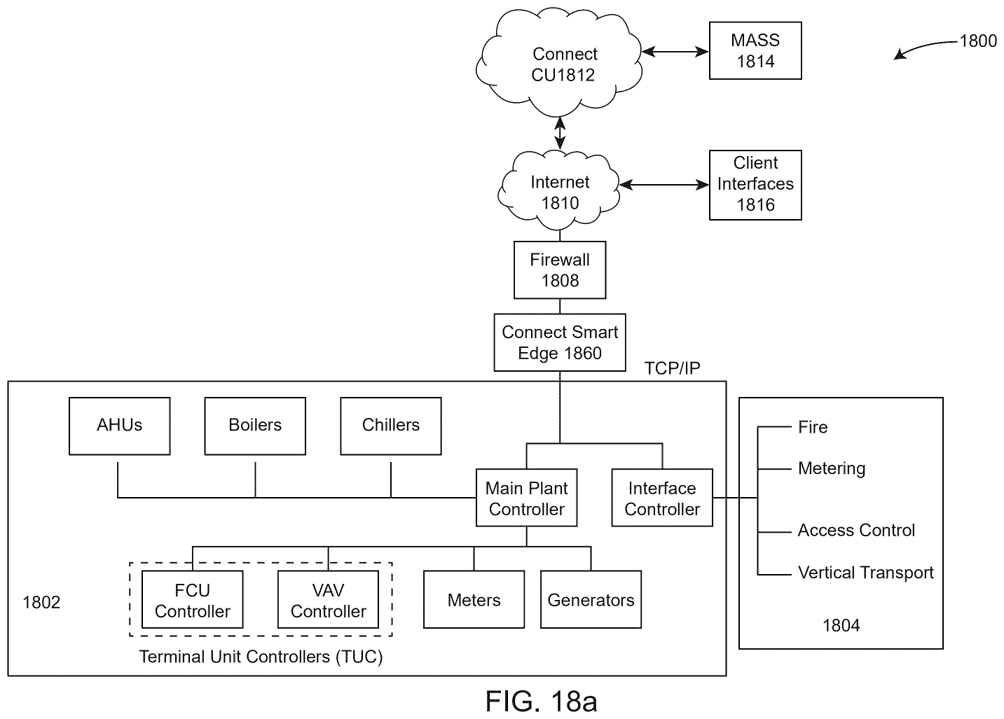

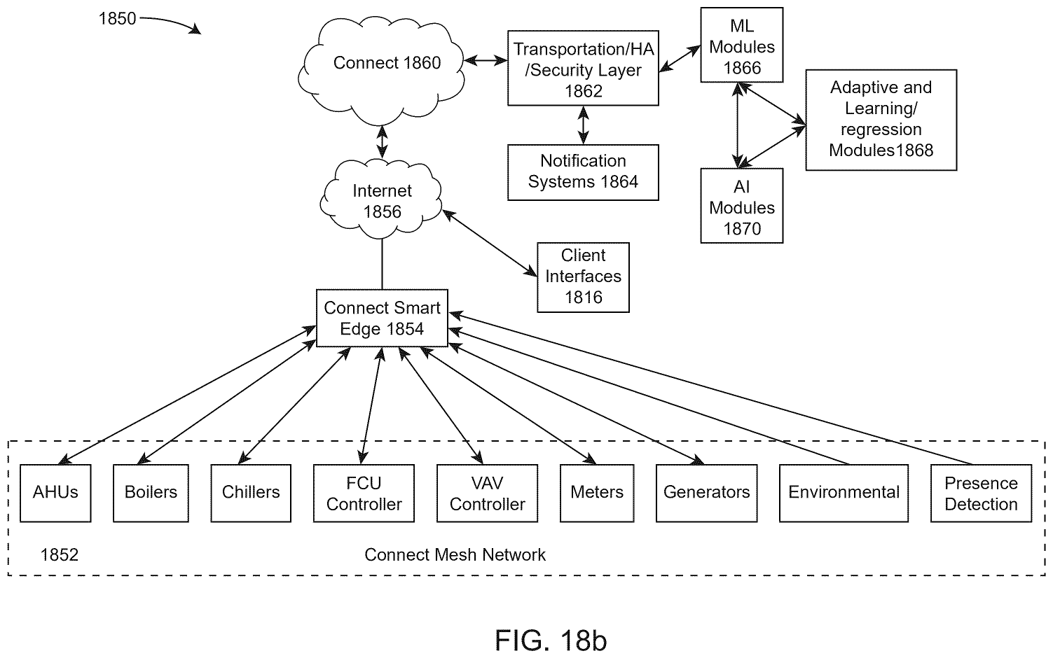

FIGS. 18A-18B are exemplary system architectures, highlighting the integration of illustrating a multidimensional adaptive sensing system with building management system. FIG. 18A illustrates a network of sensors distributed throughout a building, connected to a central processing unit that interfaces with the building's operational components. The key elements of the system architecture 1800 are sensors and building's operational components 1802, control interface 1804, connect smart edge 1806, security firewalls 1808, internets service 1810, server e.g., connect (e.g., SIBCA Connect), client interfaces 1816, and multidimensional adaptive sensing system 1814. The system 1800 take sensor data e.g., internal and external environmental data, and processes it using MASS and provide output on client and system interfaces. The building operational components 1802 includes, for example, but not limited to, AHUs, boilers, chillers. FCU controller, VAV controller, generators and the like. The sensors and building's operational components 1802 are connected to the MASS 1814, through main controller to smart edge 1806, via security firewalls and internet services. The clients are also connected to MASS 1814 through their devices via internet.

FIG. 18B depicts similar exemplary system architectures, highlighting the integration of illustrating a multidimensional adaptive sensing system with building management system, along with the detailed overview of the MASS system. The system 1850 comprises sensors and building's operational components 1852 connected to the MASS via connect smart edge 1854 and internet service 1856. The clients are also interconnected to MASS via internet service 1856. The MASS comprises transportation/HA/security layer 1862, notification system 1864, ML modules 1866, AI modules 1870, and adaptive and learning/regression modules 1868. With reference to FIG. 18B, the ML modules 1866, AI modules 1870, adaptive and learning/regression modules 1868, notification system 1864 are same as ML module 1124, AI module 1128, adaptive and learning/regression modules 1128, notification system 1130 respectively, as described previously herein. Thus, it is to be understood herein that the description about the same has not been repeated herein for the sake of conciseness.

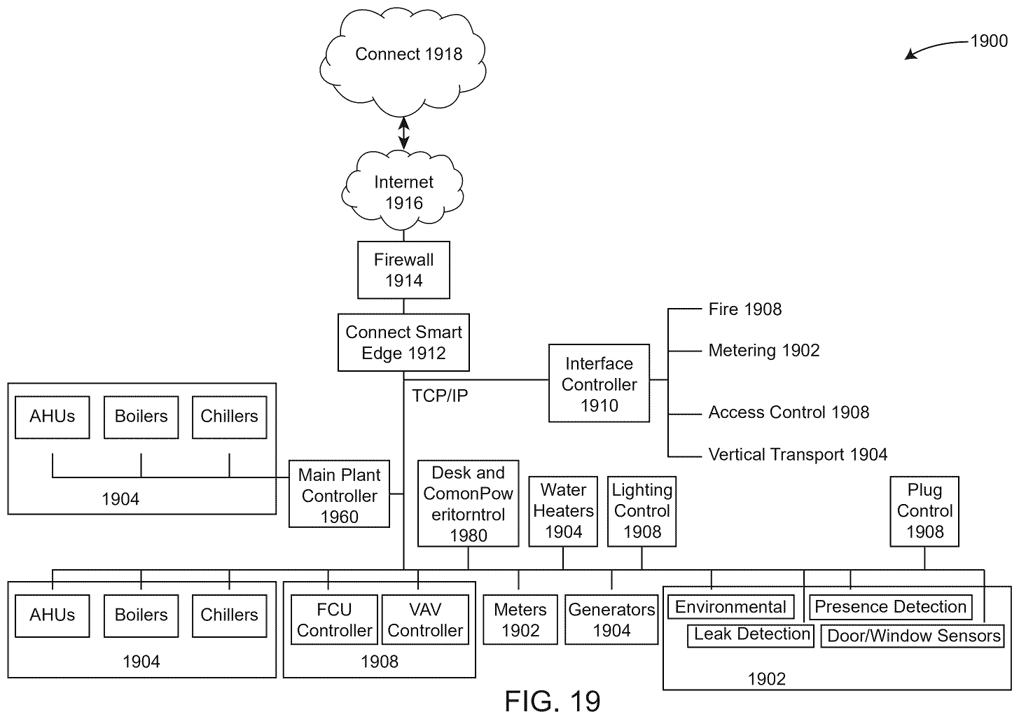

FIG. 19 illustrates a system architecture of an adaptive environmental control system 1900 for dynamic routine management using one or more machine learning models according to the present disclosure. The adaptive environmental control system 1900 includes a plurality of sensors 1902, a plurality of operational components 1904, a main controller 1906, a plurality of field controllers 1908, an interface controller 1910, an edge connector 1912, and an external connector 1914. The plurality of sensors 1902 are deployed in an entity to monitor a plurality of environmental parameters impacting operational routines of the plurality of operational components 1904. In some embodiments, the plurality of sensors 1902 includes, for example, but not limited to, environmental sensors, presence detection sensors, leak detection sensors, door or window sensors, gas meters, water meters, and electricity meters. The environmental parameters may include temperature, humidity, airflow, and chemical concentrations. In some embodiments, the entity is a building. In some embodiments, the plurality of operational components 1904 includes, for example, but not limited to, air handling units (AHU), boilers, chillers, generators, vertical transport, and water heaters. The sensors 1902, operational components 1904, controllers 1916 and 1908 are communicatively connected with the edge connector 1912 through which the sensor data is transmitted for analysis via the external connector 1914. Similarly, the operational rules, codes, instructions etc transmitted to the controllers 1916 and 1908 via the external connector 1914 and the edge connector 1912. The environment data from the plurality of sensors 1902 are analysed using a data processing unit to determine or forecast environment changes that will affect the operational routines of the plurality of operational components 1904. If the upcoming changes will affect the operational routines of the plurality of operational components 1904, then the one or more machine learning models are trained to adapt the environmental changes to changes the operational routines. Thereafter, the updated or trained one or more machine learning models are deployed in the main controller 1906 and/or field controllers 1908. Accordingly, the controller 1906 and/or field controllers 1908 change the operation of the plurality operational components 1904. The data processing unit may be remotely located in a server or located on a on-premise server. For example, if it is predicted a significantly hotter day, the system may decide to start cooling procedures earlier than usual to ensure optimal indoor conditions when occupants arrive.

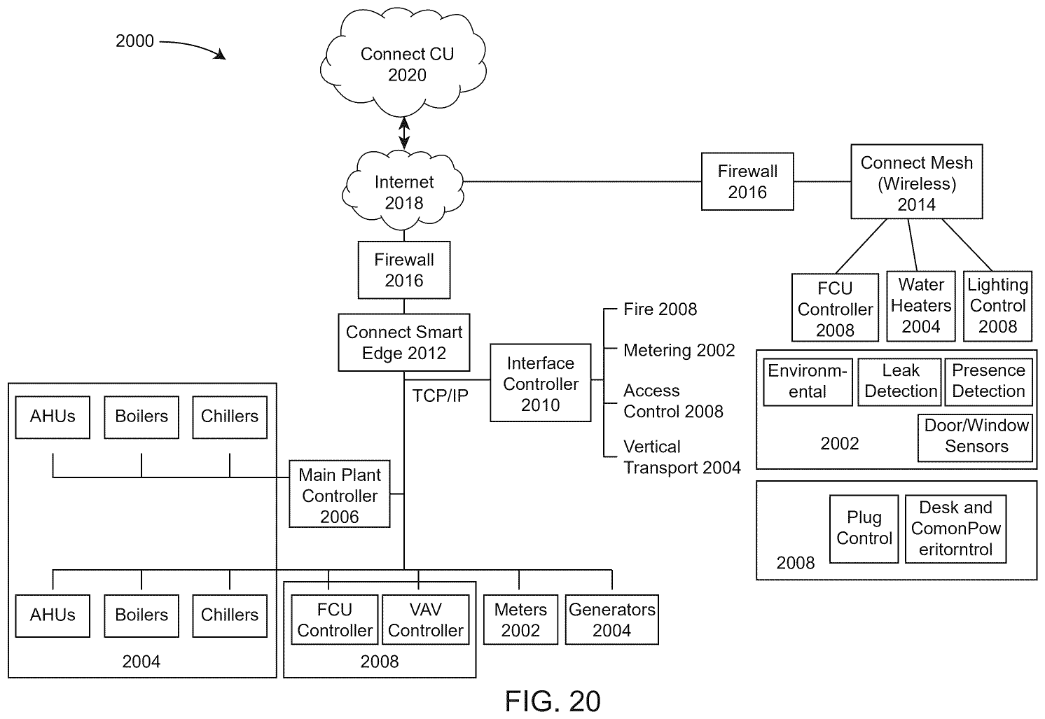

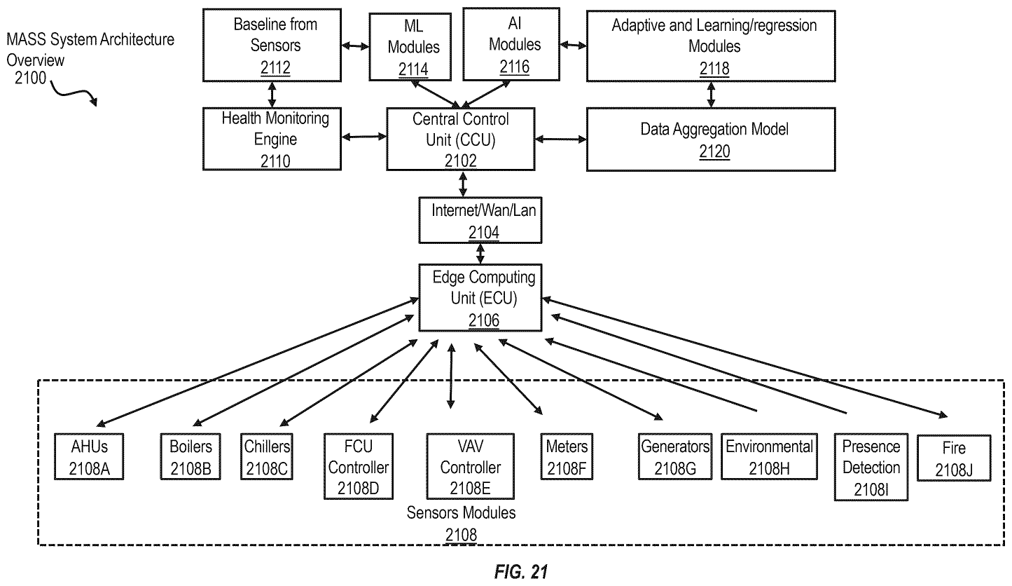

FIG. 20 illustrates a system architecture of a triage system 2000 for event analysis according to the present disclosure. The triage system 2000 includes a plurality of sensors 2002, a plurality of operational components 2004, a main controller 2006, a plurality of field controllers 2008, an interface controller 2010, an edge connector 2012, an external connector 2020 and a mesh connector 2014. The triage system 2000 includes a data processing unit may be remotely located in a server or located on a on-premises server. The data processing unit is configured to train one or more machine learning models with historical environmental data to recognize the complex patterns associated with each non-linear triage (NCT). Once trained, the one or more machine learning models are deployed to embedded control units (ecus) within the sensor network. These ECUs are responsible for processing sensor data in real-time, applying the models to continuously monitor for NCTs. The ECUs analyze incoming data from the sensors 1902, using the deployed models to detect the occurrence of NCTs. This analysis takes into account the current environmental context, ensuring that the system's responses are both accurate and relevant. When an ECU detects an NCT, it triggers the associated triage actions. The system evaluates the context of the trigger, including the severity of the condition and any related environmental factors, to determine the most appropriate response. The system activates the predetermined triage actions, which may involve adjusting operational settings of connected systems (e.g., HVAC adjustments), issuing alerts to relevant personnel, or initiating automated safety protocols.

In another embodiment of the present disclosure, an intelligent triage system for complex event analysis using adaptive multidimensional sensing is disclosed. The multidimensional adaptive sensing system integrated with advanced triaging models, enables the system to identify and responds to non-linear and sophisticated phenomena beyond traditional sensor capabilities. The system operates by defining Non-linear Conditional Triggers (NCTs) and associated triage actions, using a network of advanced sensors to monitor environmental conditions in real-time. Specialized triaging models, trained on historical data, dynamically adapt to evolving situations, enabling precise identification of anomalies and automatic execution of appropriate responses or human interventions. This adaptive, intelligent system revolutionizes event detection and management, offering a versatile solution to a wide range of applications by continuously learning and adjusting to new conditions, thereby improving operational efficiency and accuracy. Thus, an intelligent triage system for complex event analysis using MASS in present invention significantly enhances the detection and analysis of complex environmental events.

The intelligent triage system operates by deploying an array of advanced sensors to continuously monitor environmental conditions across multiple dimensions, including temperature, humidity, airflow, and more. This data is then analyzed in real-time by the system's adaptive models, which have been trained on historical data to recognize patterns indicative of complex events. These models employ non-linear conditional triggers (NCTs) to identify specific environmental scenarios that require attention. Upon detection of such scenarios, the system dynamically adjusts its response through predefined triage actions, which can range from automatic adjustments of system controls to the initiation of human intervention protocols. The ability to adapt and learn from new data, ensuring that its detection and response mechanisms remain accurate and relevant over time. This adaptability is achieved through the continuous refinement of its models based on ongoing environmental feedback, allowing the system to evolve in response to changing conditions and emerging threats. This results in a marked reduction in false alarms and missed detections, enhancing safety, efficiency, and operational continuity across various applications.

The intelligent triage system comprises a diverse array of sensors, each capable of detecting different environmental parameters such as temperature, humidity, airflow, and chemical concentrations. These sensors are selected based on their accuracy, reliability, and response time to ensure comprehensive environmental monitoring. Each sensor is equipped with network connectivity, allowing it to transmit data in real-time to the system's central processing unit. At the core of the system is a powerful data processing unit, capable of handling vast amounts of data from the sensor network. This unit uses advanced computational techniques to analyze the incoming data stream, identifying patterns and anomalies indicative of environmental changes. Further, the data processing unit are embedded with machine learning algorithms. These algorithms are trained on historical data to recognize complex event patterns, facilitating the dynamic adjustment of detection thresholds and the identification of Non-linear Conditional Triggers (NCTs). In addition to machine learning algorithms, the system incorporates rule-based logic to evaluate sensor data against predefined conditions. This hybrid approach ensures robust event detection by combining the predictive power of machine learning with the certainty of rule-based assessments. Further, a comprehensive database stores predefined response protocols associated with various environmental events identified by the system. This database includes both automated system adjustments and protocols for human intervention, tailored to the severity and nature of the detected event. A response activation unit is responsible for initiating the appropriate response once an event is detected. It processes the analysis models' output, consulting the triage database to determine the best course of action, and then activates the necessary protocols to address the event.

In certain embodiments, a critical feature of the intelligent triage system is its feedback loop, which allows for continuous learning and adaptation. The loop integrates new environmental data and event outcomes back into the system, enabling the machine learning algorithms to refine their models and improve detection accuracy over time. Further, a model update mechanism oversees the periodic update of analysis models based on the feedback loop's input. It ensures that the system's event detection and response capabilities evolve in response to changing environmental conditions and emerging threats.

In some embodiments, non-linear conditional triggers (NCTs) are complex patterns or conditions indicating significant changes or events in the environment. These triggers are identified through a thorough analysis of historical environmental data, using both expert knowledge and machine learning algorithms to recognize patterns that precede specific events. Each NCT is associated with one or more triage actions, which are predefined responses designed to address the event or condition indicated by the trigger. Triage actions can range from automated system adjustments to alerts prompting human intervention, depending on the nature and severity of the detected condition. The historical environmental data is collected from the sensor network, covering a wide range of conditions and events. This data forms the foundation for model training and development. Also, machine learning algorithms are trained on the historical data, learning to recognize the complex patterns associated with each NCT. These models are designed to dynamically adjust detection thresholds and sensitivity based on real-time environmental changes, improving their accuracy over time. Once the models are trained, the models are deployed to embedded control units (ECUs) within the sensor network. These ECUs are responsible for processing sensor data in real-time, applying the models to continuously monitor for NCTs. When an ECU detects an NCT, it triggers the associated triage actions. The triage system evaluates the context of the trigger, including the severity of the condition and any related environmental factors, to determine the most appropriate response. The triage system activates the predetermined triage actions, which may involve adjusting operational settings of connected systems (e.g., HVAC adjustments), issuing alerts to relevant personnel, or initiating automated safety protocols. In addition, new patterns can emerge from the ongoing analysis of environmental data and feedback. The triage system is configured to identify potential new NCTs. These triggers are then evaluated by experts and, if validated, are incorporated into the triage system with associated triage actions, enhancing the system's capabilities. Further, the machine learning models are periodically updated with new data and insights, ensuring that they remain effective in detecting NCTs and initiating appropriate triage actions. This process of continuous learning and adaptation allows the system to stay ahead of evolving environmental conditions and emerging threats.

In an embodiment of the present disclosure, a multifaceted compliance assurance solution utilizing dynamic sensing and predictive regulatory analysis innovates compliance in building management systems, such as fire safety, by leveraging the multidimensional adaptive sensing system (MASS) is disclosed. It transforms regulatory adherence into a dynamic, automated process by encoding compliance requirements into target constraints and rules within MASS. This approach enables real-time monitoring and automated health checks of sensors, facilitating immediate responses to violations and predictive maintenance to pre-empt compliance failures. By integrating adaptive models that adjust to environmental changes and sensor degradation, the solution not only ensures ongoing compliance with local and global regulations but also reduces manual inspection burdens. Predictive analytics further enhance the system's capability to foresee and mitigate potential non-compliance, making it a cutting-edge solution for efficient, reliable compliance management in critical building systems.

In certain embodiments, the core of the multifaceted compliance assurance solution is the integration of the multidimensional adaptive sensing system (MASS), a sophisticated system that employs a network of advanced sensors alongside adaptive models developed through a blend of rule-based algorithms and machine learning techniques. MASS is designed to dynamically adjust its operational parameters in response to real-time changes in environmental conditions, sensor degradation, and other relevant factors, thus enhancing the accuracy and reliability of event detection and reducing the incidence of false alarms. The application of the MASS as a compliance management solution achieved by translating regulatory requirements into target constraints and rules, which are then encoded within the system. This allows for continuous, real-time monitoring of compliance status across various system components and environmental conditions. When a potential compliance issue is detected, the system can automatically adjust its parameters or trigger maintenance processes to address the issue, thus preventing non-compliance.

Further, in certain embodiments, the solution incorporates predictive analytics capabilities, enabling it to forecast potential compliance violations based on trends and patterns identified within the collected data. This predictive aspect not only facilitates pre-emptive actions to avert non-compliance but also significantly enhances the overall efficiency and effectiveness of the building management system's compliance management processes. Thus, the solution transforms the traditionally static and manual process of regulatory compliance into an automated, dynamic, and intelligent system. By doing so, it solves several problems associated with conventional compliance management approaches, including the high cost of manual inspections, the risk of human error, the inability to adapt to changing environmental or operational conditions, and the lack of predictive capabilities for future compliance issues. Through its innovative use of adaptive sensing, real-time data analysis, and predictive modelling, enabled the Multifaceted Compliance Assurance Solution significantly improves the reliability, efficiency, and predictability of compliance management in critical building systems.

In certain embodiments, the multifaceted compliance assurance system comprises an array of advanced sensors that continuously monitor environmental and operational parameters, feeding data into the system for real-time analysis. Further, the system comprises adaptive compliance models that dynamically interpret sensor data, adjusting operational parameters and compliance thresholds in real-time based on evolving environmental conditions and sensor performance. A regulatory analysis module is used to translate complex regulatory requirements into programmable target constraints and rules, which are then monitored and enforced through the system's operational logic. A predictive compliance engine leveraging machine learning algorithms is employed, to predicts potential compliance violations by analyzing trends and patterns in the data, enabling pre-emptive corrective actions.

In certain embodiments, the operational mechanism of the multifaceted compliance assurance solution utilizing dynamic sensing and predictive regulatory analysis embodies a comprehensive approach to compliance management. This process is underpinned by the integration and constant interaction of several key components and phases, from the initial decoding of compliance rules into actionable system targets to the predictive analysis aimed at pre-empting future violations. The first step involves translating complex regulatory requirements into specific, actionable system target constraints (STCs) and system target rules (STRs). This translation process is achieved through a collaborative effort between regulatory experts and system engineers, ensuring that every compliance requirement is accurately represented within the system's operational framework. For each STC and STR, associated adaptive and predictive models are developed. These models are designed to continuously monitor environmental and operational parameters relevant to the compliance criteria, enabling real-time evaluation and decision-making. A network of advanced sensors is deployed throughout the building or facility, tasked with continuously monitoring a broad spectrum of environmental and operational parameters. This data is critical for the real-time assessment of compliance status. Sensor data is collected and processed by the Environmental Control Units (ECUs), which utilize the predefined adaptive models to evaluate current conditions against the STCs and STRs. This evaluation considers the dynamic nature of environmental conditions and operational activities, ensuring that the system's assessment is both accurate and reflective of real-time statuses. When an evaluation identifies a deviation from the defined STCs or STRs, the system automatically triggers a corresponding course of action. These actions can range from adjusting operational parameters to initiating maintenance protocols, depending on the nature of the detected deviation. For operational deviations, the system can automatically adjust controls to realign with compliance requirements. For maintenance-related issues, the system can schedule maintenance tasks, alerting facility management to potential concerns before they escalate into compliance violations. Further, the central control units (CCUs) employ sophisticated machine learning algorithms to analyze historical and real-time data collected from the sensor network. These predictive models identify patterns and trends that may indicate the potential for future compliance violations. Based on the predictions, the system proactively initiates corrective actions to avoid predicted compliance violations. This may involve adjusting operational parameters, pre-emptively scheduling maintenance, or implementing other preventive measures.

Additionally, in certain embodiments, the predictive models are designed to learn from new data, continuously improving their accuracy and reliability over time. This learning process ensures that the system remains effective in pre-empting compliance violations, even as environmental conditions, operational practices, and regulatory requirements evolve. Thus, the multifaceted compliance assurance solution not only ensures continuous adherence to current regulatory standards but also anticipates and mitigates potential future violations. This dynamic and predictive approach to compliance management represents a significant advancement in the field, offering enhanced efficiency, reliability, and peace of mind for building management systems.

In some aspects, the present disclosure relates to a multidimensional adaptive sensing system (MASS) that integrates dynamic sensor discovery, intelligent model selection, autonomous health monitoring, and operational adjustment capabilities. The system detects and corrects sensor degradation, decay, and malfunctioning and dynamically reconfigures itself when new sensors are added. The system utilizes a combination of baseline and compound models which are intelligently selected based on sensor metadata and environmental conditions of the environment in which the sensors are operating.

In certain embodiments, MASS solves many of the technical problems associated with existing sensor systems. Sensor systems have long been the cornerstone of monitoring across various industries. These existing sensors are designed to respond to specific physical phenomena—such as detecting changes in temperature, humidity, pressure, or gas concentration—and trigger a response when predefined thresholds are reached. While effective in their specific roles, these sensors provide little flexibility or insight into their own operational health. They operate in isolation, unable to detect or correct issues such as sensor decay or drift over time. As a result, their readings can become less reliable as the sensors age. Sometimes their performance can deteriorate without warning, often leading to costly maintenance or complete failure in critical environments. This lack of self-awareness and adaptability creates significant operational inefficiencies, increases costs, and can pose safety risks when sensors fail without prior indication of degradation.

The rise of IoT technology has ushered in a new era for sensor networks, enabling a more connected and intelligent infrastructure. By cross-referencing data from multiple sensors, modern IoT systems allow for the development of complex management models that can respond to a broader range of environmental factors and provide deeper insights into system behavior. These networks can detect patterns and anomalies by analyzing data from various sources simultaneously, offering greater control and smarter decision-making. However, despite the advanced capabilities of IoT, these systems still do not inherently account for the degradation of sensor performance over time. The intelligence they provide is largely focused on real-time data collection and analysis, but they fall short when it comes to addressing the inevitable decay that affects sensor accuracy and reliability. IoT systems, for all their sophistication, are still reactive when it comes to sensor health.

Predictive maintenance, while a step forward, has traditionally been focused on identifying anomalies that suggest sensor failure might be imminent. These systems can flag potential issues before they lead to breakdowns, but their approach is typically reactive, triggering maintenance actions that can be both costly and time-consuming. Moreover, predictive maintenance strategies are limited to spotting irregularities rather than correcting them. This means that even when potential sensor failures are identified early, the system does not address the underlying problem, often leading to unnecessary maintenance interventions or replacements that could have been avoided.

In response to these limitations, in certain embodiments, MASS offers a proactive solution that not only detects but also corrects for sensor decay, significantly extending the operational lifespan of sensors. In certain embodiments, by intentionally inducing controlled decay conditions during development, MASS gathers comprehensive data on how sensors deteriorate over time. This data is then used to train both baseline and compound models, allowing the system to predict and correct for sensor decay in real-world applications. Once deployed, these models may enable MASS to detect early signs of sensor deterioration and automatically adjust operational parameters-such as detection thresholds and sensitivity settings—in real time. This dynamic correction may ensure that the system maintains accuracy and reliability, even as sensors age, making MASS a more economical, safe, and efficient solution for industries that rely on accurate sensing over extended periods.

Moreover, the deployment of such sophisticated models and advanced IoT technology often requires complex installation and continuous reconfiguration as new sensors are added or replaced. Recognizing this challenge, in certain embodiments, MASS incorporates active and intelligent observers that automate both the initial setup and any future reconfigurations. These observers monitor the sensor network continuously, detecting changes in sensor deployment or environmental conditions and automatically adjusting the models and configurations to optimize performance. This automation eliminates the need for manual intervention, ensuring that MASS remains adaptable and easy to maintain, even in large-scale, dynamic environments. By combining proactive sensor health management with automated configuration, in certain embodiments, MASS offers a comprehensive solution that enhances sensor longevity, reduces costs, and improves overall system efficiency.

FIG. 21 depicts a high-level view of an overall system architecture of MASS, in another example embodiment. Arrows illustrated in FIG. 21 indicate the flow of data between sensors, processing units, and decision-making components, thereby depicting how the system operates cohesively between its various components. In particular, FIG. 21 depicts system 2100, which includes a central control unit (CCU) 2102 in communication with an edge computing unit (ECU) 2106 via communication interface 2104. The CCU 2102 is also in communication with a health monitoring engine 2110, one or more ML modules 2114, one or more AI modules 2116, and a data aggregation model 2120.

Baseline from sensors 2112 is in communication with health monitoring engine 2110 and the one or more ML modules 2114. One or more adaptive, learning, and/or regression modules 2118 is in communication with the one or more AI modules 2116 and the data aggregation model 2120.

CCU 2102 serves as the central management node for the MASS network (e.g., system 2100) and orchestrates the overall system performance. CCU 2102 aggregates data from ECU 2106 and analyses the data at a broad, system-wide level to ensure that efficient and accurate configurations are applied across the entire network. CCU 2102 is responsible for deploying and adjusting the baseline models and compound models used by ECU 2106, ensuring that the models account for both localized sensor performance and system-wide network trends. Through continuous data aggregation and analysis, CCU 2102 improves the network's performance by making global adjustments to detection thresholds and model configurations as necessary. CCU 2102 provides centralized control of system 2100 and enables system 2100 to respond dynamically to the evolving state of the network and the evolving state of the external environmental conditions.

ECU 2106 is configured as a local processing node within the MASS architecture (e.g., system 2100). ECU 2106 is responsible for interfacing directly with sensor modules 2108 and gathering data in real-time. A sensor module is a self-contained unit that contains one or more sensors and related components designed to detect specific parameters. Some examples of sensor modules 2108 include: air handling units (AHUs) 2108A, boilers 2108B, chillers 2108C, fan coil unit (FCU) controllers 2108D, variable air volume (VAV) controllers 2108E, meters 2108F, generators 2108G, environmental sensor modules 2108H, presence detection modules 2108I, and fire detection modules 2108J.

AHUs 2108A control airflow, temperature, and humidity in HVAC systems. Boilers 2108B are configured as heat-generating equipment that provides hot water or steam for buildings. Chillers 2108C are cooling systems that remove heat from a liquid via vapor-compression or absorption refrigeration cycles. FCU controllers 2108D regulate individual room temperature control units. VAV controllers 2108E regulate airflow to different zones of a building/structure and maintain desired temperature within a zone. Meters 2108F are devices that measure and record consumption of resources, like electricity, water, or gas. Generators 2108G convert mechanical energy into electrical energy, often used as backup power. Environmental sensor modules 2108H monitor environmental conditions like temperature, humidity, air quality, and pressure. Presence detection modules 2108I are configured to detect occupancy or movement in a space, often to trigger lighting, HVAC, or security responses. Fire detection modules 2108J are configured to detect smoke, heat, or flames in order to trigger fire alarm systems.

In addition to being equipped to detect specific parameters, including environmental conditions, such as temperature, humidity, pressure, sensor modules may also be configured to monitor and report on their own operational health. Thus, each sensor module provides telemetry data that reflects both the environmental phenomena it monitors and its own internal status, allowing the system to track sensor performance and detect early signs of degradation.

ECU 2106 is also configured to execute baseline and compound models received from CCU 2102. ECU 2106 processes data locally, ensuring that system 2100 remains responsive to environmental changes and sensor health issues at a localized level. When sensor degradation or environmental shifts are detected, ECU 2106 is configured to make immediate adjustments to operational parameters. Some examples of adjustments to operational parameters include recalibrating detection thresholds or triggering early corrective actions. The localized processing by ECU 2106 enables a reduction in latency and allows sensors to remain highly responsive, even before data reaches CCU 2102. While one ECU is depicted in FIG. 21, system 2100 may include a plurality of ECUs, which each are configured as local processing nodes.

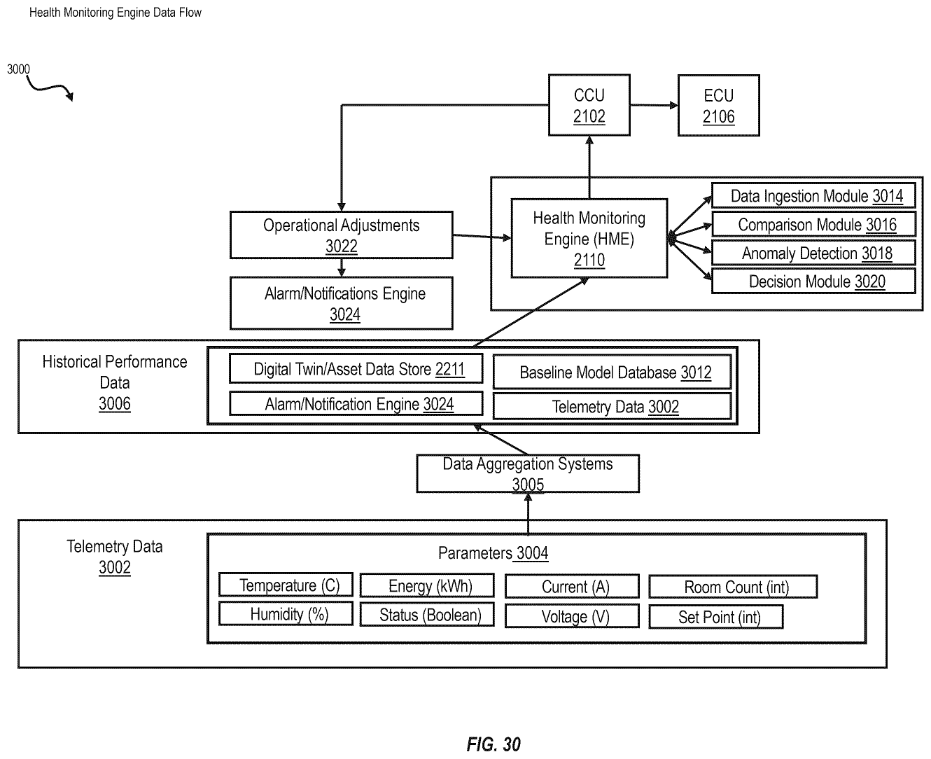

Health monitoring engine 2110 is configured to evaluate the real-time performance of each sensor in the network. By analysing telemetry data and cross-referencing it with historical performance data, such as historical performance data 3006 of FIG. 30, health monitoring engine 2110 is able to detect early signs of sensor degradation or malfunction. Health monitoring engine 2110 provides insights to both ECU 2106 and CCU 2102, enabling ECU 2106 and CCU 2102 to adjust operational parameters or trigger corrective actions to prevent sensor failures. By continuously monitoring sensor health, health monitoring engine 2110 beneficially allows system 2100 to maintain a high level of reliability, to minimize downtime, and to extend the operational life of sensors.

Data aggregation model 2120 is configured to gather data from all sensor modules 2108 and ECU 2106. Data aggregation model 2120 also is configured to compile the gathered data into a comprehensive dataset that is provided to CCU 2102 for analysis. By performing data aggregation, data aggregation model 2120 beneficially allows system 2100 to achieve a holistic view of sensor performance across the network and to allow CCU 2102 to make informed decisions when adjusting models and operational settings. The aggregation of sensor data improves the system's response to both localized and global changes within the network.

In some aspects, system 2100 includes an operational adjustment mechanism (not pictured). The operational adjustment mechanism may be configured to execute real-time adjustments to system 2100 based on insights received from health monitoring engine 2110. These adjustments can range from recalibrating detection thresholds, to adjusting the sensitivity of specific sensors to correct for sensor degradation. The operational adjustment mechanism may allow system 2100 to remain adaptable to evolving conditions and dynamical adjust to both environmental changes and internal sensor conditions. Thus, the operational adjustment mechanism may allow system 2100 to maintain accurate detection and reliable system performance.

In some aspects, system 2100 includes a communication interface (not pictured) that facilitates data exchange between system 2100 and external entities, such as cloud-based services, user interfaces, and emergency response systems. The communication interface is configured to support remote monitoring and control, thus allowing operators to receive real-time updates on system performance and make adjustments when necessary. In certain aspects, the communication interface enables system 2100 to integrate with external data sources. By integrating with external data sources, system 2100 is able to access supplementary environmental data to enhance the system's performance and decision-making capabilities.

Overall, system 2100, representative of a MASS architecture, improves upon existing sensing systems by integrating advanced models capable of correcting sensor decay in real time. System 2100 is configured to automatically detect new sensors, monitor sensor health, and continuously adjust detection thresholds and operational parameters. The detection thresholds and operational parameters are based on real-time and evolving sensor conditions. System 2100 operates autonomously, thereby eliminating the need for manual intervention. By operating autonomously, system 2100 allows sensor networks to remain accurate and reliable, even as they evolve over time.

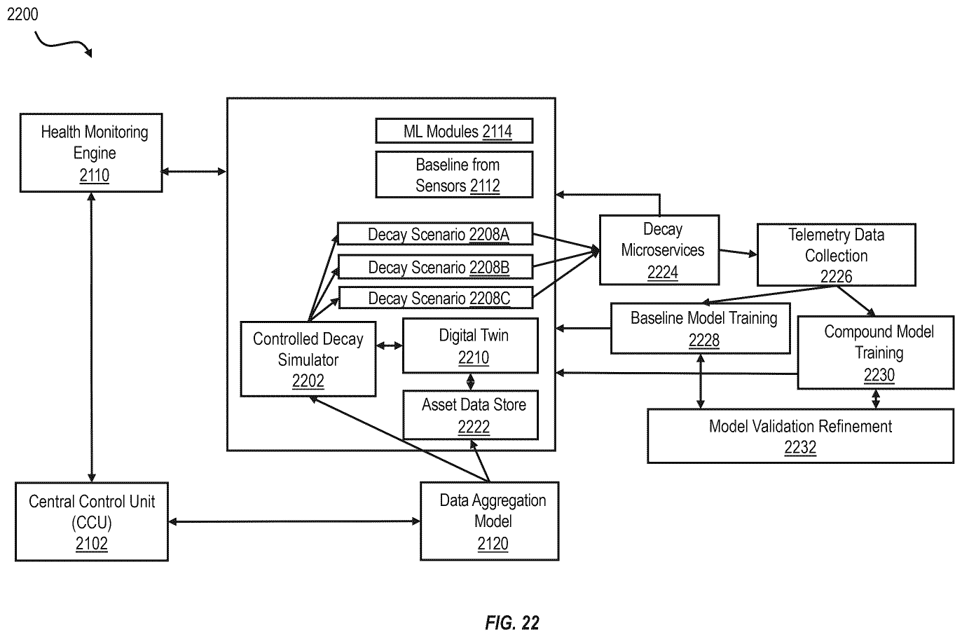

FIG. 22 depicts system 2200 for facilitating decay-induced training of models, according to certain embodiments. FIG. 22 also shows how sensors are subjected to controlled degradation in a testing environment in order to collect sensor data during sensor decay. Arrows illustrated as part of system 2200 indicate the flow from decay simulation to data collection, the training of baseline and compound models, and model validation.

System 2200 includes CCU 2102 of FIG. 21 in communication with health monitoring engine 2110 of FIG. 21 and data aggregation model 2120 of FIG. 21. Health monitoring engine 2110 and data aggregation model 2120 are in communication with a controlled decay simulator 2202. Controlled decay simulator 2202 includes ML modules 2114 of FIG. 21, baseline from sensors 2112 of FIG. 21, and a plurality of decay scenarios (e.g., decay scenario 2208A, decay scenario 2208B, and decay scenario 2208C). Controlled decay simulator also includes a digital twin 2210, which is in communication with asset data store 2222. In some aspects, data aggregation model 2120 is in communication with controlled decay simulator 2202 and asset data store 2222. In some aspects, a digital twin is virtual representation of a physical object, process, or system that mirrors its real-world counterpart. Thus, herein, a digital twin 2210 may refer to a virtual representation of a sensor, plurality of sensors, and/or sensing device.

System 2200 also includes a telemetry data collection component 2226 that is in communication with decay microservices 2224, baseline model training component 2228, and compound model training component 2230. Decay microservices 2224 facilitates the data flow between the controlled decay simulator 2202 and the telemetry data collection component 2226. Additionally, baseline model training component 2228 and compound model training component 2230 are in communication with model validation refinement component 2232.

Controlled decay simulator 2202 is configured to intentionally induce sensor decay in sensors to develop predictive models that are able to predict and mitigate sensor decay. By developing models under decay scenarios, system 2200 is able to ensure that system 2100 of FIG. 1 is prepared to detect and correct sensor degradation in real-world applications. Sensors are placed in a controlled environment where they can be subjected to stress tests and various environmental factors to induce sensor decay within the sensors. Some environmental factors include changes in temperature, humidity, pressure, or exposure to corrosive elements. These environmental factors are deliberately manipulated to induce sensor degradation over time.

Each decay scenario of the plurality of decay scenarios (e.g., decay scenario 2208A, decay scenario 2208B, and decay scenario 2208C) includes one or more environmental factors that will be applied to a set of sensors. Essentially, controlled decay simulator 2202 is configured to mimic real-world conditions under which sensors may typically operate, ensuring that the decay models learn and reflect authentic performance deterioration.

Telemetry data collection component 2226 is configured to monitor and collect data from one or more sensors. During the decay simulation, sensors continuously transmit data related to their readings and operational health. The telemetry data that is collected from these sensors captures both the environmental phenomena being measured and the internal state of the sensors. Telemetry data collection component 2226 collects performance metrics, including detection thresholds, response times, and error rates as decay progresses during the decay simulation.

A detection threshold of a sensor refers to the minimum signal level that can be reliably distinguished from background noise. Detection thresholds may be specified in terms of the minimum detectable signal strength, a statistical confidence level, and/or specific operating conditions. For example, in optical sensors, the detection threshold may be expressed as a minimum light intensity that can be detected. In acoustic sensors, it could be the minimum sound pressure level that produces a measurable response in the sensor. Response time of a sensor is the time interval between when a measurable change occurs in the input signal and when the sensor's output reaches a steady-state value corresponding to the change in the input signal. The error rate of a sensor is the percentage or frequency of incorrect measurements relative to the total number of measurements.

A well-functioning sensor will have low detection thresholds, fast response times, and low error rates. By intentionally inducing decay according to various decay scenarios, the controlled decay simulator 2202 is able to train models on how the detection thresholds, response times, and error rates are affected during sensor decay. Additionally, by collecting telemetry data with the telemetry data collection component 2226, system 2200 is able to determine accuracy drift and sensitivity loss of the sensors as the sensors undergo one or more decay scenarios. Accuracy drift refers to the gradual change in a sensor's readings over time as compared to the true value being measured. This drift leads to decreased measurement reliability and may require recalibration to maintain sensor performance.

Sensitivity loss refers to the reduction in a sensor's ability to detect changes in the input signal over time, resulting in a diminished output response to a given input magnitude. Thus, a sensor experiencing sensitivity loss may not be able to accurately measure the target parameter it is measuring. Accuracy drift and sensitivity loss may be caused by aging components, environmental factors, mechanical stress, contamination, and/or physical damage, which can all be simulated by the controlled decay simulator.

Data collected by the telemetry data collection component 2226 is provided to baseline model training component 2228 and compound model training 2230 to train ML modules 2114. Baseline model training component 2228 is configured to develop baseline models using the data collected during the initial stages of sensor operation and through the decay process. The baseline models define the normal operating ranges for each sensor and establish thresholds for detecting deviations that may suggest sensor decay. Machine learning algorithms are applied to the collected data to identify patterns of sensor degradation, thereby training the baseline models to predict when sensor performance will start to decline. Each baseline model corresponds to a particular sensor. In some aspects, the baseline model is configured to predict, detect, and auto-correct the sensor in response to predicting and/or detecting a sensor abnormality.

Compound model training component 2230 is configured to develop compound models by integrating data from multiple sensors that experience decay in the simulated environment. The compound models account for interactions between different sensors and identify how the decay of one sensor might influence or be influenced by other sensors in the network. For example, a single sensor module may include multiple different sensors to measure different parameters, such as an ACU that has sensors that measure humidity, temperature, and airflow. Compound models learn to recognize complex decay scenarios, where multiple sensors might degrade under similar or varying conditions. This enables the system to correct for network-wide performance issues. In some aspects, the compound model is configured to run in CCU 2102 and monitors whether several sensors drifting or experiencing abnormalities together are environment-related or a shared fault. In response to detecting a grouped abnormality, the system is configured to re-weight the sensors. In one example, a compound model may be configured as a supervisory DCS loop that balances multiple valves to keep a corresponding header stable.

System 2200 also includes a model validation refinement component 2232 that is configured to validate baseline and compound models after they are trained. Model validation refinement component 2232 validates the models by comparing the model predictions against the actual sensor performance decay that was measured during one or more simulated decay scenarios and/or real-world decay scenarios. For example, MASS checks the model against late-life data that the model has not seen before. In certain aspects, a lightweight file may be stored into each edge gateway, such that no cloud link is needed for day-to-day corrections. The models are refined iteratively, wherein the model validation refinement component 2232 adjusts one or more model parameters until the models are able to accurately predict and respond to sensor degradation. For example, if field readings diverge from model predictions for a day or two, the edge gateway may be configured to query the cloud for a model tune-up and retrieve an improved file.

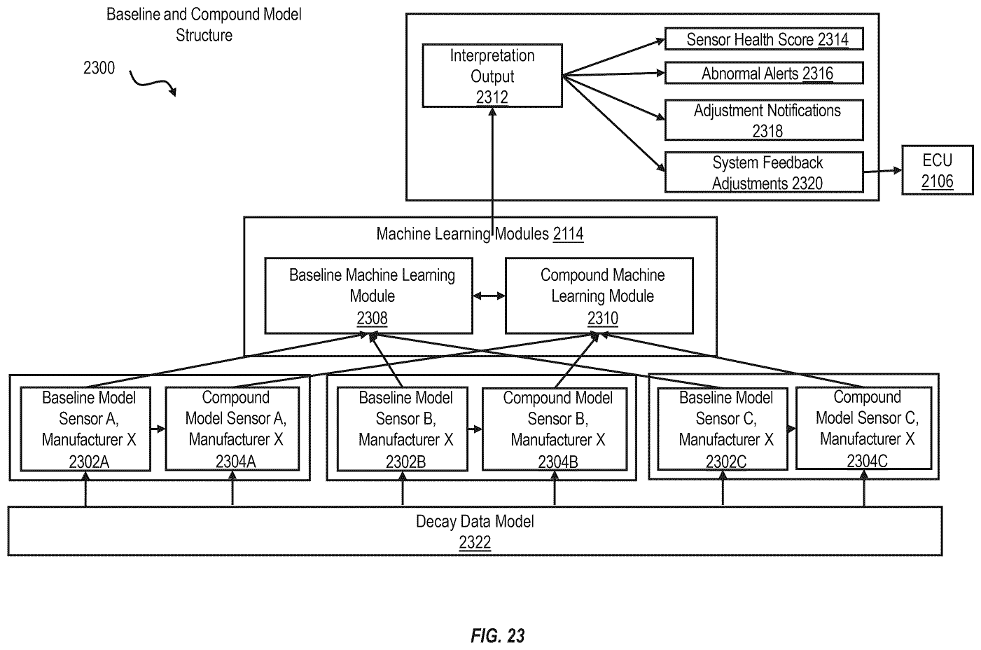

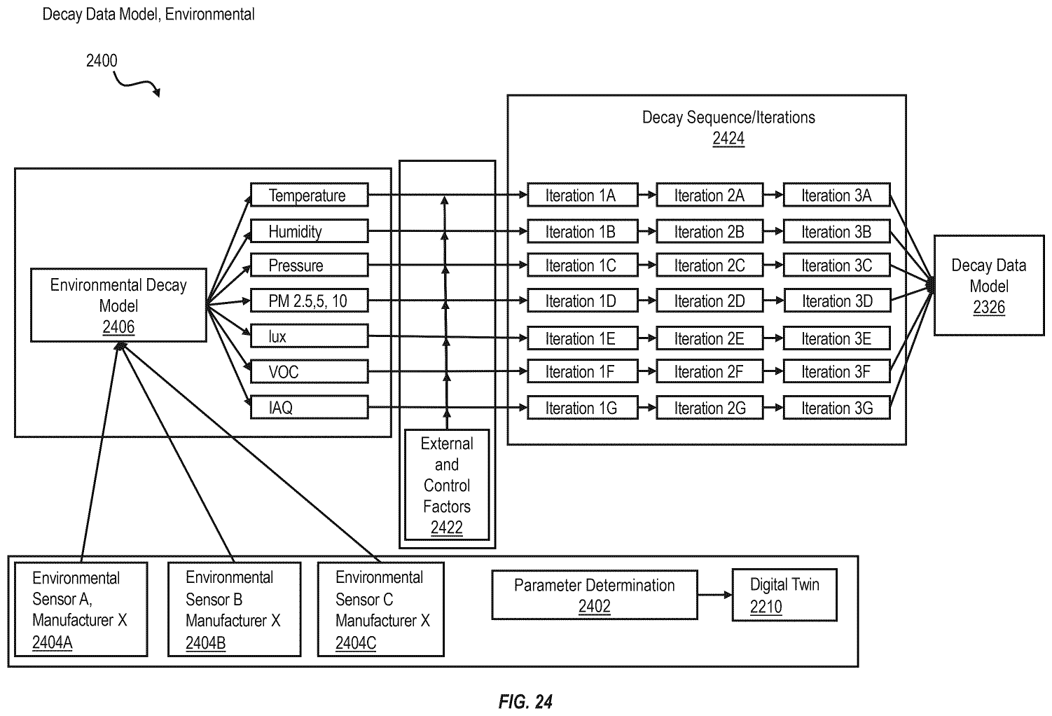

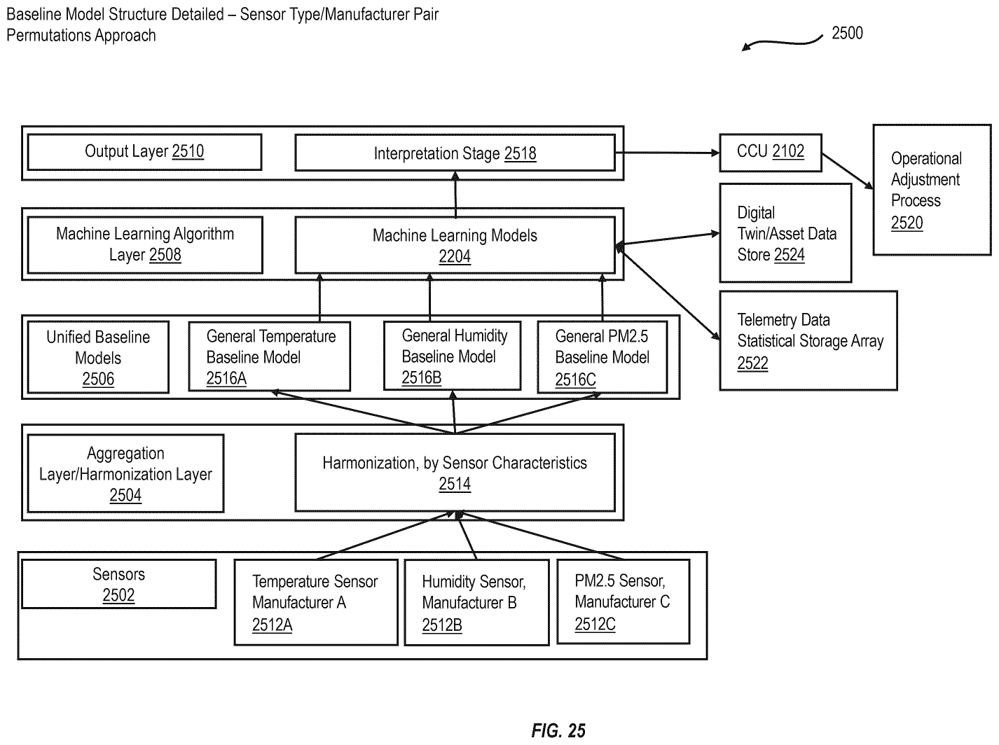

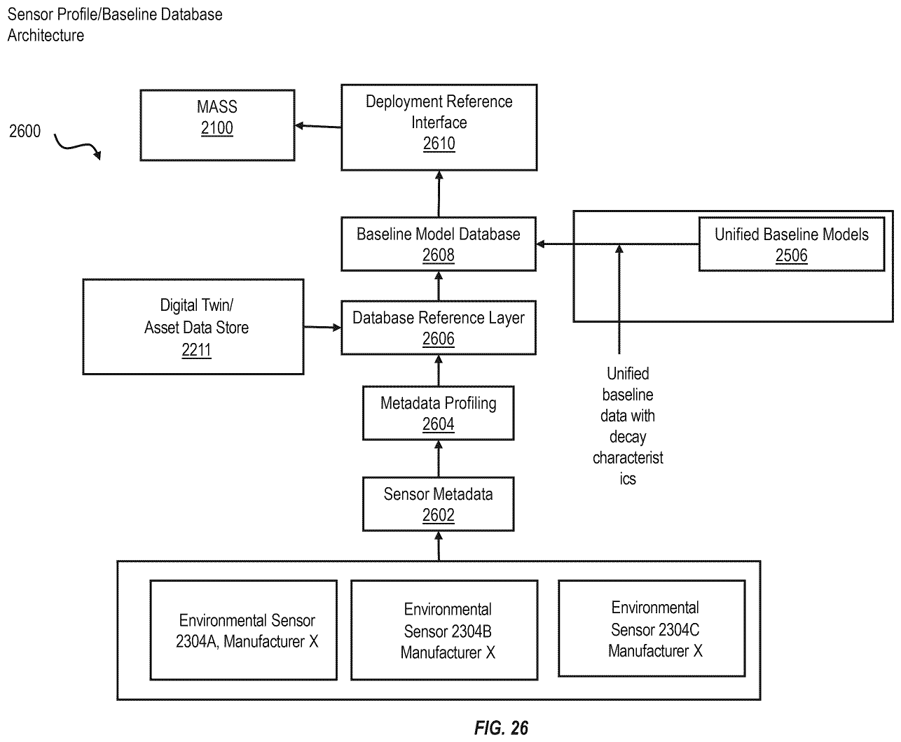

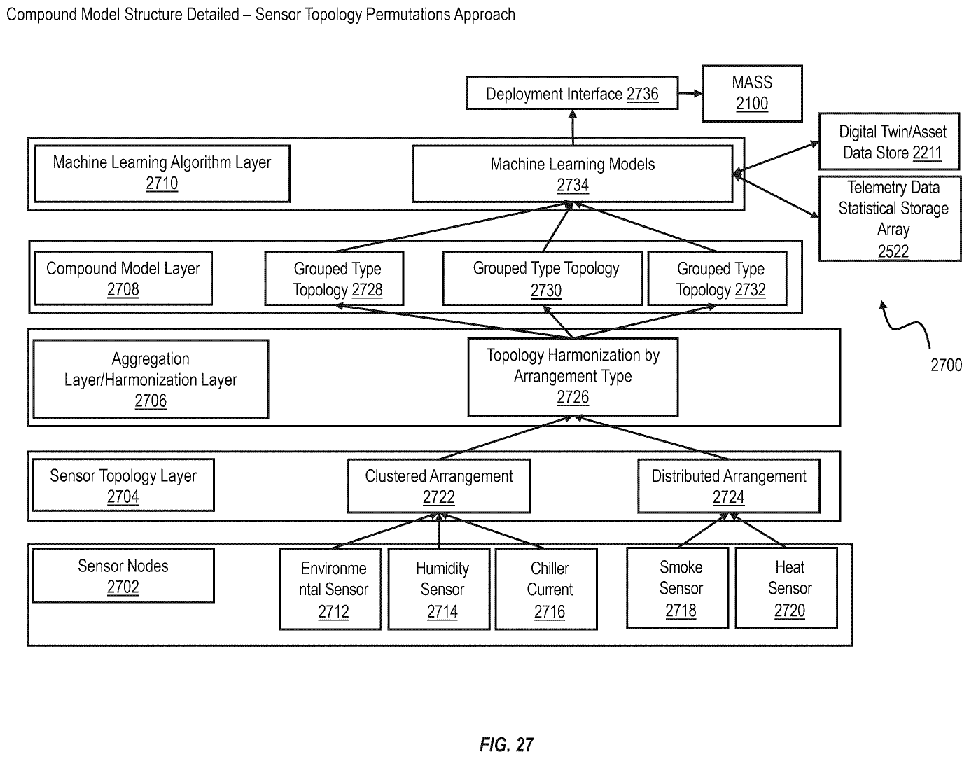

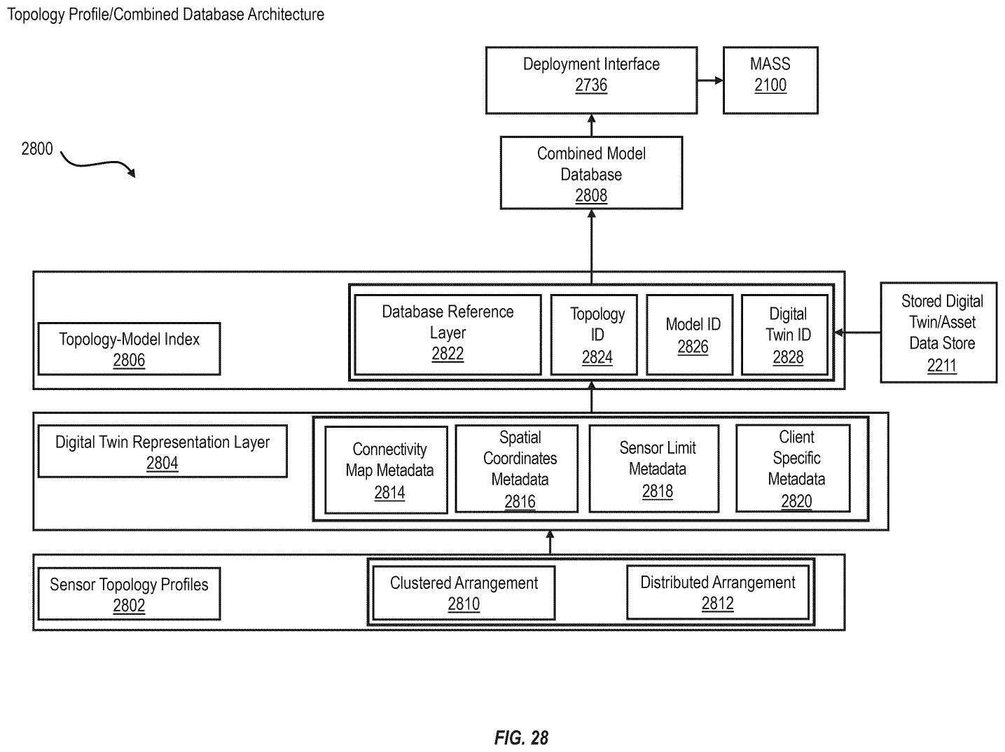

FIG. 23 depicts the structure of a baseline machine learning module and a compound machine learning module within a MASS architecture (e.g., system 2100 of FIG. 21), according to certain embodiments. In particular, FIG. 23 depicts how baseline models monitor individual sensors and how compound models monitor a combination of sensors. FIG. 23 includes a decay data model 2322, a plurality of sensors, a plurality of machine learning modules 2114 of FIG. 21, interpretation output 2312, and ECU 2106 of FIG. 21. FIG. 24 depicts an example of how a decay data model, such as decay data model 2322 of FIG. 23, is developed. Baseline machine learning module 2308 is described in further detail in FIGS. 25-26, and compound machine learning module 2310 is described in further detail in FIGS. 27-28.

As shown in FIG. 23, the plurality of machine learning modules 2114 may include baseline machine learning module 2308 and compound machine learning module 2310. The plurality of sensors includes baseline model sensor 2302A, compound model sensor 2304A, baseline model sensor 2302B, compound model sensor 2304B, baseline model sensor 2302C, and compound model sensor 2304C. In some aspects, the system identifies a manufacturer (e.g., Manufacturer X) of each sensor.

Baseline machine learning module 2308 may monitor any one of baseline model sensor 2302A, baseline model sensor 2302B, or baseline model sensor 2302C. In some aspects, machine learning modules 2114 includes a baseline machine learning module for each sensor being monitored. Compound machine learning module 2310 may monitor a combination of: compound model sensor 2304A, compound model sensor 2304B, and compound model sensor 2304C.

Machine learning modules 2114 are configured to generate interpretation output 2312 based on data collected while monitoring and measuring the plurality of sensors. In some aspects, interpretation output 2312 includes a sensor health score 2314, abnormal alerts 2316, adjustment notifications 2318, and system feedback adjustments 2320. In some aspects, a sensor health score 2314 is generated for each sensor being monitored and reflects a performance of the sensor during a specific monitoring interval. Abnormal alerts 2316 may be generated when a behavior of a sensor is determined to be abnormal. In some aspects, abnormal behavior is detected when the sensor behaves outside the range of normal operating conditions established by a baseline for the sensor. Adjustment notifications 2318 are generated when one or more adjustments to the sensor and/or system connected to the sensor should be applied in order to correct abnormal behavior. System feedback adjustments 2320 may be provided to ECU 2106, which is configured to facilitate system-wide adjustments.

As mentioned above, FIG. 24 depicts an example of how a decay data model, such as decay data model 2322 of FIG. 23, is developed. In particular, FIG. 24 depicts data models used during the decay-induced model training, including environmental decay variables that are modified on a per sensor basis, and the number of iterations and sequence of decay introduced. Some examples of sensor stresses that can be performed to induce decay include thermal swings, moisture increases/decreases, and/or gas pulses. Accordingly, a model can learn the signature of temperature-induced zero shifts well before the sensor decay would exhibit itself in the field. Furthermore, models can know the early, subtle flattening of the sensor's response curve. Additionally, models can correct the first millivolt of zero-point sag instead of alarming after 10 mV. Beneficially, the decay sequences can model and mimic five years of sensor wear into a matter of days or weeks, in order to provide the model with a full lifecycle of data for a sensor or combination of sensors.

Environmental decay model 2406 monitors a plurality of environmental factors, such as temperature humidity, pressure, particulate matter (PM), lux, volatile organic compounds (VOC), and indoor air quality (IAQ).

Environmental decay model 2406 is configured to monitor a plurality of sensors, including environmental sensor 2404A, environmental sensor 2404B, and environmental sensor 2404C.

### Parameter Determination 2402

### Digital Twin 2210

The plurality of sensors are placed in a controlled environment, in which external and control factors 2422 can be manipulated in order to induce changes in one or more of the plurality of environment factors. For example, in some instances, the temperature 2408 may be changed by introducing heating and/or cooling elements. The humidity may be changed based on adding water sources or including a dehumidifier within the controlled environment. Other external and control factors 2422 may be changed in order to induce a change in any one of the environmental factors.

In some aspects, the environmental decay model 2406 undergoes a sequence of decay iterations, wherein one or more external and control factors 2422 are changed in a specific order, and by specific increments, according to one or more decay scenarios. As shown in FIG. 24, each environmental factor is associated with a plurality of decay iterations 2424. For example, a sensor corresponding to temperature 2408 may undergo decay iteration 1A, decay iteration 2A, and decay iteration 3A.

Similarly, a sensor corresponding to humidity 2410 may undergo decay iteration 1B, decay iteration 2B, and decay iteration 3B. A sensor corresponding to pressure 2412 may undergo decay iteration 1C, decay iteration 2C, and decay iteration 3C. A sensor corresponding to PM may undergo decay iteration 1D, decay iteration 2D, and decay iteration 3D. A sensor corresponding to lux 2416 may undergo decay iteration 1E, decay iteration 2E, and decay iteration 3E. A sensor corresponding to VOC 2418 may undergo decay iteration 1F, decay iteration 2F, and decay iteration 3F. A sensor corresponding to IAQ 2420 may undergo decay iteration 1G, decay iteration 2G, and decay iteration 3G.

As the controlled environment undergoes the sequence of decay iterations that affect one or more environmental factors of the controlled environment, the environmental decay model 2406 learns how each sensor of the plurality of sensors responds to changes in the environment, as well as changes in other sensors of the plurality of sensors. Accordingly, decay data model 2426 can then be used to monitor sensors in real-world environments, to predict and mitigate sensor decay based on changes in environmental factors in the real-world environments. This process produces decay data model 2426, which is comparable to decay data model 2322 of FIG. 23.

FIG. 25 depicts an example of a baseline model structure 2500, according to certain embodiments. As shown in FIG. 25, baseline models structure 2500 includes a plurality of layers, including an aggregation/harmonization layer 2504, unified baseline model layer 2506, machine learning algorithm layer 2508, and output layer 2510. In some aspects, the disclosed systems and methods are directed to a network of connected sensors, wherein each sensor is configured to broadcast telemetry data. In such aspects, the telemetry data from each sensor is aggregated and organized to mitigate any noise in the data. The sensor type/manufacturer pairs are compiled for each sensor in order to find and load a matching machine learning model. Further, the sensor type/manufacturer pair provides context for the telemetry data.

Baseline model structure 2500 includes a plurality of sensors 2502, including a temperature sensor 2512A, humidity sensor 2512B, and particular matter sensor 2512C. Sensor metadata for each of the plurality of sensors 2502 is provided to the aggregation layer/harmonization layer 2504, which is configured to harmonize the sensor data according to sensor characteristics 2514.

The harmonized metadata from aggregation/harmonization layer 2504 is used by one or more unified baseline model 2506. In some aspects, as shown in FIG. 25, unified baseline models 2506 includes a general temperature baseline model 2516A, a general humidity baseline model 2516B, and general particulate matter baseline model 2516C.

### Machine Learning Algorithm Layer 2508

Output layer 2510 is configured to perform interpretation and generate interpretation output, which is provided to CCU 2102 of FIG. 1. Based on the interpretation output, CCU 2102 is configured to perform an operation adjustment process 2520 on the sensor system.

FIG. 26 depicts an example of a sensor profile and baseline database architecture, according to certain embodiments. In particular, FIG. 26 illustrates a flow diagram for storing metadata or profile information for each sensor type and manufacturer pair and its associated baseline model. In some aspects, the baseline model is derived during training so that it can be subsequently referenced by the system when in deployment. FIG. 26 depicts a plurality of sensors, including environmental sensor 2304A, environmental sensor 2304B, and environmental sensor 2304C. Sensor metadata 2602 is collected from the plurality of sensors and integrated into metadata profiles at block 2604. The database reference layer 2606 is configured to access data from the digital twin/asset data store 2211 and metadata profiles generated at block 2604. Database reference layer 2606 is used by the baseline model database 2608. Baseline model database 2608 includes one or more unified baseline models 2506. Based on selected baseline models, MASS 2100 is able to utilize the baseline models through deployment reference interface 2610.

FIG. 27 depicts an example of a compound model structure, according to certain embodiments. In particular, FIG. 27 depicts a flow diagram for determining the sensor topology permutations for which each combined model is applicable and any aggregation and/or harmonization methodology is used. Such techniques are used to reduce the number of model permutations for combined models (e.g., so that there is not a separate combined model for each sensor topology in an overall system). Flow diagram 2700 includes a plurality of layers, including a sensor topology layer 2704, an aggregation/harmonization layer 2706, a compound model layer 2708, a machine learning algorithm layer 2710, and a deployment interface 2736.

FIG. 27 depicts a plurality of sensor nodes 2702 corresponding to one or more sensors, including environmental sensor 2712, humidity sensor 2714, chiller current 2716, smoke sensor 2718, and heat sensor 2720. In some aspects, the sensors are arranged according to a specific sensor topology, for example, as facilitated by sensor topology layer 2704.

As shown in FIG. 27, sensor topology layer 2704 includes clustered arrangement 2722 associated with environmental sensor 2712, humidity sensor 2714, and chiller current 2716, and a distributed arrangement 2724 associated with smoke sensor 2718 and heat sensor 2720.

Aggregation/harmonization layer 2706 is configured to aggregate and harmonize data in order to generate a grouped topology layer, which establishes the context of the incoming data from the sensors. As an example, a gateway may serve three rooms and all sensors from each room are connected to the gateway. By aggregating and harmonizing the data, the grouped topology layer is able to represent which sensors are in each room, gathering which data. For example, a temperature sensor in room A may relate to the fire detector in the same room. This type of relationship can then be represented by the grouped topology layer.

Compound model layer 2708 is associated with a plurality of grouped type topologies, including grouped type topology 2728, grouped type topology 2730, and grouped type topology 2732.

Machine learning algorithm layer 2710 includes one or more machine learning models 2734, which are in communication with the digital twin/asset data store 2211 and telemetry data statistical storage array 2522. The one or more machine learning models 2734 are then deployed through the deployment interface 2736 to MASS 2100.

FIG. 28 depicts an example of a topology profile and combined database architecture. In particular, FIG. 28 depicts a flow diagram for storing metadata and profile information for each combined model derived during training. For example, if there is a digital twin approach to building topology representation, references will be derived from a particular digital twin that is used to correlate that network with a corresponding combined model.

Flow diagram 2800 includes sensor topology profiles 2802, digital twin representation layer 2804, a topology-model index 2806, a combined model database 2808, and deployment interface 2736. Sensor topology profiles 2802 includes clustered arrangement 2810 and distributed arrangement 2812.

The digital twin representation layer 2804 includes metadata such as connectivity map metadata 2814, special coordinates metadata 2816, sensor limit metadata 2818, and client-specific metadata 2820.

The topology-model index 2806 includes a database reference layer 2822, topology ID 2824, model ID 2826, and digital twin ID 2828. The topology-model index 2806 is configured to access data from the stored digital twin/asset data store 2211.

Based on the information associated with the topology-model index 2806, the system accesses the combined model database 2808 and selects one or more combined models to be deployed to MASS 2100, via the deployment interface 2736.

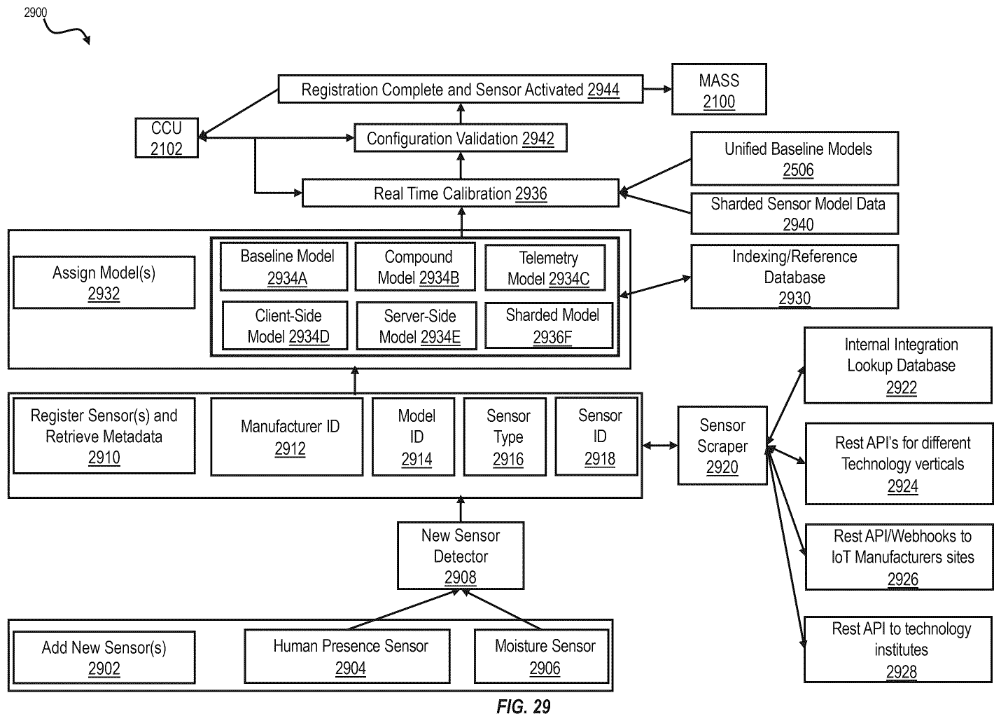

FIG. 29 depicts a process flowchart 2900 associated with an automatic system configuration that occurs when new sensors are introduced into the network, according to certain embodiments. In particular, FIG. 29 depicts how the system automatically detects new sensors, retrieves sensor metadata, and assigns baseline and compound models based on environmental context and sensor specifications. In some aspects, a new sensor is connected to the network and powered up, for example, bringing a pressure transducer online in a plant. After powering up, the sensor is configured to send a short radio (or wired-bus) message that lists: the model, what parameter the sensor is configured to monitor/measure, factory calibration accuracy, and a firmware version. A nearby edge gateway will log the sensor on a “live devices” list and will begin to forward the data generated by the new sensor to the network. In some aspects, the MASS system is further configured to transmit a digital certificate along with the short radio message so that the edge gateway is able to prove that the new sensor is genuine. In some aspects, the MASS system also stores a sensor twin inside the edge gateway. A sensor twin is a live copy of the sensor's nameplate and status. This allows the system to perform local health checks even if the network connection (e.g., WAN) drops out.

Process flowchart 2900 includes adding new sensors at block 2902, detecting new sensors at block 2908, registering sensors and retrieving sensor metadata at block 2910, and assigning models at block 2932.

In some aspects, a human presence sensor 2904 and a moisture sensor 2906 are added to the system. The human presence sensor 2904 and moisture sensor 2906 are detected at block 2908. At block 2910, each respective sensor is registered based on metadata that is retrieved for the respective sensor. In some aspects, the metadata includes a manufacturer ID, a model ID, a sensor type, and sensor ID. In some aspects, sensors are configured to transmit metadata to one or more ECUs, such as ECU 2106 of FIG. 21, which are configured to initiate the configuration process. In some aspects, the metadata retrieval is facilitated by sensor scraper 2920 that is configured with an internal integration lookup database (2922), rest APIs for different technology verticals (2924), rest APIs and/or webhooks to internet of things (IoT) manufacturer sites (2926), and/or rest APIs to technology institutes 2928. Each of the aforementioned API's is used to access external datasets, such as manufacturer data on sensors and/or other information or testing associated with sensors, to retrieve sensor metadata.

At block 2932, the ECUs select the most appropriate baseline model (e.g., baseline model 2934A) from a repository of pre-trained models. In some aspects, the pre-trained models are trained on accelerated decay logs, such that each pre-trained model is trained on a baseline, mid-life, and worn-out behavior of one or more sensors. Baseline model 2934A is configured to reflect the specific conditions under which the sensor operates, including expected environmental factors and decay patterns. The ECU assigns the baseline model 2934A to the sensor (e.g., human presence sensor 2904) and configures the initial detection thresholds and sensitivity settings.

In addition to assigning baseline models, ECUs in collaboration with the CCU also assign one or more compound models, such as compound model 2934B, at block 2932. Compound model 2934B integrates data from multiple sensors, such as human presence sensor 2904 and moisture sensor 2906. Compound model 2934B also factors in environmental conditions and network-wide performance considerations as part of the data integration process.

Process flowchart 2900 also include performing real-time calibration at block 2936, performing a configuration validation at block 2942, and activating the sensor at block 2944. Real-time calibration is performed based on unified baseline models 2938 and sharded sensor model data 2940. In some aspects, block 2936, block 2942, and block 294 are performed by CCU 2102 of FIG. 1. After registration is complete and the new sensor is activated, MASS 2950 is automatically configured with the new sensor.

Other types of models associated with model assignment during the automatic configuration process may include a telemetry model 2934C, client-side model 2934D, server-side model 2934E, and sharded model 2934F. In some aspects, the models may be indexed in a reference database 2930.

At block 2936, the system performs an initial calibration to fine-tune the operational parameters. In particular, sensors begin sending real-time data to the ECUs, which then cross-check the real-time data with the assigned baseline model 2934A and compound model 2934B. This calibration ensures that each sensor is properly configured for its environment and that models are optimized at the start of the system processes.

In some aspects, the automatic configuration process includes a model optimization feedback loop. For example, throughout operation, the system may monitor the performance of the models and adjust the model configurations as new sensors are added or environmental conditions change. The system continuously improves model assignments through feedback loops, thereby improving the network without manual intervention.

FIG. 30 depicts a flow diagram 3000 associated with health monitoring and continuous evaluation, according to certain embodiments. In this phase, MASS continuously monitors sensor health and identifies potential decay or malfunctions in real-time. For example, sensors continuously transmit telemetry data to the ECUs, which collect telemetry data 3002 on sensor readings, operational states, and environmental contexts. Telemetry data 3002 may include detection accuracy, sensitivity levels, errors rates, and signal strength, in addition to values for one or more parameters that are being measured by the sensors. As shown in FIG. 30, some parameters 3004 include temperature, energy, current, room count, humidity, status, voltage, and set point.

The telemetry data 3002 is provided to a data aggregation system 3005 which is configured to aggregate all of the different types of telemetry data 3002 that is being collected. In some aspects, data aggregation system 3005 is comparable to data aggregation model 2120 of FIG. 21. In some aspects, telemetry data 3002 is aggregated with historical performance data 3006, including data from the digital twin/asset data store 2211, baseline model database 3012, and the alarm/notification engine 3010. In some aspects, the baseline model database 3012 is comparable to the repository of pre-trained models accessed during model assignment at block 2932 of FIG. 29.

The alarm/notification engine 3010 is configured to trigger an alarm and/or generate one or more notifications about changes in the environment, the sensors, and/or within the MASS system. In some aspects, alarm/notifications engine 3010 is configured to generate abnormal alerts 2316 of FIG. 23.

The historical performance data 3006 is provided to health monitoring engine 2110, which is configured to compare the telemetry data 3002 against the expected performance defined by the baseline models included in the baseline model database 3012. Health monitoring engine 2110 is configured to identify deviations from normal operating conditions, such as sensor drift, sensitivity loss, or response time delays. These deviations may be indicators of sensor decay.

In some aspects, health monitoring engine 2110 is in communication with a plurality of modules, including a data ingestion module 3014, a comparison module 3016, an anomaly detection module 3018, and a decision module 3020. Accordingly, data ingestion module 3014 is configured to ingest the historical performance data 3006. The comparison module 3016 is configured to compare the telemetry data 3002 against the expected performance data. The anomaly detection module 3018 is configured to detect anomalies (e.g., deviations from expected performance) based on comparing the data. In some aspects, when significant deviations are detected, the anomaly detection module 3018 logs the anomalies and reports them to CCU 2102. The CCU 2102 coordinates further analysis and prepares to adjust operational parameters as needed. In some aspects, decision module 3020 is configured to make one or more decisions about whether/how to respond to the anomalies, including whether to implement operational adjustments 3022 and/or generate notifications via the alarm/notifications engine 3024.

In order to prevent false positives, the health monitoring engine 2110 cross-references individual sensor data with the compound models. Thus, by analysing trends across multiple sensors, health monitoring engine 2110 determines whether the detected anomaly is due to sensor decay or external factors affecting the sensor and/or network.

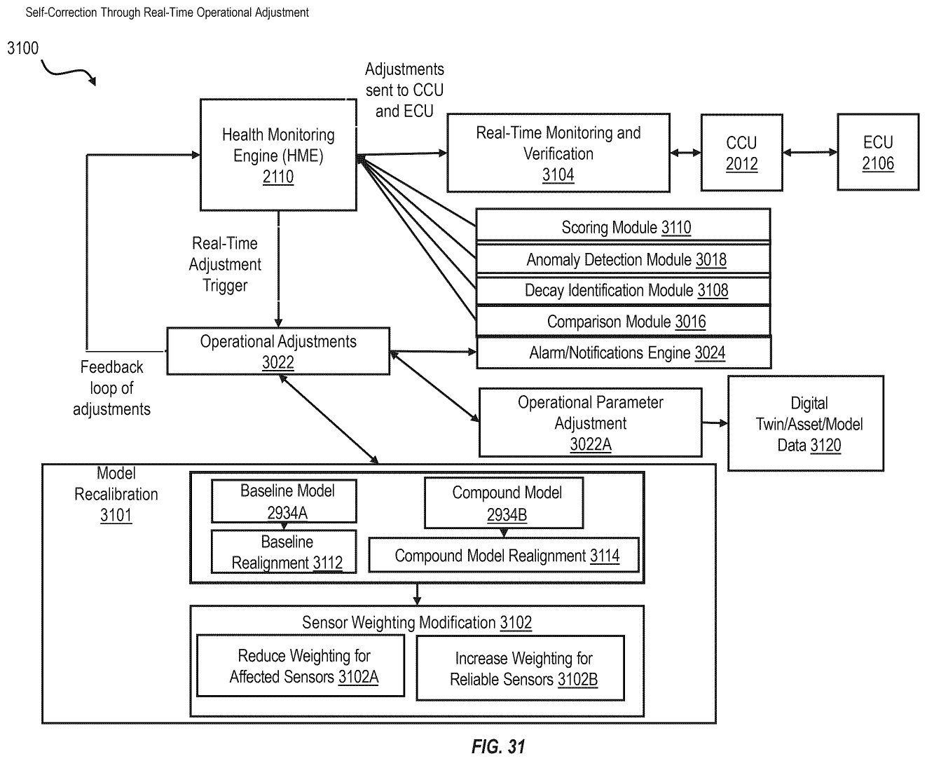

FIG. 31 depicts a flow diagram for performing self-correction through real-time operational adjustment, according to certain embodiments. This self-correction phase of MASS allows the system to autonomously adjust operational parameters in response to detected sensor decay. As described above, health monitoring engine 2110 identifies anomalies indicating sensor decay. An example of an anomaly is a deviation from the baseline model's expected performance. In certain embodiments, the system evaluates whether the detected anomaly is critical enough to warrant operational adjustments 3022.

In certain embodiments, the system is configured to recalibrate detection thresholds for an affected sensor. In some aspects, the system adjusts the sensitivity or response time to correct for sensor performance loss. For example, if a sensor's accuracy has decreased due to decay, the system may adjust the threshold so that the sensor continues to provide reliable data.

Beneficially, in certain embodiments, the system is configured to dynamically adjust baseline and compound models. In particular, the system dynamically adjusts models to reduce the weight given to degraded sensors and increase the weight given to healthier sensors in the network. For example, as shown in FIG. 31, baseline model 2934A undergoes a baseline realignment 3112. Compound model 2934B undergoes a compound model realignment 3114. The compound realignment 3114 is facilitated by applying a sensor weighting modification 3102 to compound model 2934B. If one or more sensors being monitored by compound model 2934B are underperforming, the system is configured to reduce the weighting for affected sensors (block 3102A). If the sensors being monitored by compound model 2934B are performing as expected, the system is configured to increase the weighting for the sensors, which are identified as reliable sensors (block 3102B). This ensures that the system maintains accuracy despite the decay of one or more sensors.

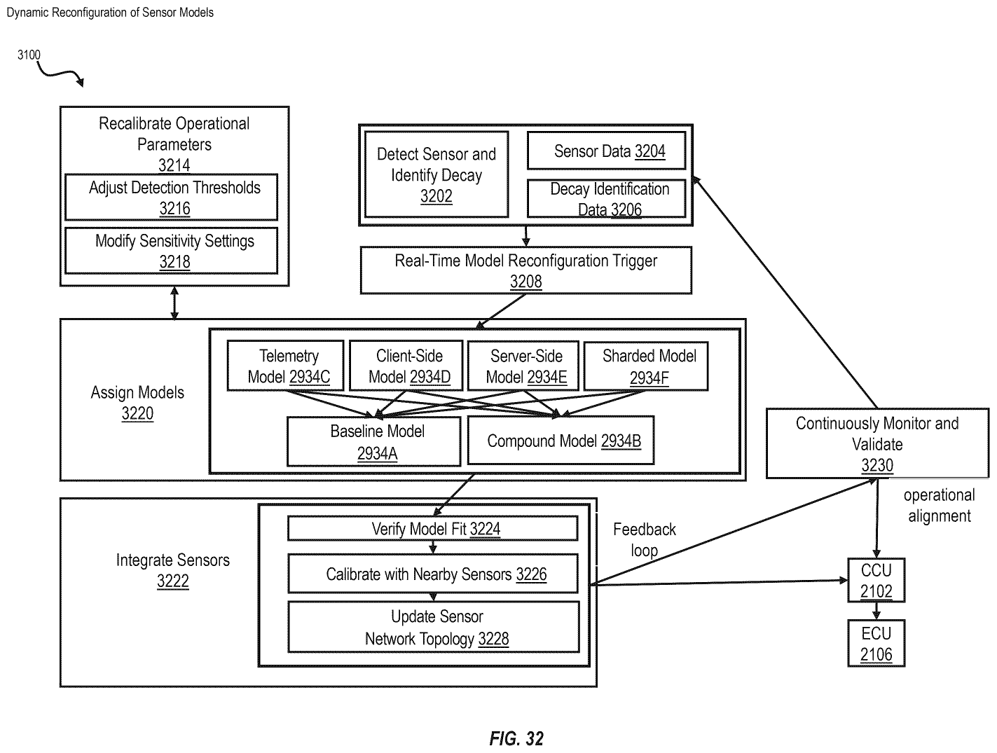

FIG. 32 depicts a flow diagram associated with a process for dynamically reconfiguring sensor models, according to certain embodiments. For example, MASS dynamically reconfigures models to accommodate new sensors, sensor decay, and environmental changes. Flow diagram 3200 includes steps and components for detection of new sensors, re-evaluation of compound models, recalibration of operational parameters, model optimization, and autonomous configuration.

In certain aspects, the system continuously monitors for new sensors within the network at block 3230 by communicating with CCU 2102 of MASS 2100. Based on this continuous monitoring, the system detects new sensors and identifies sensor decay at block 3202. When a new sensor is introduced into the network, MASS automatically detects is and retrieves its metadata for processing. Accordingly, the system stores sensor data 3204 and decay identification data 3206. The detection of new sensors and/or identification of sensor decay triggers a real-time model reconfiguration trigger 3208.

The system is configured to assign models to the new sensors at block 3220. The system registers any new sensors within the network and assigns it a baseline model and a compound model based on the sensor's operational context. As shown in FIG. 32, the system may select from one or more of: baseline model 2934A, compound model 2934B, telemetry model 2934C, client-side model 2934D, server-side model 2934E, and sharded model 2934F.

In some aspects, as part of the model assignment, the system is configured to re-evaluate existing compound models to incorporate into the new sensor's metadata. The system updates the network-wide models to ensure that the new sensor's data is properly integrated into the overall monitoring framework.

The system is also configured to recalibrate operational parameters at block 3214. Some examples of recalibrations that can be made include adjusting detection thresholds 3216 and/or modifying sensitivity settings 3218 of the sensors. MASS recalibrates the operational parameters of both new and existing sensors to reflect changes in the network configuration. This ensures that the addition of new sensors does not disrupt ongoing operations and that all sensors remain optimally configured. In addition to recalibrating operational parameters, the system is also configured to continuously optimize the network by dynamically adjusting model parameters based on sensor health and environmental conditions. Models are recalibrated as necessary to maintain overall system performance as the network evolves.

The system then integrates sensors at block 3222 by verifying model fit at block 3224 of the models assigned at block 3220, calibrating with nearby sensors at block 3226, and updating the sensor network topology at block 3228. The system is also able to calibrate with nearby sensors through CCU 2102 and ECU 2106. In this manner, the system is able to dynamically reconfigure sensor models based on the identification of new sensors and/or sensor decay within the network. Accordingly, reconfiguration occurs autonomously, without the need for human intervention. The system adapts in real-time to changes in the sensor network. Beneficially, the system is able to prevent system disruption and perform continuous performance optimization.

In summary, in certain embodiments, MASS introduces a unique approach to sensor management through the development of “decay-induced models.” These baseline and compound models are specifically trained to detect and correct for sensor decay, enabling real-time operational adjustments. By simulating sensor degradation during development, MASS builds models that can automatically adjust detection thresholds and operational parameters based on continuous monitoring of sensor telemetry, ensuring long-term accuracy and efficiency.

MASS, in certain embodiments, also features dynamic discovery and intelligent model selection, allowing the system to automatically detect and configure new sensors. For example, one or more new sensors are powered-up and one or more edge gateways corresponding to the new sensor(s) log sensor metadata. Then, using sensor metadata, it intelligently selects the most suitable models, ensuring seamless integration into the network. In some aspects, the CCU is able to match and push the relevant baseline file for the new sensor(s). If the local sensor layout is new, the CCU either re-uses an appropriate compound model or is able to generate a new compound model for the local sensor layout.

Through autonomous health monitoring, in certain embodiments, the system continuously evaluates sensor performance, detecting decay or malfunctions early. As part of the routine monitoring, the system is configured to tag every reading from a sensor with a sensor health score, which can be reviewed by the CCU network-wide. When issues arise, in certain embodiments, MASS initiates real-time decay correction by dynamically recalibrating operational settings, maintaining system reliability and extending sensor lifespan. In some aspects, the baseline model trims detection thresholds so the new sensor(s) line up with neighboring units. Beneficially, this calibration does not require an in-person field tech calibration. Finally, in certain embodiments, MASS offers Dynamic Reconfiguration, automatically adjusting models and operational parameters as sensors degrade or new sensors are added, ensuring optimal performance in ever-changing environments. For example, in certain aspects, if a single sensor drifts, the corresponding baseline model is configured to apply an offset to the single sensor. If a combination of sensors is starting to drift, in certain aspects, the compound model is configured to down-weight the sensors' influence or raise a group alert. Furthermore, in certain aspects, when a replacement sensor appears or when a drifting sensor no longer meets acceptable operational thresholds, the CCU is configured to re-train the affected model in the background and provide a new version of the model.

Accordingly, in certain aspects, the disclosed systems and methods beneficially improve upon existing systems and methods for sensor management. For example, by providing continuous and automatic software recalibration, in certain aspects, MASS allows for strategic planning of resources for physical in-person sensor management for times when the health score drops below an acceptable threshold. Additionally, in certain aspects, the decay-trained models not only detect, but anticipate, sensor abnormalities in real time, thus preventing false detections or even missed detections.

Another technical benefit is achieved, in certain aspects, by training models on the full lifecycle of a sensor's behavior, instead of only training the model on clean or early life data. As another example of a technical benefit, in certain aspects, MASS is able to improve upon existing systems and methods which average sensor readings, by instead providing a baseline model for each individual sensor, and a compound model for the combination of sensors, to manage groups of sensors in an efficient and accurate manner.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine that is programmed to execute instructions to carry out the functions described herein. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both non-transitory computer storage media and communication media including any medium that facilitates transfer of a computer program. A storage medium may be any available media that can be accessed by a computer. By way of example, and not limitation, such computer-readable media can include non-transitory computer-readable media including RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium can include a communication signal path. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The system may include various modules as discussed above. As can be appreciated by one of ordinary skill in the art, each of the modules may include one or more of a variety of sub-routines, procedures, definitional statements and macros. Each of the modules may be separately compiled and linked into a single executable program. Therefore, the description of each of the modules is used for convenience to describe the functionality of the disclosed embodiments. Thus, the processes that are undergone by each of the modules may be redistributed to one of the other modules, combined together in a single module, or made available in, for example, a shareable dynamic link library.

The system may be used in connection with various operating systems such as Linux®, UNIX® or Microsoft Windows®. The system may be written in any conventional programming language such as C, C++, BASIC, Pascal, or Java, and ran under a conventional operating system. The system may also be written using interpreted languages such as Perl, Python or Ruby.

It will be appreciated by those skilled in the art that various modifications and changes may be made without departing from the scope of the described technology. Such modifications and changes are intended to fall within the scope of the embodiments. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. An adaptive sensing system, comprising one or more memories; and one or more processors configured to cause the adaptive sensing system to:
receive data from one or more sensing devices in a sensor network;
provide the data to a machine learning model trained to detect sensor abnormality in the one or more sensing devices;
receive, from the machine learning model, an output indicating that at least one sensing device of the one or more sensing devices is experiencing a sensor abnormality; and
based on receiving the output indicating that the at least one sensing device is experiencing the sensor abnormality, dynamically adjust a detection parameter of the at least one sensing device to mitigate the sensor abnormality, wherein the detection parameter represents a signal value, that when satisfied, triggers an action.

2. The adaptive sensing system of claim 1, wherein the at least one sensing device comprises a sensor configured to monitor a parameter of a sensing environment in which the at least one sensing device is located; and the machine learning model is configured as a baseline model that is configured to receive data from and monitor an individual sensor of the at least one sensing device.

3. The adaptive sensing system of claim 1, wherein the at least one sensing device comprises a plurality of sensors configured to monitor a plurality of parameters of a sensing environment in which the at least one sensing device is located; and the machine learning model is configured as a compound model that is configured to receive data from and monitor multiple sensors of the plurality of sensors.

4. The adaptive sensing system of claim 3, wherein the one or more processors are further configured to cause the adaptive sensing system to receive, from a plurality of baseline models, a plurality of additional outputs, wherein each of the plurality of baseline models corresponds to a particular sensor of the plurality of sensors, such that the detection parameter is adjusted based on output from the compound model and the plurality of additional outputs from the plurality of baseline models.

5. The adaptive sensing system of claim 1, wherein the one or more processors are configured to cause the adaptive sensing to:
identify one or more attributes of the at least one sensing device; and
select the machine learning model from a plurality of machine learning models based on one or more attributes of the machine learning model corresponding to the one or more attributes of the at least one sensing device.

6. The adaptive sensing system of claim 1, wherein the one or more processors are configured to cause the adaptive sensing system to:
detect a new sensing device within the sensor network associated with a sensing environment;
identify one or more attributes of the new sensing device;
identify one or more attributes of the sensing environment;
based on the one or more attributes of the new sensing device and the one or more attributes of the sensing environment, assign a pre-trained baseline model from a plurality of pre-trained baseline models to each sensor of the new sensing device based on feedback from each pre-trained baseline model; and
configure one or more settings of each sensor of the new sensing device.

7. The adaptive sensing system of claim 6, wherein the one or more processors are configured to cause the adaptive sensing system to:
based on the one or more attributes of the new sensing device and the one or more attributes of the sensing environment, assign a pre-trained compound model from a plurality of pre-trained compound models to the new sensing device; and
perform a calibration of the new sensing device based on feedback from the pre-trained compound model.

8. The adaptive sensing system of claim 1, wherein the action comprises one or more of: activating an alarm, generating and displaying a notification to a user, or activating an emergency system to mitigate a change in at least one parameter of a sensing environment in which the at least one sensing device is located.

9. The adaptive sensing system of claim 1, wherein the output from the machine learning model indicates that the at least one sensing device is experiencing the sensor abnormality due to an internal sensor deterioration of a sensor included in the at least one sensing device.

10. The adaptive sensing system of claim 1, wherein the output from the machine learning model indicates that the at least one sensing device is experiencing the sensor abnormality due to a sensor deterioration of a second sensing device, and the one or more processors are configured to cause the adaptive sensing system to adjust one or more detection parameters of the second sensing device.

11. The adaptive sensing system of claim 1, wherein the output from the machine learning model indicates that the at least one sensing device is experiencing the sensor abnormality due to an external environmental factor of a sensing environment in which the at least one sensing device is located.

12. The adaptive sensing system of claim 11, wherein the one or more processors are configured to cause the adaptive sensing system to adjust one or more parameters associated with the external environmental factor of the sensing environment to mitigate the sensor abnormality.

13. The adaptive sensing system of claim 1, wherein the one or more processors are configured to cause the adaptive sensing system to:
receive, from the machine learning model, a second output indicating that a second sensing device of the one or more sensing devices is predicted to experience a second sensor abnormality within an estimated timeframe; and
based on receiving the second output, dynamically adjust a second detection parameter of the second sensing device, wherein the second detection parameter represents a second signal value, that when satisfied, triggers a second action.

14. The adaptive sensing system of claim 1, wherein the detection parameter comprises a sensitivity setting or a detection threshold.

15. An adaptive sensing system, comprising one or more memories; and one or more processors configured to cause the adaptive sensing system to train a machine learning model to detect sensor abnormality in a sensing device, wherein to train comprises to:
receive a first set of data, over a first time period, from one or more sensing devices located within a sensing environment, the first set of data comprising data values corresponding to one or more parameters of the sensing environment;
based on reception of the first set of data from the one or more sensing devices, determine a baseline detection parameter of a target sensing device of the one or more sensing devices;
select a scenario from a plurality of scenarios, wherein each scenario of the plurality of scenarios comprises one or more adjustments to one or more parameters of the sensing environment;
adjust one or more parameters of the sensing environment according to the scenario to induce a sensor abnormality in the target sensing device;
subsequent to adjustment of one or more parameters of the sensing environment, receive a second set of data, over a second time period, from one or more sensing devices located within the sensing environment about the one or more parameters of the sensing environment;
detect that the target sensing device is experiencing a sensor abnormality based on the second set of data received over the second time period;
based on detection that the target sensing device has experienced the sensor abnormality, identify a new detection parameter for the target sensing device to mitigate the sensor abnormality; and
train the machine learning model on the first set of data, the baseline detection parameter, the second set of data, and the new detection parameter such that the machine learning model is configured to detect sensor abnormalities in sensing devices and identify new detection parameters for the sensing devices.

16. The adaptive sensing system of claim 15, wherein the first set of data and the second set of data further comprise one or more data values corresponding to operational parameters of the target sensing device, including one or more of: a detection parameter, a response time, or error rate.

17. The adaptive sensing system of claim 15, wherein the machine learning model is further trained to predict a time at which a sensing device will experience a sensor abnormality.

18. The adaptive sensing system of claim 15, wherein the target sensing device comprises a sensor configured to monitor a parameter of a sensing environment in which the target sensing device is located; and the machine learning model is configured as a baseline model corresponding to the sensor.

19. The adaptive sensing system of claim 15, wherein the target sensing device comprises a plurality of sensors configured to monitor a plurality of parameters of a sensing environment in which the target sensing device is located; and the machine learning model is configured as a compound model corresponding to the target sensing device.

20. The adaptive sensing system of claim 15, wherein to train the machine learning model further comprises to:
receive an output from the machine learning model comprising a predicted set of data that the machine learning model predicts that the target sensing device will transmit over a third time period;
adjust the baseline detection parameter to the new detection parameter for the target sensing device;
subsequent to adjusting the baseline detection parameter to the new detection parameter for the target sensing device, receive a third set of data, over the third time period; and
validate the machine learning model based on a comparison of the predicted set of data with the third set of data.
